(19) United States
(12) Patent Application Publication
(10) Pub. No.: US 2013/0193164 A1
(43) Pub. Date: Aug. 1, 2013

(54) SUBSTANTIALLY RIGID COLLAPSIBLE LINER, CONTAINER AND/OR LINER FOR REPLACING GLASS BOTTLES, AND ENHANCED FLEXIBLE LINERS

(71) Applicants: Glenn Tom, Bloomington, MN (US); Greg Nelson, Minneapolis, MN (US); Wei Liu, Eden Prairie, MN (US); Amy Koland, Eden Prairie, MN (US); Don Ware, Woodbury, MN (US); Daniel J. Durham, Toledo, OH (US); Tracy M. Momany, Sylvania, OH (US)

(72) Inventors: Glenn Tom, Bloomington, MN (US); Greg Nelson, Minneapolis, MN (US); Wei Liu, Eden Prairie, MN (US); Amy Koland, Eden Prairie, MN (US); Don Ware, Woodbury, MN (US); Daniel J. Durham, Toledo, OH (US); Tracy M. Momany, Sylvania, OH (US)

(73) Assignee: Advanced Technology Materials, Inc., Danbury, CT (US)

(21) Appl. No.: 13/878,930

(22) PCT Filed: Oct. 10, 2011
(86) PCT No.: PCT/US11/55558

§ 371 Date: Apr. 11, 2013

(30) Foreign Application Priority Data
Oct. 11, 2010 (US) 61391945
Oct. 21, 2010 (US) 61405567
Dec. 20, 2010 (US) 61424800
Jan. 12, 2011 (US) 61432122
Mar. 28, 2011 (US) 61468547
May 10, 2011 (US) 61484487
Jun. 21, 2011 (US) 61499254
Sep. 23, 2011 (US) 61538509

(51) Int. Cl. B65D 35/28; B32B 1/02; B67D 7/60

(52) U.S. Cl. CPC B65D 37/00; B32B 1/02
USPC 222/95; 428/34.1; 222/105; 222/386.5

(57) ABSTRACT

The present disclosure relates to a blow-molded, rigid collapsible liner that can be suitable particularly for smaller storage and dispensing systems. The rigid collapsible liner may be a stand-alone liner, e.g., used without an outer container, and may be dispensed from a fixed pressure dispensing can. Folds in the rigid collapsible liner may be substantially eliminated, thereby substantially reducing or eliminating the problems associated with pinholes, weld tears, and overflow. The present disclosure also relates to systems and liners, including the liners just mentioned, that may be used as alternatives to, or replacements for, simple rigid-wall containers, such as those made of glass. Such advantageous systems and liners may replace simple rigid-wall containers in a system for delivering a high purity material to a semiconductor process substantially without modification to an end user's existing pump dispense or pressure dispense systems.

### CROSS-REFERENCE TO RELATED APPLICATIONS

This application relates to International Pat. Appl. No. PCT/US10/41629, titled “Substantially Rigid Collapsible Liner and Flexible Gusseted or Non-gusseted Liners and Methods of Manufacturing the Same and Methods for Limiting Choke-off in Liners,” filed Jul. 9, 2010; U.S. Patent Appl. No. 61/391,945, titled “Substantially Rigid Collapsible Liner, Container and/or Liner for Replacing Glass Bottles, and Flexible Gusseted or Non-Gusseted Liners,” filed Oct. 11, 2010; and U.S. Patent Appl. No. 61/405,567, titled “Substantially Rigid Collapsible Liner, Container and/or Liner for Replacing Glass Bottles, and Flexible Gusseted or Non-Gusseted Liners,” filed Oct. 21, 2010, the contents of each of which are hereby incorporated by reference herein in their entirety.

### FIELD OF THE INVENTION

The present disclosure relates to liner-based storage and dispensing systems. More particularly, the present disclosure relates to substantially rigid containers, collapsible liners, and flexible gusseted or non-gusseted liners and methods for manufacturing the same. The present disclosure also relates to systems and liners that may be used as alternatives to, or replacements for, simple rigid-wall containers, such as those made of glass. The present disclosure also relates to methods for limiting choke-off in liners.

### BACKGROUND OF THE INVENTION

Numerous manufacturing processes require the use of ultrapure liquids, such as acids, solvents, bases, photoresists, slurries, cleaning formulations, dopants, inorganic, organic, metalorganic and biological solutions, pharmaceuticals, and radioactive chemicals. Such applications require that the number and size of particles in the ultrapure liquids be minimized. In particular, because ultrapure liquids are used in many aspects of the microelectronic manufacturing process, semiconductor manufacturers have established strict particle concentration specifications for process chemicals and chemical-handling equipment. Such specifications are needed because, should the liquids used during the manufacturing process contain high levels of particles or bubbles, the particles or bubbles may be deposited on solid surfaces of the silicon. This can, in turn, lead to product failure and reduced quality and reliability.

Accordingly, storage, transportation, and dispensing of such ultrapure liquids require containers capable of providing adequate protection for the retained liquids. Two types of containers typically used in the industries are simple rigid-wall containers made of glass or plastic and collapsible liner-based containers. Rigid-wall containers are conventionally used because of their physical strengths, thick walls, inexpensive cost, and ease of manufacture. Such containers, however, can introduce air-liquid interfaces when pressure-dispensing the liquid. This increase in pressure can cause gas to dissolve into the retained liquid, such as photoresist, in the container and can lead to undesired particle and bubble generation in the liquids in the dispense train.

Alternatively, collapsible liner-based containers, such as the NOWPak® dispense system marketed by ATMI, Inc., are capable of reducing such air-liquid interfaces by pressurizing, with gas, onto the liner, as opposed to directly onto the liquid in the container, while dispensing. However, known liners may be unable to provide adequate protection against environmental conditions. For example, current liner-based containers may fail to protect the retained liquid against pinhole punctures and tears in the welds sometimes caused by elastic deformation from vibrations, such as those brought on by transportation of the container. The vibrations from transportation can elastically deform or flex a liner many times (e.g., thousands to millions of times) between the source and final destinations. The greater the vibration, the more probable that pinholes and weld tears will be produced. Other causes of pinholes and weld tears include shock effect, drops, or large amplitude movements of the container. Gas may be introduced through the pinholes or weld tears, thereby contaminating the retained liquids over time, as the gas will be permitted to go into the solution and come out onto the wafer as bubbles.

Additionally, collapsible liners are configured to be filled with a specified amount of liquid. However, the liners do not fit cleanly within their respective outer containers as folds are created in the liners as they are fit inside the containers. The folds may preclude liquid from filling the liners in the space taken up by the folds. Accordingly, when the container is filled with the specified amount of liquid, the liquid tends to overflow the container resulting in loss of liquid. As stated previously, such liquids are typically ultrapure liquids, such as acids, solvents, bases, photoresists, dopants, inorganic, organic, and biological solutions, pharmaceuticals, and radioactive chemicals, which can be very expensive, for example about $2,500/L or more. Thus, even a small amount of overflow is undesirable.

Thus, there exists a need in the art for better liner systems for ultrapure liquids that do not include the disadvantages presented by prior rigid-wall and collapsible liner-based containers. There is a need in the art for substantially rigid collapsible liners and flexible gusseted or non-gusseted liners. There is a need in the art for a liner-based storage and dispensing system that addresses the problems associated with pinholes, weld tears, gas pressure saturation, and overflow. There is a need in the art for liner-based storage and dispensing systems that addresses the problems associated with excess folds in the liner that can result in additional trapped gas within the liner. There is also a need in the art for liners that are comprised such that choke-off is limited or eliminated.

### BRIEF SUMMARY OF THE INVENTION

The present disclosure, in one embodiment, relates to a liner-based storage system that includes an overpack and a liner. The liner may be provided within the overpack. The liner may have a substantially rigid liner wall forming an interior cavity of the liner, the rigid liner wall having a thickness such that the liner is substantially self-supporting in an expanded state but collapsible at a pressure less than about 20 psi to dispense fluid from within the interior cavity.

The present disclosure, in another embodiment, relates to a liner that has a liner wall forming an interior cavity of the liner and a sump area generally at the bottom of the liner to increase dispensability.

The present disclosure, in another embodiment, relates to a liner that further includes a means for preventing choke-off.

The present disclosure, in another embodiment, relates to a liner for replacing rigid-wall containers. The liner includes a liner wall that forms an interior cavity of the liner for holding a material. The liner wall is made from polyethylene napthalate (PEN) with or without a moisture-barrier coating. The liner also includes a fitment attached to the liner wall for introducing the material into the interior cavity of the liner and for dispensing the material from the interior cavity of the liner.

In another embodiment, the present disclosure relates to a liner system for replacing rigid-wall containers. The liner system includes a liner that forms an interior cavity for holding a material. The liner is made from polyethylene napthalate (PEN). The liner system also includes at least one desiccant for reducing moisture passing into the interior cavity of the liner.

In another embodiment, the present disclosure relates to a method of delivering a high purity material to a semiconductor process that includes providing a substantially rigid, free-standing container having the high purity material stored in an interior thereof. The container has a container wall comprising polyethylene naphthalate (PEN) and a dip tube in the interior for dispensing the high purity material therefrom. The dip tube is coupled to a downstream semiconductor process. The method also includes dispensing the high purity material from the container via the dip tube and delivering the high purity material to the downstream semiconductor process.

In still further embodiments, the present disclosure relates to a liner-based system including an overpack and a liner provided within the overpack, the liner having a mouth and a liner wall forming an interior cavity of the liner and having a thickness such that the liner is substantially self-supporting in an expanded state, but is collapsible at a pressure of less than about 20 psi. The liner may be configured to collapse away from an interior wall of the overpack upon the introduction of a gas or liquid into an annular space between the liner and the overpack, thereby dispensing contents of the liner. The liner and/or overpack may have one or more surface features for controlling the collapse of the liner. The one or more surface features, in a particular embodiment, may include a plurality of rectangular-shaped panels spaced around the circumference of the liner and/or overpack. The liner and overpack can be coblowmolded, or nested blowmolded, or integrally blow molded. The one or more surface features for controlling the collapse of the liner may be configured to maintain the integrity between the liner and overpack when not in active dispense. In some cases the system may further include a chime coupled to the exterior of the overpack. The chime may be coupled to the overpack by snap fit, with the chime substantially entirely covering the one or more surface features. The liner and/or overpack could be configured to control the collapse of the liner such that the liner collapses substantially evenly circumferentially away from the interior wall of the overpack. The liner and/or overpack may have a barrier coating for protecting contents of the liner. Similarly, the chime may have a barrier coating for protecting contents of the liner. The system may further include means for preventing choke-off, which in one embodiment, may be a choke-off preventer disposed through the mouth of the liner and positioned within the interior cavity of the liner. The liner and/or overpack can have a plurality of wall layers and/or could be comprised of a biodegradable material. The system may also include a sensor for measuring dispense of the contents of the liner and/or a device for tracking at least one of liner contents or liner usage. In some cases, a dessicant may be disposed between the liner and overpack. A cap may also be included and can be adapted for coupling with the mouth of the liner. Similarly, a connector may be included with the system, the connector adapted for at least one of filling the liner or dispensing contents from the liner. The connector can be adapted for coupling with the cap of the liner. In some cases, the connector can be configured for substantially aseptic filling or dispense. The connector may also have a diptube probe that partially extends into the liner for dispensing the contents of the liner. In addition to being configured for dispense, the connector may be adapted for recirculation of the contents of the liner. The liner wall in an expanded shape could be substantially cylindrical, but other shapes, such as but not limited to a substantially rectangular or square cross-section, are possible. The liner could comprise a plurality of predetermined fold lines that allow the liner to be collapsed in a predetermined manner. The liner may thus be provided within the overpack by collapsing the liner in the predetermined manner, inserting the collapsed liner into a mouth of the overpack, and expanding the liner inside the overpack. In some cases, the overpack may include two interconnecting portions.

In yet further embodiments, the present disclosure relates to a liner having a polymeric liner wall forming an interior cavity of the liner, the liner wall having a thickness of between about 0.1 mm to about 3 mm such that the liner is substantially free-standing and a mouth configured for coupling with a pump dispense connector having a diptube. The pump dispense connector could be that of a conventional glass bottle dispensing system, as described herein. The liner could have an overpack layer and an liner layer disposed therein, and in some cases may be coblowmolded, or nested blowmolded, or integrally blow molded.

In other embodiments, the present disclosure relates a method for dispensing the contents of a liner-based system. The method may include providing a liner having a polymeric liner wall forming an interior cavity of the liner, the liner wall having a thickness of between about 0.1 mm to about 3 mm such that the liner is substantially free-standing and a mouth configured for coupling with a pump dispense connector having a diptube, wherein the pump dispense connector is that of a conventional glass bottle dispensing system. The mouth of the liner may be coupled to the pump dispense connector, and the contents of the liner may be dispensed via the pump dispense connector.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a side, cross-sectional view of a substantially rigid collapsible liner in accordance with an embodiment of the present disclosure.

FIG. 2 is a chart showing gas permeation over time.

FIG. 3 is a flow diagram for a method of applying a barrier enhancing material to a liner in accordance with an embodiment of the present disclosure.

FIG. 4 is a side, cross-sectional view of a substantially rigid collapsible liner in accordance with another embodiment of the present disclosure.

FIG. 5 is a cut-away view showing a liner with a sump, in accordance with one embodiment of the present disclosure.

FIG. 6 is a side, cross-sectional view of a substantially rigid collapsible liner in accordance with another embodiment of the present disclosure.

FIG. 7 is a side, cross-sectional view and a top view of a substantially rigid collapsible liner in accordance with a further embodiment of the present disclosure.

FIG. 8A is a perspective view of a liner in accordance with one embodiment of the present disclosure.

FIG. 8B is a perspective view of the liner of FIG. 8A shown in an expanded state.

FIG. 8C is a top view of the liner shown in FIG. 8A.

FIG. 8D is top view of the liner shown in FIG. 8B.

FIG. 8E shows the neck of a liner in an injection blow molding process, according to one embodiment of the present disclosure.

FIG. 9A is a perspective view of a liner in an expanded state, according to another embodiment of the present disclosure.

FIG. 9B is a perspective view of the liner of FIG. 9A shown in a collapsing state.

FIG. 10 is a front, cross-sectional view, side, cross-sectional view, and top view of a substantially rigid collapsible liner in accordance with yet another embodiment of the present disclosure.

FIG. 11A is a cut-away view of a connector for a liner according to one embodiment of the present disclosure.

FIG. 11B is a cut-away view of a connector for a liner according to another embodiment of the present disclosure.

FIG. 12 is a cut-away view of a connector for a liner according to one embodiment of the present disclosure.

FIG. 13A is a cut-away view of a connector for a liner according to one embodiment of the present disclosure.

FIG. 13B shows the embodiment of FIG. 13A wherein the tube has been welded shut after filling, according to one embodiment of the present disclosure.

FIG. 13C shows the embodiment of FIG. 13B including a protective overcap that has been secured to the connector, according to one embodiment of the present disclosure.

FIGS. 14A-F are various views of liners with handles, according to some embodiments of the present disclosure.

FIG. 15A is a perspective view of a liner with an overpack in two parts, in accordance with some embodiments of the present disclosure.

FIG. 15B is a perspective view of a liner with the overpack of 15A connected, according to some embodiments of the present disclosure.

FIG. 16 is a cut-away view of a liner, according to one embodiment of the present disclosure.

FIG. 17 is a perspective view of an overpack that may be used with certain embodiments of the present disclosure.

FIG. 18A is an end view of a liner in a collapsed state, according to some embodiments of the present disclosure.

FIG. 18B is a perspective view of an inflated liner, according to one embodiment of the present disclosure.

FIG. 19 is a view of an inflated liner with an inversion point.

FIG. 20A is a perspective view of a collapsed liner showing secondary fold lines, in accordance with some embodiments of the present disclosure.

FIG. 20B is a perspective view of an expanded liner of FIG. 20A, in accordance with some embodiments of the present disclosure.

FIG. 21 is a perspective view of a liner half-way inside of an overpack, in accordance with some embodiments of the present disclosure.

FIG. 22A is a perspective view of a bottom of a liner that has not fully expanded, according to some embodiments of the present disclosure.

FIG. 22B is a perspective view of a bottom of a liner that has fully expanded, according to some embodiments of the present disclosure.

FIG. 23A is a perspective view of the bottom of a liner in an expanded view, in accordance with some embodiments of the present disclosure.

FIG. 23B is a perspective view of the bottom of a liner in a collapsed state, in accordance with some embodiments of the present disclosure.

FIG. 23C is a perspective view of a liner in an expanded state in accordance with some embodiments of the present disclosure.

FIG. 23D is a two dimensional view showing the difference between how many cylindrically shaped liners versus rectangular liners can be stored in the same area.

FIG. 24A is a side, cross-sectional view of an injection step of a process of injection blow molding a liner, wherein a liner preform is fabricated in accordance with an embodiment of the present disclosure.

FIG. 24B is a side, cross-sectional view of an injection step of a process of injection blow molding a liner in accordance with an embodiment of the present disclosure, wherein a liner preform is removed from a preform mold.

FIG. 24C is a side, cross-sectional view of a preform conditioning step of a process of injection blow molding a liner in accordance with an embodiment of the present disclosure.

FIG. 24D is a side, cross-sectional view of a blow molding step of a process of injection blow molding a liner in accordance with an embodiment of the present disclosure.

FIG. 24E is a side, cross-sectional view of another blow molding step of a process of injection blow molding a liner in accordance with an embodiment of the present disclosure, wherein a liner preform is blown to the dimensions of a liner mold.

FIG. 24F is a cross-sectional view of nested preforms for use in a co-blow molding process in accordance with another embodiment of the present disclosure.

FIG. 24G is a cross-sectional view of a liner in accordance with one embodiment of the present disclosure.

FIG. 24H is a cross-sectional view of an overpack and a chime in accordance with one embodiment of the present disclosure.

FIG. 24I is a cross-sectional view of a liner in an overpack and a chime in accordance with an embodiment of the present disclosure.

FIG. 24J is a view from inside of a n overpack looking from the bottom of the overpack to the top in accordance with one embodiment of the present disclosure.

FIG. 24K is a perspective view of a preform in accordance with one embodiment of the present disclosure.

FIG. 24L is perspective view of a preform in accordance with one embodiment of the present disclosure.

FIG. 24M is a cross-sectional end view of the embodiment of FIG. 24L in accordance with present disclosure.

FIG. 24N is a cross-sectional end view of a liner preform and its corresponding expanded liner in accordance with one embodiment of the present disclosure.

FIG. 24O is a perspective view of a preform in accordance with another embodiment of the present disclosure.

FIG. 24P is a top view of a liner-based system with air channels according to one embodiment of the present disclosure.

FIG. 24Q is a top view of a liner-based system with support rings and air passages according to one embodiment of the present disclosure.

FIG. 24R is view of air channels in an overpack aligning with air passages in a support ring according to one embodiment of the present disclosure.

FIG. 25 shows a liner-based system of the present disclosure including surface features according to one embodiment of the present disclosure.

FIG. 26 shows a liner-based system of the present disclosure including surface features according to another embodiment of the present disclosure.

FIG. 27 shows a liner-based system of the present disclosure including surface features according to yet another embodiment of the present disclosure.

FIG. 28 shows a liner-based system of the present disclosure including surface features according to yet another embodiment of the present disclosure.

FIG. 29 shows a liner-based system of the present disclosure including a chime according to another embodiment of the present disclosure.

FIG. 30 is a cross-sectional view of a blow molding step of a process of injection blow molding or injection stretch molding in accordance with another embodiment of the present disclosure.

FIG. 31A is perspective view of a dispensing canister for dispensing liquid stored in a liner in accordance with an embodiment of the present disclosure.

FIG. 31B is a graph plotting pressure vs. time that shows how the inlet gas pressure rises sharply as the contents of the liner are nearly empty.

FIG. 31C is a perspective view showing a process for dispensing liquid stored in a liner in accordance with another embodiment of the present disclosure.

FIG. 32 is a perspective view showing a liner being loaded into a pressure vessel via a transport cart, according to one embodiment of the present disclosure.

FIG. 33A is a perspective view of a substantially rigid collapsible liner or substantially rigid liner in accordance with an embodiment of the present disclosure including a cap.

FIG. 33B is a perspective view of a substantially rigid collapsible liner or substantially rigid liner in accordance with another embodiment of the present disclosure including a temporary cap or “dust” cap.

FIG. 33C is a perspective view of a substantially rigid collapsible liner or substantially rigid liner in accordance with an embodiment of the present disclosure with a connector.

FIG. 33D is a perspective view of a substantially rigid collapsible liner or substantially rigid liner in accordance with an embodiment of the present disclosure with a misconnect prevention closure.

FIG. 33E is a perspective view of a substantially rigid collapsible liner or substantially rigid liner in accordance with an embodiment of the present disclosure with a misconnect prevention connector.

FIG. 33F is a broken, cross-sectional view of a substantially rigid collapsible liner or substantially rigid liner in accordance with an embodiment of the present disclosure including a pressure dispense connector.

FIG. 33G are perspective views of a caps and a neck insert for a substantially rigid collapsible liner or substantially rigid liner in accordance with embodiments of the present disclosure.

FIG. 34A includes perspective views of a conventional rigid-wall liner or glass bottle and a liner and overpack system in accordance with one embodiment of the present disclosure.

FIG. 34B is an expanded view of a liner and overpack system in accordance with one embodiment of the present disclosure.

FIG. 34C is a cut-away view of an overpack and cap according to one embodiment of the present disclosure.

FIG. 34D is a cut-away view of an overpack and cap according to another embodiment of the present disclosure.

FIG. 34E is a perspective view of liner-based system according to one embodiment of the present disclosure.

FIG. 35 is a perspective view of a liner and overpack system in accordance with another embodiment of the present disclosure, illustrating alignment means of the overpack.

FIG. 36A is a cross-sectional view of a liner and overpack system in accordance with another embodiment of the present disclosure, illustrating an interconnecting mechanism of the overpack.

FIG. 36B is a cross-sectional view of a liner and overpack system in accordance with yet another embodiment of the present disclosure, illustrating another cap embodiment.

FIG. 37 a perspective view of a liner and overpack system in accordance with another embodiment of the present disclosure, illustrating a protective cap sleeve.

FIG. 38 is a cross-sectional view of a liner system according to one embodiment of the present disclosure.

FIG. 39 is a cross-sectional view of a liner system according to another embodiment of the present disclosure.

FIG. 40A includes perspective views of a conventional rigid-wall liner and a liner and overpack system in accordance with one embodiment of the present disclosure, connected to a pump dispense connector.

FIG. 40B includes cross-sectional views of a conventional rigid-wall liner and a liner and overpack system in accordance with one embodiment of the present disclosure, connected to a pump dispense connector.

FIG. 40C is a perspective view of a liner-based system according to one embodiment of the present disclosure.

FIG. 40D is a perspective view of a liner-based system according to another embodiment of the present disclosure.

FIG. 40E is a cross-sectional view of a liner-based system according to another embodiment of the present disclosure.

FIG. 41A is a perspective view of a liner and overpack system in accordance with another embodiment of the present disclosure, connected to a pressure dispense connector.

FIG. 41B is a broken, cross-sectional view of a liner-based system according to one embodiment of the present disclosure.

FIGS. 41C and D are perspective views of liner-based systems according to embodiments of the present disclosure.

FIGS. 41E and F are cross-sectional views of liner-based systems according to embodiments of the present disclosure.

FIG. 42A includes perspective views of a conventional rigid-wall liner and a liner and overpack system in accordance with one embodiment of the present disclosure, connected to a conventional pump dispense connector modified for pressure dispense.

FIG. 42B includes cross-sectional views of a conventional rigid-wall liner and a liner and overpack system in accordance with one embodiment of the present disclosure, connected to a conventional pump dispense connector modified for pressure dispense.

FIG. 42C is a close-up, cross-sectional view of the connector of FIGS. 42A and 42B.

FIG. 43 is a cross-sectional view of a connector in accordance with one embodiment of the present disclosure.

FIG. 44 is a perspective view of a liner and overpack system in accordance with yet another embodiment of the present disclosure.

FIG. 45A is a cross-sectional view of the liner and overpack system of FIG. 44.

FIG. 45B is an expanded view of the liner and overpack system of FIG. 44.

FIG. 45C is a perspective view of the liner of FIGS. 45A and 45B.

FIG. 46A is a view of a connector with two channels in accordance with an embodiment of the present disclosure.

FIG. 46B is a side, cross-sectional view of a substantially rigid collapsible liner with a connector having two channels in accordance with an embodiment of the present disclosure.

FIG. 47 shows a liner and overpack system, in accordance with one embodiment of the present disclosure.

FIG. 48 shows a liner and overpack system including a bladder, in accordance with one embodiment of the present disclosure.

FIG. 49 shows a liner and overpack system, in accordance with another embodiment of the present disclosure.

FIG. 50 shows a liner and overpack system that includes suspending the liner from the overpack, in accordance with one embodiment of the present disclosure.

FIG. 51A shows the texture on the inside of a liner, in accordance with one embodiment of the present disclosure.

FIG. 51B shows two sides of a liner together according to the embodiment shown in FIG. 51A.

FIG. 52 shows a liner with choke-off prevention means, in accordance with one embodiment of the present disclosure.

FIG. 53A shows a liner, in accordance with another embodiment of the present disclosure.

FIG. 53B shows a liner, in accordance with yet another embodiment of the present disclosure.

FIG. 54A shows a liner, in accordance with one embodiment of the present disclosure.

FIG. 54B shows the liner of FIG. 54A and the direction in which the liner will collapse, in accordance with one embodiment of the present disclosure.

FIG. 55A shows a liner with a framework, in accordance with one embodiment of the present disclosure.

FIG. 55B shows a lattice of the framework of the liner shown in FIG. 55A, in accordance with one embodiment of the present disclosure.

FIG. 56 shows a liner, in accordance with another embodiment of the present disclosure.

FIG. 57A shows a liner that connects to rails, in accordance with one embodiment of the present disclosure.

FIG. 57B shows the rails of the embodiment shown in FIG. 57A, in accordance with one embodiment of the present disclosure.

FIG. 58 shows a liner wherein the bottom acts as a piston, in accordance with one embodiment of the present disclosure.

FIG. 59 shows a perspective view of a choke off preventer for use with some embodiments of liners of the present disclosure.

FIG. 60 is a perspective view of an apparatus that may be used to prevent choke-off according to one embodiment of the present disclosure.

FIG. 61 is a perspective view of an apparatus that may be used to prevent choke-off according to another embodiment of the present disclosure.

FIG. 62 is a perspective view of an apparatus that may be used to prevent choke-off according to yet another embodiment of the present disclosure.

FIG. 63 is a cross-sectional view of a contractible layer that may be added to a liner to prevent choke-off according to one embodiment of the present disclosure.

FIG. 64 is a perspective view of an insert that may be used to prevent choke-off according to one embodiment of the present disclosure.

FIG. 65 is a perspective view of an insert that may be used to prevent choke-off according to another embodiment of the present disclosure.

FIG. 66 is a perspective view of an insert that may be used to prevent choke-off according to yet another embodiment of the present disclosure.

FIG. 67 is an end perspective view of a liner that may be used to prevent choke-off according to one embodiment of the present disclosure.

FIG. 68 shows an interior surface of a liner with surface features according to one embodiment of the present disclosure.

FIG. 69 shows an interior surface of a liner with surface features according to another embodiment of the present disclosure.

FIG. 70 shows an interior surface of a liner with surface features according to yet another embodiment of the present disclosure.

### DETAILED DESCRIPTION

The present disclosure relates to novel and advantageous liner-based storage and dispensing systems. More particularly, the present disclosure relates to novel and advantageous substantially rigid collapsible liners and flexible liners including gusseted or non-gusseted liners and methods for manufacturing such liners. The present disclosure also relates to methods for preventing or eliminating choke-off in liners. More particularly, the present disclosure relates to a blow-molded, substantially rigid collapsible liner that can be suitable particularly for smaller storage and dispensing systems, such as storage of about 2000 L or less of liquid, and more desirably about 200 L or less of liquid. The substantially rigid collapsible liner can be formed from materials with inert properties. Furthermore, the substantially rigid collapsible liner may be a stand-alone liner, e.g., used without an outer container, and may be dispensed from using a pump or a pressurized fluid. Unlike certain prior art liners that are formed by welding films together with resultant folds or seams, folds in the substantially rigid collapsible liner may be substantially eliminated, thereby substantially reducing or eliminating the problems associated with pinholes, weld tears, gas saturation, and overflow.

The present disclosure also relates to a flexible gusseted or non-gusseted liner, which is scalable in size and may be used for storage of up to 200 L or more. The flexible liner may be foldable, such that the liner can be introduced into a dispensing container, for example but not limited to, a pressure vessel, can, bottle, or drum. However, unlike certain prior art liners, among other things, the flexible liner of the present disclosure can be made of thicker materials, substantially reducing or eliminating the problems associated with pinholes, and may include more robust welds, substantially reducing or eliminating the problems associated with weld tears. The flexible liner can further be configured such that the number of folds is substantially reduced.

Example uses of the liners disclosed herein may include, but are not limited to, transporting and dispensing acids, solvents, bases, photoresists, chemicals and materials for OLEDs, such as phosphorescent dopants that emit green light, for example, ink jet inks, slurries, detergents and cleaning formulations, dopants, inorganic, organic, metalorganics, TEOS, and biological solutions, DNA and RNA solvents and reagents, pharmaceuticals, hazardous waste, radioactive chemicals, and nanomaterials, including for example, fullerenes, inorganic nanoparticles, sol-gels, and other ceramics, and liquid crystals, such as but not limited to 4-methoxylbenzylidene-4′-butylaniline (MBBA) or 4-cyanobenzylidene-4′-n-octyloxyanaline (CBOOA). However, such liners may further be used in other industries and for transporting and dispensing other products such as, but not limited to, coatings, paints, polyurethanes, food, soft drinks, cooking oils, agrochemicals, industrial chemicals, cosmetic chemicals (for example, foundations, bases, and creams), petroleum and lubricants, adhesives (for example, but not limited to epoxies, adhesive epoxies, epoxy and polyurethane coloring pigments, polyurethane cast resins, cyanoacrylate and anaerobic adhesives, reactive synthetic adhesives including, but not limited to, resorcinol, polyurethane, epoxy and/or cyanoacrylate), sealants, health and oral hygiene products, and toiletry products, etc. Those skilled in the art will recognize the benefits of such liners and the process of manufacturing the liners, and therefore will recognize the suitability of the liners to various industries and for the transportation and dispense of various products.

The present disclosure also relates to methods for limiting or eliminating choke-off in liners. Generally speaking, choke-off may be described as what occurs when a liner necks and ultimately collapses on itself, or a structure internal to the liner, to form a choke point disposed above a substantial amount of liquid. When a choke-off occurs, it may preclude complete utilization of the liquid disposed within the liner, which is a significant problem, as specialty chemical reagents utilized in industrial processes such as the manufacture of microelectronic device products can be extraordinarily expensive. A variety of ways of preventing or handling choke-off are described in PCT Application Number PCT/US08/52506, entitled, “Prevention Of Liner Choke-off In Liner-based Pressure Dispensation System,” with an international filing date of Jan. 30, 2008, which is hereby incorporated herein by reference in its entirety.

As explained herein, various features of liner-based systems disclosed in embodiments described herein may be used in combination with one or more other features described with regard to other embodiments. That is, liners of the present disclosure may include any one or more of the features described herein, whether or not described as the same or another embodiment. For example, any embodiment (unless specifically stated otherwise) may include a stand-alone liner, or a liner and an overpack; may include a flexible liner, semi-rigid, substantially rigid, or rigid collapsible liner; may include a dip tube or not include a dip tube; may be dispensed by direct or indirect pressure dispense, pump dispense, pressure assisted pump dispense, gravity dispense, pressure assisted gravity dispense, or any other method of dispense; may include any number of layers; may have layers made of the same or different materials; may include a liner made of the same or different material as the overpack; may have any number of surface or structural features; may be filled with any suitable material for any suitable use; may be filled by any suitable means, using any suitable cap or connector; may have one or more barrier coatings; may include a sleeve, chime, or base cup; may include a desiccant; may have one or more methods for reducing choke-off; may be configured for use with any one or more caps, closures, connectors, or connector assemblies as described herein; the material comprising the liner and/or overpack may include one or more additives; the liner and/or overpack may be manufactured by any suitable means or means described herein, including, but not limited to, welding, molding, including blow molding, extrusion blow molding, stretch blow molding, injection blow molding, and/or co-blow molding; and/or the liners, overpacks, or liner-based systems may have any other combination of features herein described. While some embodiments are particularly described as having one or more features, it will be understood that embodiments that are not described are also contemplated and within the spirit and scope of the present disclosure, wherein those embodiments comprise any one or more of the features, aspects, attributes, properties or configurations or any combination thereof of storage and dispense systems described herein.

### Substantially Rigid Collapsible Liners

As stated above, the present disclosure relates to various embodiments of a blow-molded, substantially rigid collapsible liner that may be suitable particularly for smaller storage and dispensing systems, such as storage of about 2000 L or less of liquid, and more desirably about 200 L or less of liquid. Accordingly, the substantially rigid collapsible liners may be suitable for storage of high purity liquids, which can be very expensive (e.g., about $2,500/L or more), that are used in the integrated circuit or flat panel display industries, for example.

As used herein, the terms “rigid” or “substantially rigid,” in addition to any standard dictionary definitions, are meant to also include the characteristic of an object or material to substantially hold its shape and/or volume when in an environment of a first pressure, but wherein the shape and/or volume may be altered in an environment of increased or decreased pressure. The amount of increased or decreased pressure needed to alter the shape and/or volume of the object or material may depend on the application desired for the material or object and may vary from application to application.

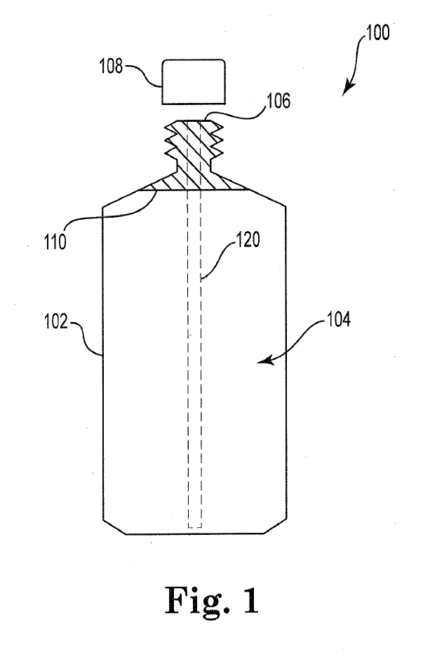

FIG. 1 illustrates a cross-sectional view of one embodiment of a substantially rigid collapsible liner 100 of the present disclosure. Liner 100 may include a substantially rigid liner wall 102, an interior cavity 104, and a mouth 106.

Liner wall 102 may generally be thicker than the liners in conventional collapsible liner-based systems. The increased thickness of liner wall 102 and/or the composition of the film comprising the liner increases the rigidity and strength of liner 100. Because of the rigidity, in one embodiment, as shown in FIG. 1, liner 100 may be free-standing and used similar to conventional rigid-wall containers, for example glass bottles. In another embodiment, the liner 100 may be free-standing during filling, transportation, and storage. That is, an outer container is not necessary for support of the liner as with liners in conventional collapsible liner-based systems. In one embodiment, a pressure vessel may be used when pressure dispensing liquid from liner 100 during chemical delivery. In a further embodiment, liner 100 may be a free-standing container system. Such embodiments can reduce the overall cost of the container system by substantially eliminating the cost associated with the outer containers. Additionally, in conventional collapsible liner-based systems, the liner and outer container are both typically non-reusable and need to be disposed. In various embodiments of the present disclosure, since an outer container is not necessary, waste can be substantially reduced or minimized because only the liner would be disposed. In one embodiment, liner wall 102 may be from about 0.05 mm to about 3 mm thick, desirably from about 0.2 mm to about 1 mm thick. However, the thickness may vary depending on the volume of the liner. Generally, liner 100 can be thick and rigid enough to substantially reduce or eliminate the occurrence of pinholes.

As mentioned above, both the composition of the film comprising the liner as well as the thickness of the liner wall 102 can provide rigidity to liner 100. The thickness is selected so that, when a specified amount of pressure or vacuum is applied to liner 100, liner wall 102 is collapsible to dispense liquid from within interior cavity 104. In one embodiment, the dispensability of liner 100 may be controlled based on the thickness selected for liner wall 102. That is, the thicker liner wall 102 is, the more pressure that will need to be applied to fully dispense the liquid from within interior cavity 104. In further embodiments, the liner 100 may be initially shipped in a collapsed or folded state to save shipping space, and allow more liners 100 to be shipped to a recipient, for example a chemical supplier, in one shipment. The liner 100 could subsequently be filled with any of the various liquids or products previously mentioned.

Liner mouth 106 may be generally rigid, and in some embodiments, more rigid than liner wall 102. Mouth 106 may be threaded or include a threaded fitment port, such that mouth 106 may receive a cap 108 that has been complimentarily threaded. It is recognized that any other suitable connection mechanism, such as bayonet, snap-fit, etc., may be used in place of, or in addition to, threads. In some embodiments, because the liner mouth 106 may be more rigid than liner wall 102, the area near the liner mouth may not collapse as much as liner wall 102 when pressure is applied during dispensing. Thus, in some embodiments, during pressure dispense of the contents within the liner, liquid may be entrapped in a dead space where the area near the liner mouth has not fully collapsed. Accordingly, in some embodiments, a connector 110 or connecting means, for connecting with a corresponding connector of a pressure dispensing system and output line, may substantially penetrate or fill the generally rigid area of the liner near the mouth. That is, the connector 110 may substantially fill the dead space so that liquid is not entrapped during pressure dispense, thereby reducing or eliminating dead space waste. The connector 110, in some embodiments, may be manufactured of a substantially rigid material, such as plastic.

In further embodiments, liner 100 may be equipped with an internal hollow dip tube 120 (illustrated in broken line in FIG. 1) having an aperture at the lower or distal end thereof serving as a point of fluid egress from liner 100. The hollow dip tube 120 may be integral with, or separate from, connector 110. In this regard, the contents within liner 100 may be received directly from liner 100 via the dip tube 120. Although FIG. 1 illustrates a liner that may be equipped with an optional dip tube 120, liner 100 according to various embodiments described herein is, in many cases, preferably devoid of any dip tube. In some embodiments of a liner 100 that includes the use of a dip tube 120, the dip tube 120 may also be used to pump dispense the contents within the liner 100.

Liner 100 may have a relatively simplistic design with a generally smooth outer surface, or liner 100 may have a relatively complicated design, including, for example and not limited to, pleats, ridges, indentations, protrusions, and/or other types of form features. In one embodiment, for example, liner 100 may be textured to prevent choke-off, which along with other embodiments, will be discussed herein. That is, liner 100 may be textured to prevent the liner from collapsing in on itself in a manner that would trap liquid within the liner and preclude the liquid from being dispensed properly.

In some embodiments, liner 100 may be manufactured using one or more polymers, including plastics, nylons, EVOH, polyolefins, or other natural or synthetic polymers. In further embodiments, liner 100 may be manufactured using polyethylene terephthalate (PET), polyethylene naphthalate (PEN), poly(butylene 2,6-naphthalate) (PBN), polyethylene (PE), linear low-density polyethylene (LLDPE), low-density polyethylene (LDPE), medium-density polyethylene (MDPE), high-density polyethylene (HDPE), and/or polypropylene (PP). In some embodiments, the material or materials selected and the thickness of that material or those materials may determine the rigidity of the liner 100.

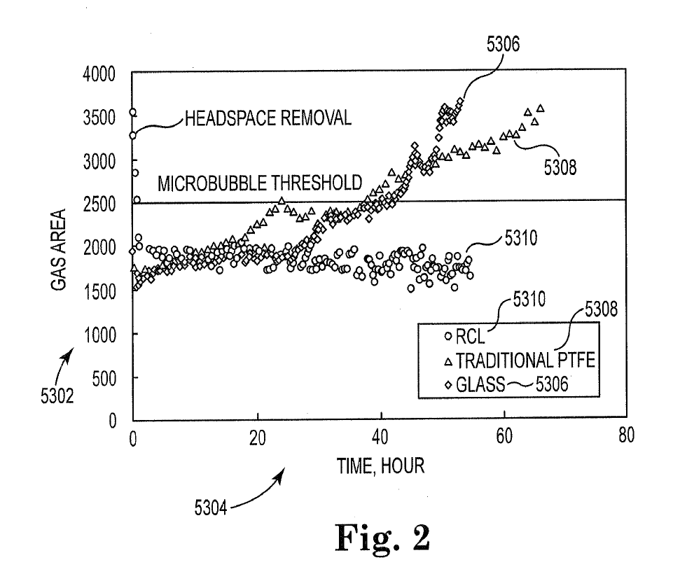

Liners made using PEN, for example, may have lower permeability, and thus, allow less gas from outside the liner 100 to infiltrate the liner wall 102 and contaminate the liquid stored within the liner 100. Generally, the amount of permeation of gas into the contents of the liner through the liner wall during, for example, pressure dispense, may be dependent upon the type of material of which the liner is made and/or the thickness of the liner. In some embodiments, the use of PEN, for example, may decrease, and in some cases significantly decrease, the amount of permeation that may occur as compared to conventional liners. In some embodiments of the present disclosure using PEN, as an example, the permeation of nitrogen (N₂) as measured in cm³/(m² day) may be below the ability for conventional instruments to detect—that is, below 1 cm³/(m² day). This may generally be seen in FIG. 2, which shows the amount of gas entrainment on the y-axis 5302 over a period of time on the x-axis 5304. As can be seen, the amount of gas entrainment rises significantly over time for both conventional rigid glass containers 5306 and traditional PTFE containers 5308. However, the amount of gas entrainment remains relatively steady over time for some rigid collapsible liners of the present disclosure 5310 that may be comprised of, for example, PEN.

Another advantage of using liners of the present disclosure comprised of, for example, PEN, PET, or PBN, can include that such liners may substantially prohibit or limit the amount of extractable organic compounds that may otherwise contaminate the contents of a liner. For example, an analytical analysis of the extractable organic compounds of liners of the present disclosure may be at least comparable to conventional PTFE liners, and in some cases may be better. In some cases, the percentage of extractable organic compounds found in the contents of embodiments of the present disclosure may be as low as less than about 0.0001%. Similarly, trace metal extractables may be kept to about less than 5 parts per billion (ppb) for all trace metals and to about less than 1 ppb per individual trace metal, and preferably less than 1 ppb for all metals and less than 0.5 ppb for individual trace metals, in some embodiments. The total amount of organic carbon may similarly be kept to about an average of 20 ppb or less, for example, in some embodiments of the present disclosure. In other embodiments, the total amount of organic carbon may be kept to about less than 30 ppb. Additionally, in some embodiments of the present disclosure, the number of particles of size 0.15 microns or larger that are present in the contents of the liner may be limited to less than about 15 particles per milliliter, for example, and in some embodiments to less than about 10 particles per milliliter.

Liners made using PE, LLDPE, LDPE, MDPE, HDPE, and/or PP may also be suitable for larger storage and dispensing systems, such as storage of about 2000 L or less of liquid.

In addition to the substantially rigid collapsible liners discussed under this heading, in an alternative embodiment, PEN, PET, or PBN, and optionally any suitable mixtures or mixtures of copolymers may be used to make generally rigid liners, similar to rigid-wall containers described above, so that such rigid liners may be introduced to, for example, the semi-conductor industry, and used with high purity liquids. Such liners comprising PEN, PET, or PBN improve chemical compatibility compared to other plastic containers and are safer to use compared to glass bottles, thereby allowing them to be used in industries typically reserved for conventional rigid wall containers.

PEN liners of the present disclosure in some embodiments, for example, may be designed for a single use. Such liners may be an advantageous alternative to prior art glass bottles because they may have an overall cost lower than that of glass bottles when all factors are considered, including the cost of ownership, shipping, sanitizing, etc. that may be associated with glass bottles. Further, a PEN liner may be more advantageous than glass because, as is well known, glass may break, which may result not only in contamination or loss of the material in the bottle, but also may create safety concerns. In contrast, the PEN liners of the present disclosure may be break-proof. In some embodiments, the PEN liner may be a stand-alone liner that may not use an overpack. In other embodiments, an overpack may be used with the liner. In some embodiments, the PEN liner may include a sump to help increase the dispensability of the contents of the liner, the sump is described in detail below and would be used in a substantially similar manner in a PEN embodiment. The dispense of the PEN liners in some embodiments may include both pump dispense or pressure dispense. However, in some embodiments, because the PEN liner may be generally non-collapsible the pressure dispense may apply pressure directly on the contents of the liner as opposed to on the exterior walls of the liner as may be the case for other embodiments described herein. In some embodiments, the PEN liner may have reduced carbon dioxide emissions. The PEN liner embodiments may be used in substantially the same way as other liners described in the present disclosure.

In alternative embodiments, liner 100 may be manufactured using a fluoropolymer, such as but not limited to, polychlorotrifluoroethylene (PCTFE), polytetrafluoroethylene (PTFE), fluorinated ethylene propylene (FEP), and perfluoroalkoxy (PFA). In some embodiments, liner 100 may comprise multiple layers. For example, in certain embodiments, liner 100 may include an internal surface layer, a core layer, and an outer layer, or any other suitable number of layers. The multiple layers may comprise one or more different polymers or other suitable materials. For example, the internal surface layer may be manufactured using a fluoropolymer (e.g., PCTFE, PTFE, FEP, PFA, etc.) and the core layer may be a gas barrier layer manufactured using such materials as nylon, EVOH, polyethylene naphthalate (PEN), PCTFE, etc. The outer layer may also be manufactured using any variety of suitable materials and may depend on the materials selected for the internal surface layer and core layer. It is recognized that the various embodiments of substantially rigid liners described herein may be manufactured from any suitable combination of materials disclosed herein.

In still alternative embodiments, the polymeric liner of the present disclosure may be manufactured using a metal outer layer, for example, but not limited to AL (aluminum), steel, coated steels, stainless steels, Ni (nickel), Cu (copper), Mo (molybdenum, W (tungsten), chromium-copper bi-layer, titanium-copper bi-layer, or any other suitable metal material or combination of materials. In some embodiments, metal coated liners may be overcoated with a protective dielectric, for example, SiO₂ from TEOS (tetraethylorthosilicate), or SiCl₄ (silicon tetrachloride), MO (metal organics), TiO₂ from TiCl₄ (titanium tetrachloride), or other suitable metal oxide material, or any other suitable metal, or some combination thereof. Metal liners may be advantageous for storing and shipping substances, including ultra-pure substances because a metal liner may be substantially impermeable to gases, thus reducing oxidation and/or hydrolysis of the contents and maintaining the purity of the substance contained in the liner. Because of the impermeability of the metal, a liner of this embodiment may be substantially free of pinholes or weld tears and may be very robust and have a consistent fill volume.

In still another embodiment, the liner of the present disclosure may be manufactured using a metal container, for example, but not limited to aluminum, nickel, stainless steel, thin-walled steel, or any other suitable metal material or combination of materials. In some embodiments, these metal containers are coated on the internal surface with inert films to reduce interaction of the high purity chemical with the metal walls. The films may be inert metals, metal oxides, metal nitrides or metal carbides chosen specifically to reduce the chemical interactions and degradation of the chemical inside the metal container. In another embodiment, a metal container may have an internal surface coated with glass, plastic, SiO2, or any other suitable material or combination of materials. Because of the rigidity of the metal, a liner of this embodiment may be substantially free of pinholes or weld tears and may be very robust and have a consistent fill volume.

Traditionally, however, metal cans have been expensive to use. For instance, the cost of a metal container may often times be greater than the cost of the substance stored in the container. Accordingly, in order to be cost-effective, such a metal container generally is used repeatedly, which in turn requires that the container be shipped back for reuse and appropriately cleaned prior to refilling. Shipping the containers back and cleaning the containers for reuse may be both time consuming and expensive. In some embodiments of the present disclosure, however, a rigid collapsible metal container may be manufactured for a cost effective single use by, for instance, manufacturing the walls of the metal liner to be relatively thin as compared to prior art metal containers. For example, in some embodiments, the liner walls may be from 0.1 to 3.0 mm thick. More preferably, the walls may be from 0.6 to 2 mm thick, in some embodiments. The thickness of the walls may allow a metal liner of the present disclosure to be substantially rigid but collapsible under pressure. Metal liners may be sized for holding generally large volumes, for example, up to approximately 2000 L in some embodiments, while in other embodiments metal liners may be sized to hold approximately 200 L or less.

In another embodiment, a plastic liner may be provided that may be coated with a metal. For example, a liner may be formed of a polymer such as PP, PE, PET, PEN, HDPE or any other suitable polymer, or combination of polymers as described above. The outside of the liner may be metallized with, such as but not limited to aluminum. In some embodiments, a metal may be applied to the container walls by vapor deposition, such as but not limited to chemical vapor deposition. It will be recognized that any suitable metal may be used to metalize the outside of a polymer liner according to this embodiment. The liner may be metallized by any suitable method, such as, for example, plating, electro-plating, spraying, etc. Metalizing the outside of the liner may substantially decrease or eliminate the effects of gas permeability. Because of the impermeability provided by the metal coating, a liner of this embodiment may be substantially free of pinholes or weld tears and may be very robust and have a consistent fill volume. Similar to the liners described above, metal coated liners of this type may also be sized to hold up to approximately 2000 L in some embodiments, while other embodiments may be sized to hold approximately 200 L or less. The metal liners and metal coated liners described herein may include folds, pleats, handles, sumps, and/or any other liner configuration and/or feature described herein with reference to other embodiments.

In some embodiments, the liner of the present disclosure may be coated with a barrier-enhancing coating, such as, for instance, an epoxy amine coating. However, it is recognized that other suitable coating polymers or mixtures of polymers may be used as a barrier-enhancing coating. The coating may be particularly advantageous where the liner is comprised of PET, or other polymeric materials, however the coating may be applied to any of the liners contemplated in the present disclosure. The application of an epoxy amine coating may reduce gas permeability bi-directionally, that is, the coating may reduce the amount of gas that may get into the liner, as well as the amount of gas that may leave the liner. Applying the coating may also increase the shelf-life of the liner and its contents. Further, application of the barrier-enhancing coating may reduce oxygen or moisture permeability and may enable a broader array of materials to be stored in the liner, for example but not limited to, liquids that display air sensitivity, such as gallic acid cleaning formulations and/or CVD precursor materials.

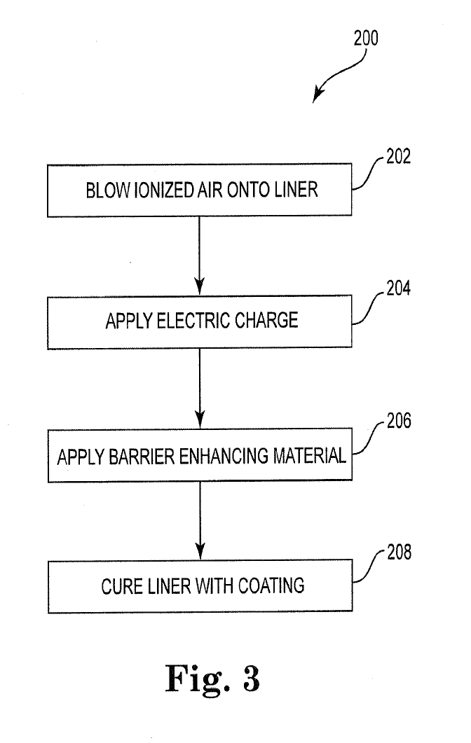

The coating may be sprayed onto the bag prior to folding, or after the liner is completely assembled. It will be understood that the coating may be applied to the interior and/or exterior of the liner, or in embodiments with multiple layers, the coating may be applied to one or both sides of one or all layers of the liner. The coating may be applied in variable thicknesses dependent upon the shelf-life desired, e.g., the thicker the coating, the longer the shelf-life. However, it will be recognized that the barrier-enhancing coating may be applied in any suitable thickness, and cured over varying amounts of time depending on the desired application. Further, the crosslink density of the barrier film and the surface adhesion of the barrier film may vary depending on the degree of barrier protection desired. Generally, the surface of the liner may be chemically, physically, electrochemically, or electrostatically modified, such as by application of a coating, to enhance the barrier qualities of the liner. In some embodiments the barrier enhancing material may be generally applied to a liner in the manner illustrated in the flow diagram of FIG. 3. In one step 202, a fan may be used to blow ionized air onto the liner in order to clean the surface in preparation for receiving the coating material. In one embodiment, as shown in step 204, an electrical charge may then be applied. The barrier enhancing material may then be applied to the liner, for example but not limited to, using electrostatic spray guns 206. Chucks may spin the liners as they proceed through the coatings application area, ensuring a uniform coating is applied. Any overspray may be collected and disposed of. The coated-liner may then be cured in a curing oven 208. In another embodiment, the barrier enhancing material may be provided in or as another liner layer as opposed to a coating.

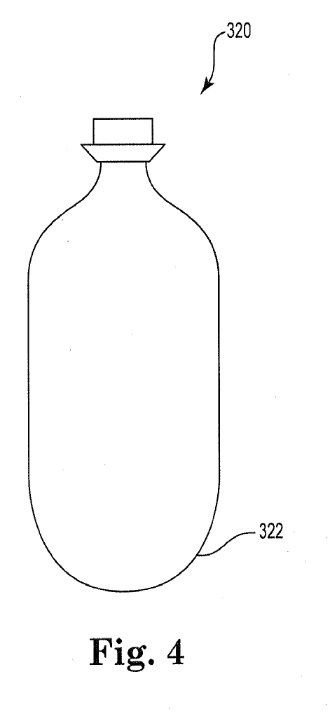

Liners of the present disclosure may take a number of advantageous shapes. As can be seen in FIG. 4, in one embodiment, a rigid collapsible liner 320 may be configured such that the bottom of the liner is rounded or bowl-shaped 322. In such embodiments, the degree of rounding may vary. The rounding of the bottom surface may be such that the liner 320 may still be free-standing in some embodiments. In still other embodiments, the rounding may be to such a degree that the liner may optimally be used in conjunction with an outer container an overpack, chime, or a sleeve. Embodiments of liners with rounded bottoms may help improve chemical utilization in, for instance, a pump dispense application as the rounding of the bottom surface may help properly direct a dip tube to the bottom of the liner, for example. Such an embodiment may be particularly useful with liners that are opaque, for instance, which may also help improve chemical utilization and dip tube alignment.

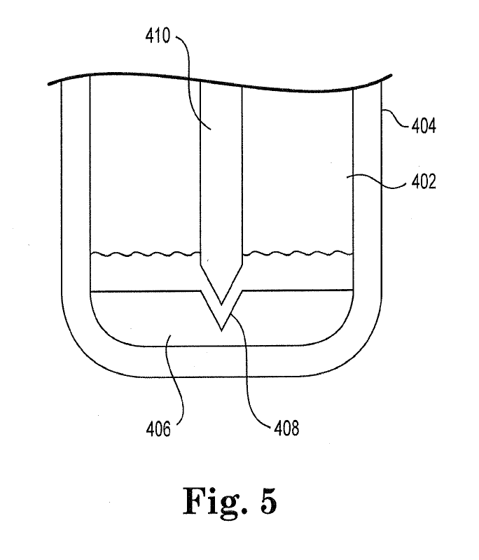

As shown in FIG. 5, in another embodiment of a liner, a rigid collapsible liner 402 may include a sump 406 that may help improve dispensability. In some embodiments, the liner 402 may be placed in an overpack 404. The sump 406 may be an area of generally rigid material at the bottom of the liner defining a divot or cup 408 forming the sump 406. As seen in FIG. 5, the divot area 408 may funnel the liquid in the liner 402 to the divot area 408. A dip tube 410 that may be inserted into the liner 402 may then be used to dispense substantially all of the liquid in the liner, thus allowing a greater amount of the liquid to be dispensed than in prior art liners without a directing sump 406. The sump may be made of the same material as the liner in some embodiments, or the sump may be made of another suitable material such as another type of plastic, for example. The use of a liner with a sump may be particularly advantageous in use with liners that may not collapse, or may not fully collapse.

Because liner 100, as shown in FIG. 1, may have a relatively simplistic design, the liner wall may comprise few or substantially no folds in substantially rigid liner wall 102 in some embodiments. In one embodiment, shown in FIG. 6, for instance, the liner 500 may be shaped similar to a conventional water or soda bottle. Therefore, an additional advantage of the various embodiments of the present disclosure includes a fixed fill volume. That is, liner 100 can be designed for a specific volume, and because there can be few or substantially no folds in substantially rigid liner wall 102, when liner 100 is filled with the specific volume, substantially no overflow should occur. As stated previously, liquids stored in such liners 100 can typically be very expensive, for example about $2,500/L or more. Thus, even a small reduction of the amount of overflow can be desirable. Additionally, trapped gas volume within the liner may be minimized if the liner is substantially rigid and generally no undercuts or folds exist to provide a trap location for gases within the liner prior to filling.

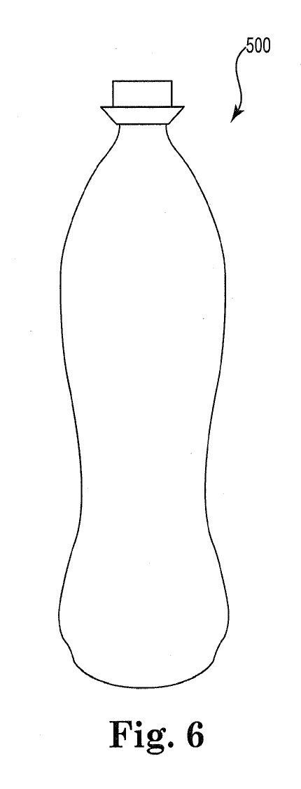

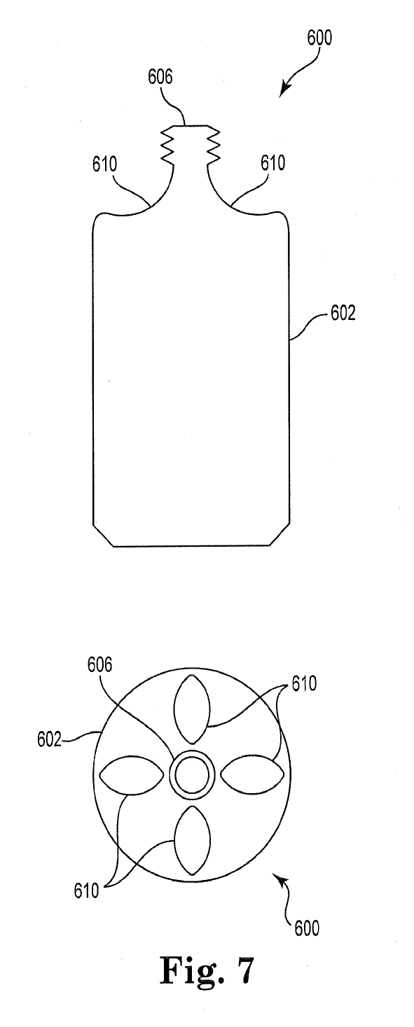

Further, the liner may be shaped to assist in dispensability of the liquid from within the interior cavity. In one embodiment, illustrated in FIG. 7, liner 600 may include folds or indentations 610 that can limit rigid areas of the liner 600, for example areas near the transition from liner wall 602 to mouth 606. Folds 610 may be molded into the liner or added subsequent the molding process. Folds 610 may be designed to control the collapsing or folding pattern of liner 600. In one embodiment, liner 600 may include two or four folds near mouth 606. However, it is recognized that folds 610 may be positioned at any suitable location of liner wall 602, and may be suitably configured to control the collapsing or folding pattern of liner 600 and reduce or minimize the number of particles that may be shed from the liner 600 during collapse. The folds 610 may be configured such that they reduce or minimize the resulting number of fold lines and/or gas trap locations within the liner upon complete or near complete collapse of the liner 600.

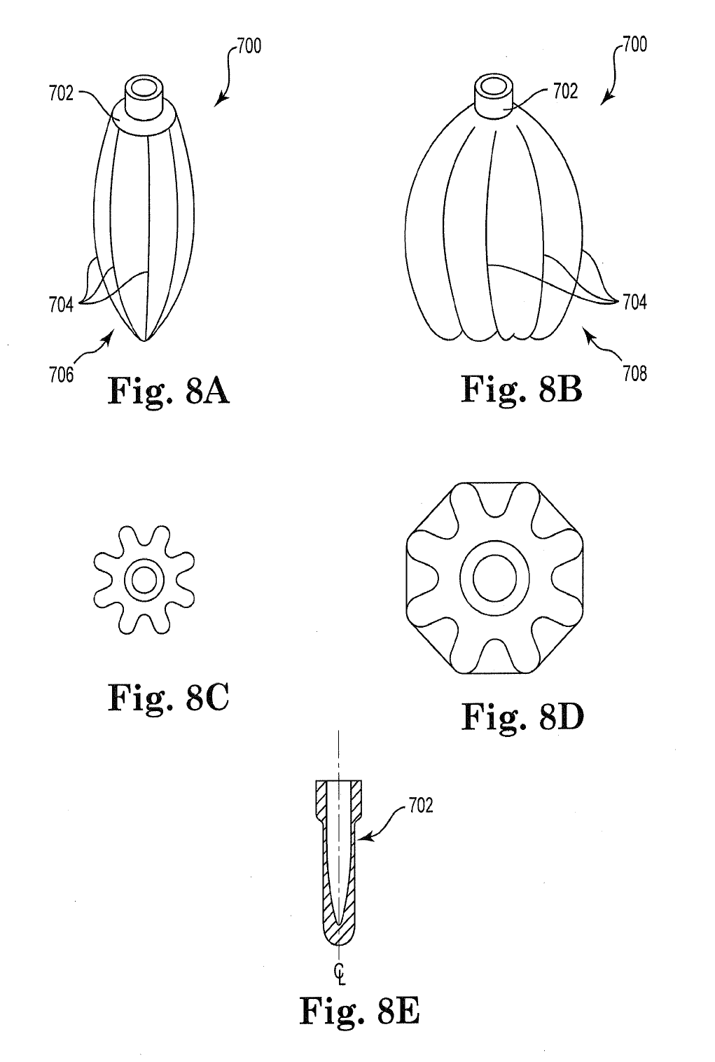

In another embodiment, illustrated in FIGS. 8A-8D, a substantially rigid collapsible liner 700 may generally include a plurality of pleats 704 that extend a vertical distance of the liner 700, and in some cases extend substantially the entire vertical distance of the liner 700, from the neck 702 to the bottom of the liner 700, and may thereby form panels or panel-like structures in the liner 700. In some embodiments, the liner 700 may include any suitable number of pleats and panels. More particularly, as may be seen in FIGS. 8A and 8C, in a deflated or collapsed state 706, the pleated liner 700 may comprise a plurality of generally parallel or patterned pleats 704 positioned about the circumference of the liner 700. As shown in FIGS. 8B and 8D, in an inflated or expanded state 708, the pleats 704 of the liner 700 may be generally opened such that the liner expands to a circumference, or diameter, that is greater than the circumference, or diameter, of the liner when in the deflated state 706. In some embodiments, the liner 700 may be generally compact in the deflated state 706, and the generally compact size of the liner when in the deflated state may make it relatively easier to position the liner inside of a rigid outer container. The vertical pleats 704 may allow for the ready expansion of the liner during filling and ready deflation during dispense. In some embodiments, as shown in FIG. 8E, the neck 702 may be thinner than the necks of prior art liners. Because the material comprising the neck may be generally thin, the neck area may be more flexible than would otherwise be the case, which may allow for relatively easier insertion into a rigid outer container, more complete filling, and/or more complete discharge of the liner. Due to the way the liner collapses as a result of the pleats and/or due to the relatively thin material that comprises the neck of the liner, this embodiment may also prevent choke-off.

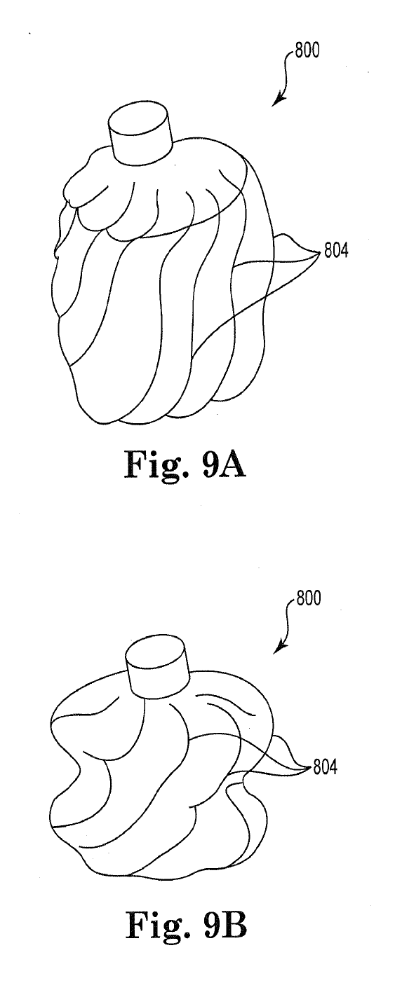

In a further embodiment, illustrated in FIGS. 9A and 9B, a substantially rigid collapsible liner 800 may comprise a plurality of non-vertical or spiral pleats 804 that may extend a vertical distance of the liner 800, and in some cases extend substantially the entire vertical distance of the liner, from the neck to the bottom of the liner. More particularly, as may be seen in FIG. 9A, which shows the liner in an expanded state, each of the plurality of pleats 804 are generally not a substantially straight line from the top of the liner 800 to the bottom of the liner, but instead each pleat may generally slant, wind, curve, etc., in the lateral direction of the liner as the pleat extends from the top of the liner to the bottom of the liner. Each of the plurality of pleats 804 may have a substantially uniform degree of slant, wind, curve, etc. about the vertical distance of the liner 800. However, in other embodiments, each of the plurality of pleats 804 may slant, wind, curve, etc. about the liner at any suitable degree, uniformly or non-uniformly with the other pleats. As may be appreciated, when the liner 800 begins to collapse upon discharge or dispense of its contents, as shown in FIG. 9B, the plurality of spiral pleats 804 will generally cause the liner bottom to twist relative to the top of the liner. This twisting motion may allow for more efficient collapse and/or more complete discharge of the contents of the liner as the twisting of the liner squeezes the liner contents from the bottom of the liner to the top of the liner. As a result of the spiral pleats and the resulting twisting motion that occurs during collapse, this embodiment may also prevent choke-off.

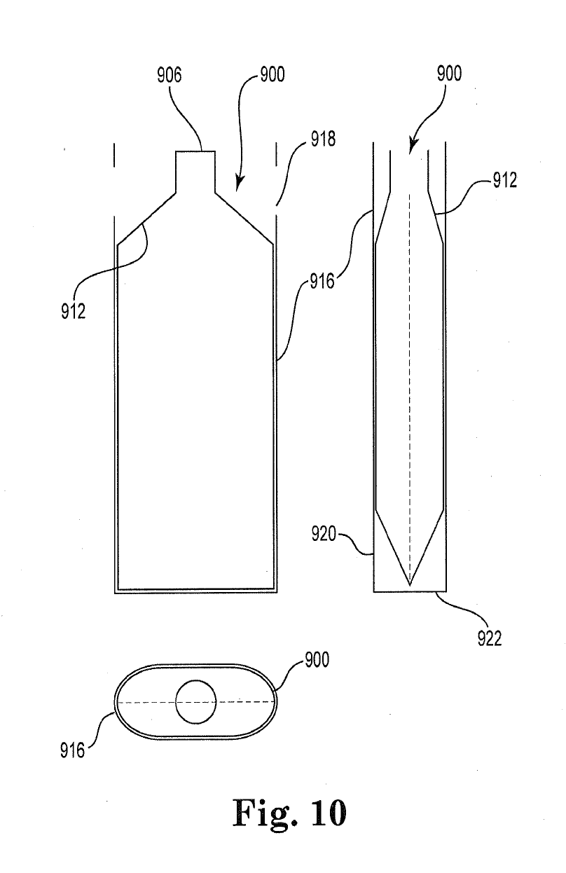

In a further embodiment, illustrated in FIG. 10, a substantially rigid collapsible liner 900 may be shaped in a similar manner to a toothpaste tube and may be configured to generally collapse flat. Such a configuration can help reduce or minimize the quantity of liquid trapped in hard-to-collapse regions and can reduce the amount of pressure or vacuum required to fully collapse the liner. The shape of liner 900 may also reduce creasing of liner 900 during collapse, which could otherwise give rise to particle generation at the crease lines, thereby contaminating the liquid within the liner. Similarly, as with many embodiments of the substantially rigid collapsible liner of the present disclosure, the configuration of liner 900 can reduce or minimize the number of trapping points for bubbles. Such substantially rigid collapsible liners may also include a slanted portion, such as slanted portion 912 near mouth 906, illustrated for example in FIG. 10, which may assist in the smooth removal of headspace gas at the beginning of dispense. Generally, the expression “headspace,” as used herein, may refer to the gas space in the liner that may rise to the top of the liner, above the contents stored in the liner. By removing headspace gas prior to content dispense, gas that is in direct contact with the liquid can be reduced or substantially eliminated, such that the amount of gas dissolved into the liquid during the dispense process is significantly reduced or minimized. Liquid with minimal dissolved gas generally has less tendency to release gas bubbles after experiencing a pressure drop in the dispense train, and thus, substantially reducing or eliminating gas bubble issues in the liquid dispense system. Generally, headspace in the liner may be removed or reduced by first pressurizing an annular space between the liner and the overpack via a pressure port so that the liner begins to collapse, thereby forcing any excess headspace gas out of the liner through a headspace removal port, or other suitable outlet port. In another embodiment, a liner according to one embodiment of the present disclosure may have a substantially round bottom, as illustrated in FIG. 4, rather than a bottom that is squared-off.

A liner according to further embodiments of the present disclosure may not be free standing, and in yet further embodiments, a sleeve 916 may be provided for support for liner. Sleeve 916 may include side walls 920 and a bottom 922. Sleeve 916 may be substantially free of the liner 900. That is, liner 900 may be removable or removably attached to the interior of sleeve 916. Liner 900 need not be adhesively bonded, or otherwise bonded, to sleeve 916. However, in some embodiments, liner 900 can be adhesively bonded to sleeve 916 without departing from the spirit and scope of the present disclosure. In one embodiment, sleeve 916 may be generally considered a sacrificial overpack or outer container. Sleeve 916 can be any suitable height, and in some embodiments, the sleeve 916 could be substantially the same height as liner 900 or taller. In embodiments where sleeve 916 is of such height, a handle 918 may be provided to assist the transportation of sleeve 916 and liner 900. Sleeve 916 may be made using one or more polymers, including plastics, nylons, EVOH, polyolefins, or other natural or synthetic polymers, and may be disposable. In other embodiments, sleeve 916 may be reusable.

In some embodiments, the liner may be detachably connected to the overpack at the fitment of the liner and at the mouth or neck of the overpack, for example by complementary threading, snap fit, or any other suitable means. The liner may be removed by twisting or unscrewing the liner from the overpack in some embodiments, or by twisting and pulling, or just pulling the liner from the overpack in other embodiments. Once removed from the overpack, the liner may be recycled, cleaned, sterilized and reused, or otherwise disposed of.

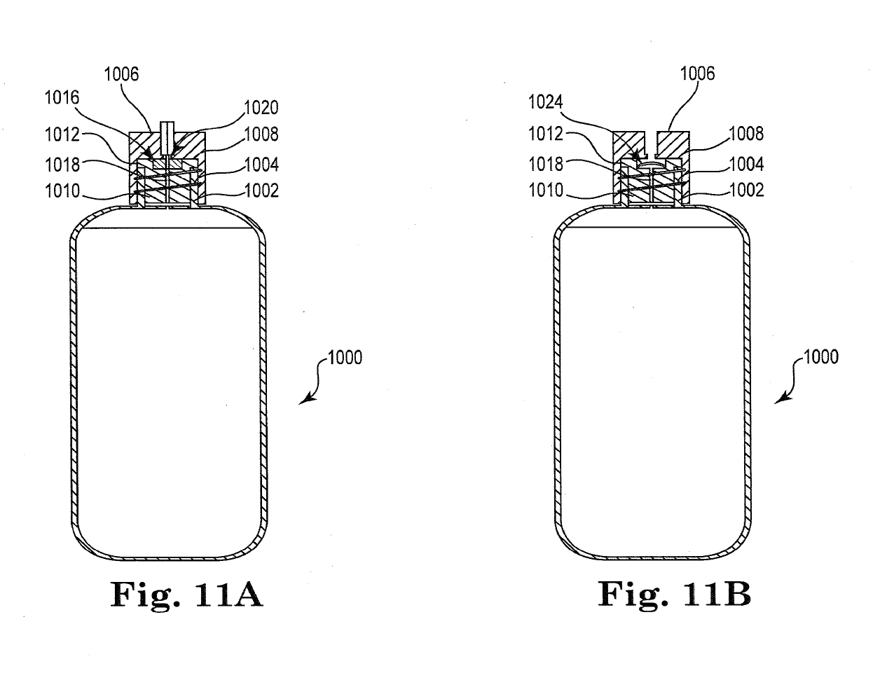

In some embodiments, connectors as shown in FIGS. 11A-13C may be used with a rigid or rigid collapsible liner to facilitate filling and dispense, as well as to secure the contents of the liner from air and other contaminants during storage. As can be seen in FIGS. 11A and 11B, the liner 1000 may include a neck 1002 that may be integral to the liner 1000 or that may be fixedly connected to the liner. The neck 1002 may have threads 1004 on the outside surface in order to couple with complimentary threads on the inside surface of a protective overcap 1006. It will be recognized, however, that any suitable method of removably attaching a cap to the neck of the liner and/or the connector may be used, such as friction-fit, snap-fit, etc. A connector 1008 may include a base section 1010 that may be configured to fit inside the neck 1002 of the liner 1000. The connector 1008 may also comprise a shoulder section or ledge 1012 such that when the base section 1010 of the connector 1008 is positioned in the neck 1002 of the liner, the shoulder section 1012 generally abuts the top edge of the neck 1002 of the liner, thereby creating a seal between the connector 1008 and the liner 1000. In some embodiments the protective cap 1006 may be integral with the connector 1008. However, in other embodiments, the protective cap 1006 and connector 1008 may be separate components, which may further be detachably secured to each other for storage and/or dispense procedures.

As shown in FIG. 11A, in one embodiment, a septum 1016 may be positioned in or adjacent the connector 1008 that may seal the bottle 1000 thereby securely containing any substance within the bottle 1000. The connector 1008 may also include a hollow tube or area 1018 extending from the septum 1016 through the entire vertical distance of the base 1010 to allow the contents of the liner 1000 to pass through the connector 1008 upon dispense. In order to dispense the contents of the liner, a needle or cannula 1020 may be introduced through an opening in the connector 1008 and/or protective cap 1006, such that the needle or cannula 1020 may make contact with and puncture the septum 1016 that seals the liner 1000. In a further embodiment the connector may comprise a diptube or a stubby probe.

In another embodiment shown in FIG. 11B, a frangible disk 1024 may be positioned in or adjacent the base of the connector 1008 that may seal the bottle 1000 securely containing any substance within the liner. The connector 1008 may also include a hollow tube or area 1018 extending from the frangible disk 1024 through the entire vertical distance of the base 1010 to allow the contents of the liner to pass through the connector 1008 upon dispense. A cap 1006 may be secured to the connector, preferably the base of the connector 1008. The contents of the bottle 1000 may be pressure dispensed, such that when the bottle is pressurized sufficiently, the frangible disk 1024 will rupture and the contents of the liner 1000 may begin to be dispensed.

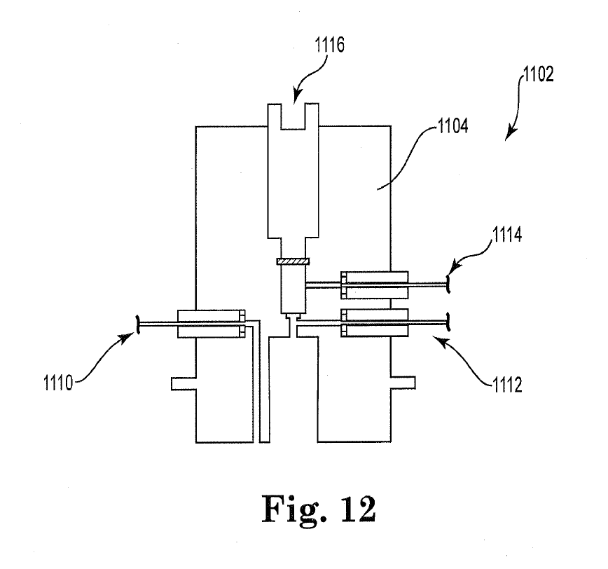

FIG. 12 shows another embodiment of a connector 1102, which may include ports 1110-1116 molded into the connector body 1104. The ports may include, for example: a liquid/gas inlet port 1110 to allow a liquid or gas to enter the liner; a vent outlet 1112; a liquid outlet 1114; and/or a dispense port 1116 to permit the contents of the liner to be removed.

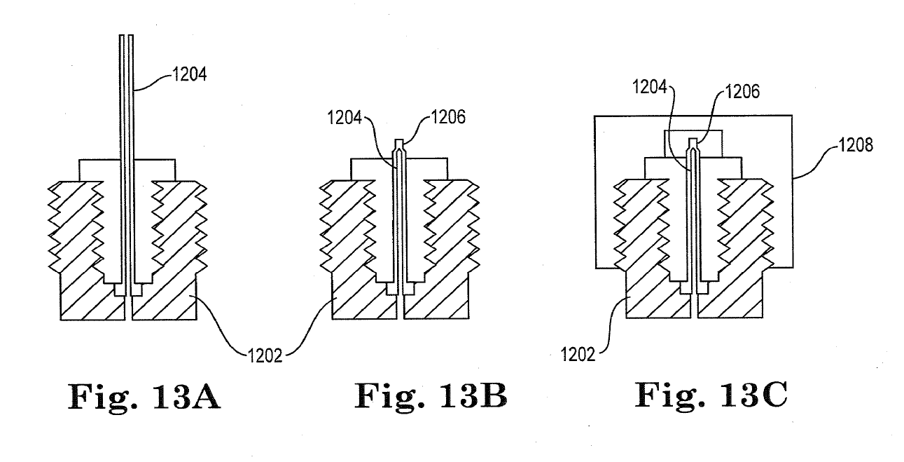

FIGS. 13A-13C show another embodiment of how a connector may be sealed after filling the container with a substance. As shown in FIG. 13A, a tube 1204 may be vertically fitted into the body of a connector 1202. The tube 1204 may be comprised of any suitable material, such as a thermoplastic or glass. The liner may be filled with contents via the tube 1204. After the liner has been filled, the tube 1204 may be welded shut 1206, or otherwise sealed, as shown in FIG. 13B. A protective cap 1208 may then be detachably secured to the connector 1202 as shown in FIG. 13C. The connector assembly of this embodiment may provide a substantially leak-tight closing mechanism for a liner. Additionally, the seal of this embodiment may be used in conjunction with the sealing embodiments described above.

In some embodiments a coded lock cap and/or connector may be used in conjunction with one or more embodiments of a liner and/or overpack of the present disclosure. The coded lock, in some embodiments, may include a sleeve attached around a bottle opening that may be sealed by a cork plug, a screw-top, and a turning device, for example. A screwed opening may be formed at a location on the sleeve corresponding to the cork plug, and the screw-top may be screwed into the screwed opening of the sleeve to mask the cork plug of the bottle, for example. A cipher hole having a given profile may be disposed on the screw-top, and the turning device may be provided at an end thereof with a key that generally matches with the cipher hole. The screw-top may be turned to expose the cork plug only when the key of the turning device fully matches with the cipher hole on the screw-top. An example of such a coded lock cap and/or connector, as well as additional embodiments of coded lock caps and/or connectors, is described in greater detail in Chinese Patent No. ZL 200620004780.8, titled, “Coded Lock for Identifying a Bottled Medicament,” which was filed Mar. 3, 2006, which is hereby incorporated herein by reference in its entirety. In another embodiment, a coded connector may be provided with punched key codes, RFID (Radio Frequency Identification) chips, or any other suitable mechanism or combination of mechanisms to prevent misconnection between a connector and the various embodiments of liners and/or overpacks described herein.

In yet another embodiment, a connector may or may also permit recirculation of the contents of the liner, which may be particularly useful for the recirculation of pressure sensitive or viscous materials. As stated above, the storage and dispensing systems of the present disclosure may be used for transporting and dispensing acids, solvents, bases, photoresists, dopants, inorganic, organic, and biological solutions, pharmaceuticals, and radioactive chemicals. Some of these types of materials may require recirculation while not being dispensed, otherwise they may become stale and unusable. As some of these materials can be very expensive, it can be desirable to keep the contents from becoming stale. Accordingly, in one embodiment, the connector may be used to recirculate the contents of the liner. A detailed description of embodiments of such a connector are provided in U.S. Provisional Patent Application No. 61/438,338, titled, “Connectors for Liner-Based Dispense Containers,” filed Feb. 1, 2011, which is hereby incorporated herein by reference in its entirety.

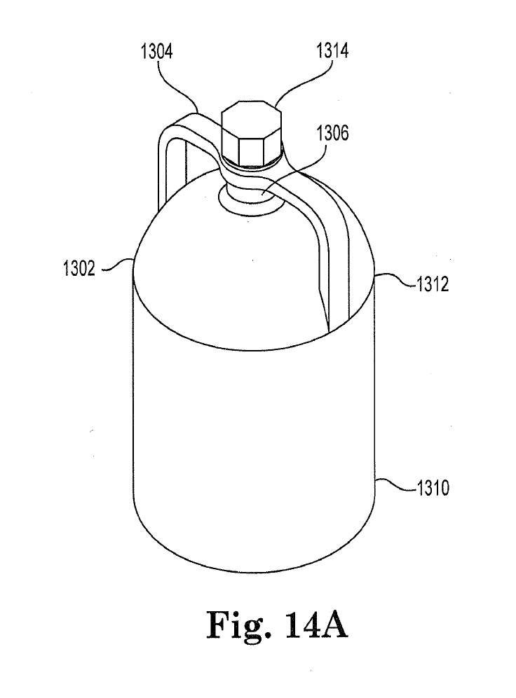

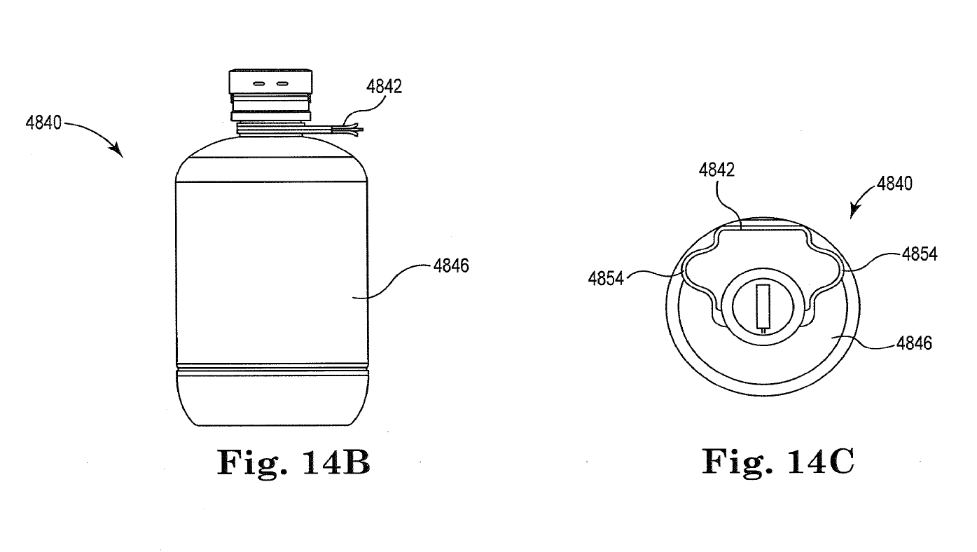

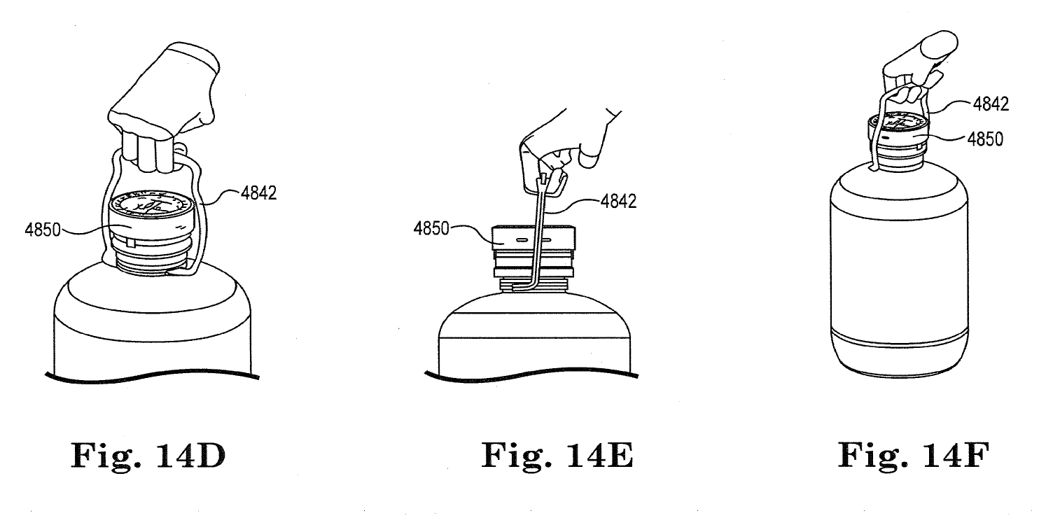

In one embodiment, a handle may be included with a rigid collapsible liner and overpack system. As shown in FIG. 14A a rigid collapsible liner 1302 may have a handle 1304 secured to the neck 1306 of the liner 1302. The liner 1302 may be inserted into an overpack 1310 that has an edge or chime 1312 that encircles the overpack 1310 at substantially the same height as the two free ends of the handle 1304 that is connected to the liner 1302 at the liner neck 1306. The ends of the handle may attach to the chime 1312 of the overpack 1310 via tongue and groove, snap-fit, or any other means of detachably securing the ends of the handle to the chime. In such an embodiment, any downward forces that are applied to the top of the liner 1302 including the liner opening 1314 may generally be transferred to the handle and then to the chime 1312 and overpack 1310, thus reducing stress on the liner 1302. In another embodiment, the two ends of the handle 1304 may also be attached to the liner 1302.

In some embodiments, as shown in FIGS. 14B and C, a handle 4842 may be used to lift and or move the liner-based system 4840. The handle 4842 may be any color and may be made from any suitable material or combination of materials, for example, plastic. As may be seen, in some embodiments the handle 4842 may be configured so as not extend beyond the circumference of the container 4846 when the handle is in a horizontal position. In further embodiments, the handle 4842, when in an unused position, for example, may have one or more bulge areas, or expansion areas, 4854 that may be configured to generally straighten out when the handle 4842 is pulled generally vertically, or otherwise in use by the user. Accordingly, when the handle 4842 is positioned in an in-use or carrying position, as shown for example in FIGS. 48D-F, in some embodiments, the handle 4842 may expand or stretch due to the give in the expansion areas 4854. For example, in some embodiments, the handle may expand by about ½ to 1½ inches when lifting the handle 4842. In other embodiments, the handle may be configured to expand more or less as appropriate. The ability of the handle to expand while in the carrying position may advantageously allow the handle to stay within the circumferential dimensions of the container while in a unused position, such that the handle does not get damaged during shipping or storage for example. The expansion of the handle while in the in-use or carrying position can also permit the handle to clear certain caps and/or connectors 4850.

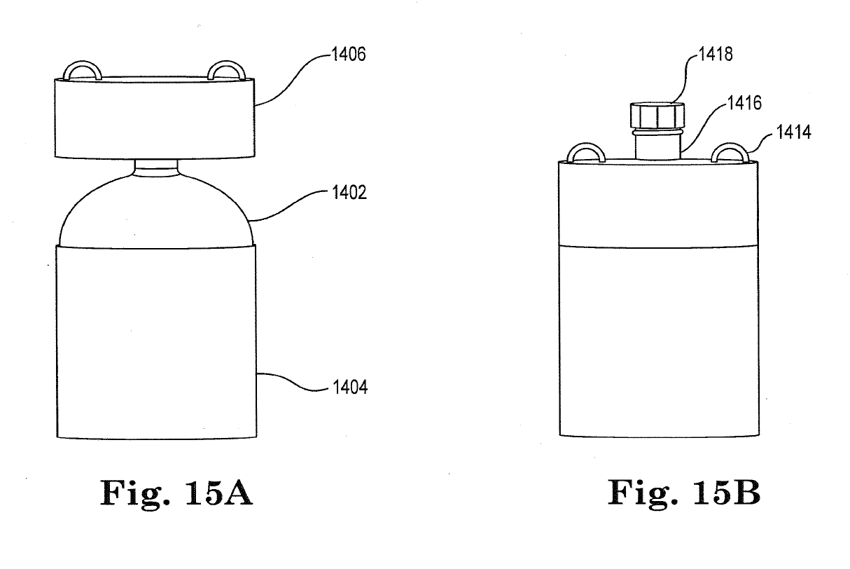

As shown in FIGS. 15A and 15B, in another embodiment, a rigid collapsible liner 1402 may be used with an overpack that is formed from two parts comprising a lower overpack 1404 and a top overpack 1406. As can be seen in FIG. 15A, the liner 1402 may be inserted into the lower overpack 1404 first. The top overpack 1406 may then be placed over the top of the liner 1402 and pushed down such that the top overpack 1406 is connected to the lower overpack 1404 as can be seen in FIG. 15B. The top overpack 1406 may attach to the lower overpack 1404 by any suitable means, such as but not limited to, snap fit or screw fit. In some embodiments, the top overpack 1406 may be sealed to the lower overpack 1404 such that pressurization may be used to collapse the liner 1402 upon dispense. The seal may be achieved by any known means. The top overpack 1406 may attach to the liner 1402 at the neck of the liner 1416. The top overpack 1406 may include one or more handles 1414 to make it easier to transport or move the system. In this embodiment, downward forces that may be applied to the top of the liner 1402 including the closure 1418 of the liner may be generally transferred to the top overpack 1406 and then to the bottom overpack 1404, thereby minimizing or reducing stress on the liner itself.

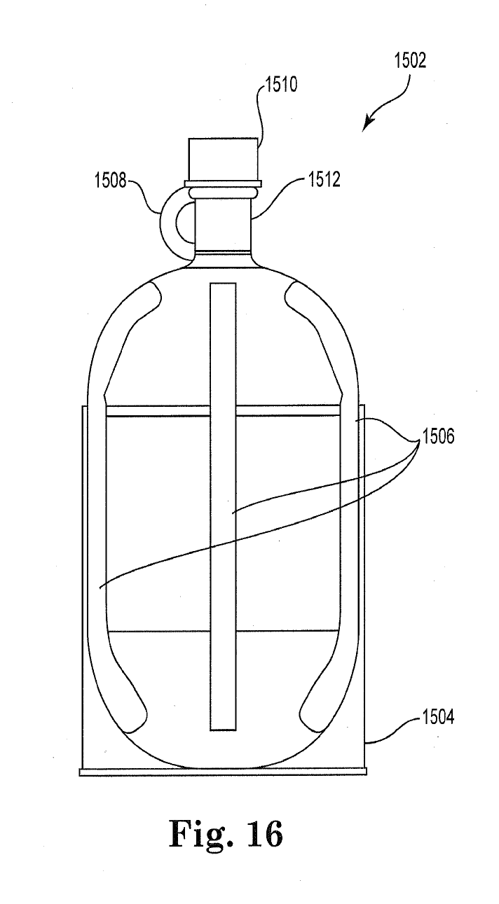

In another embodiment, a rigid collapsible liner 1502 may be positioned in an overpack 1504 as shown in FIG. 16. The liner neck 1512 of the liner 1502, in some embodiments, may include one or more handles 1508 to make moving the liner easier. The handle 1508 may be integrally comprised with the neck 1512 of the liner, or it may be fixedly secured to the liner by any known means, for instance the handle may be blow molded with the liner. The walls of the liner 1502 may have some sections 1506 that are thicker than others. These thicker walls sections 1506 may provide increased vertical thickness and yet not interfere with the ability of the liner 1502 to collapse upon dispense. The thickness of these thicker sections 1506 may be, for example, from about two to about ten times thicker than other liner wall sections, in some embodiments. Though, it will be recognized that the thicker wall sections may have any degree of additional thickness, in other embodiments. There may be one or more sections of the liner wall with increased thickness, for example, in some embodiments there may be one, two, three, or four or more such sections. In such an embodiment, any downward forces on the top of the liner 1502, including the closure 1510 of the liner 1502 may generally be transferred to the thicker wall sections 1506 of the liner 1502 and then to the overpack 1504 and thereby reducing stress on the liner 1502.

In some embodiments of the present disclosure, a substantially rigid collapsible liner may obtain above 90% dispensability, desirably above 97% dispensability, and more desirably up to 99.9% dispensability depending on the thickness of the liner wall, the material used for the liner, and the design of folds.

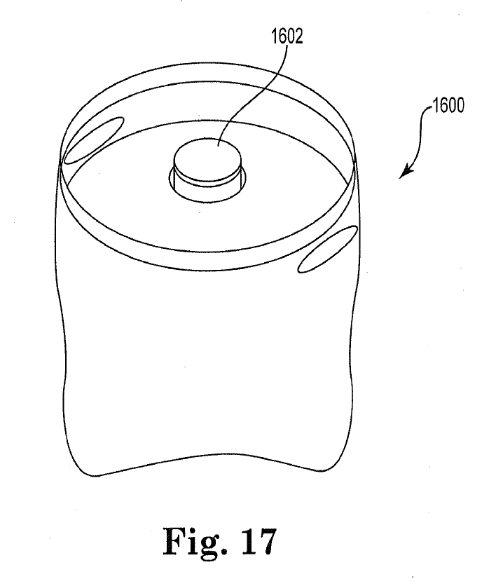

In some embodiments, a rigid collapsible liner may be configured to include folding patterns that may include one or more “hard folds” and/or one or more “pre-folds” or “secondary folds” in the rigid collapsible liner. Such liners may be formed, in some embodiments, so as to allow them to substantially uniformly collapse into a relatively small circumferential area that may permit the liners to be inserted into, or removed from, for example, an overpack that may have an opening with a relatively small diameter as compared to the diameter of the overpack itself. As can be seen in FIG. 17, an overpack 1600, which may generally resemble known overpacks already being used in the industry, may have a small opening 1602 relative to the greater diameter of the overpack 1600. Using a rigid collapsible liner of the present embodiments may be advantageous over using traditional flexible liners for several reasons. For instance, traditional flexible liners may be prone to pin holes or weld tears forming as the liner moves about during shipping. As the truck, train, or other transportation means moves, the traditional flexible liner within the overpack may also move. The more the liner is subjected to movement, the greater the risk that tiny holes will be created in the liner. The use of a rigid collapsible liner that is made of sturdier material than traditional flexible liners may greatly reduce the risk that weld tears or pin holes may develop during shipping. Traditional flexible liners may also have the disadvantage of forming creases when filled that may limit the amount of material that can be held in the liner or increase the volume of trapped gas within the liner and may also make complete dispense difficult or impossible. Such creases in a traditional flexible liner may also contribute to the likelihood that weld tears and/or pin holes may develop as the stress that is placed on the creases during shipping may be increased relative to non-creased areas, which may result in tiny tears in the liner at the crease points. Rigid collapsible liners of some embodiments of the present disclosure may not develop such creases, but instead may expand to a predetermined volume along the fold lines of the liner, thus allowing for a greater, more consistent interior volume to store a material. The lack of creases may also eliminate high-stress areas in the liner. Yet another advantage of various embodiments of the present disclosure over traditional flexible liners when used with an overpack 1600 may be that the rigid collapsible liner may be easier to remove from the overpack 1600 than traditional flexible liners. When a traditional flexible liner is removed from the overpack 1600 through the overpack opening 1602, a significant amount of the undispensed contents may accumulate at the bottom of the liner as the top of the liner is pulled through the opening 1602 making it difficult to get the bottom of the liner, which may also contain a significant portion of the liner material, out of the relatively small opening 1602 of the overpack 1600. The present embodiments, however, may collapse into a predefined shape determined by the liner fold lines (described in greater detail below) which along with the increased dispensability may substantially reduce or eliminate the accumulation of excess material at the bottom of the liner as the liner is pulled through the opening 1602. Accordingly, it may be substantially easier to remove an empty liner from the overpack 1600.

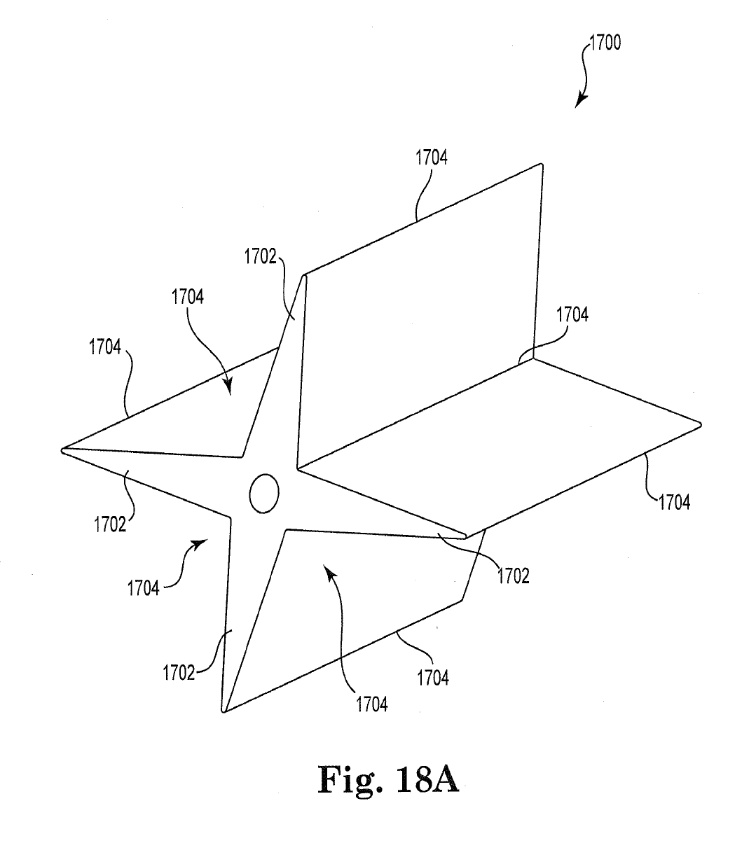

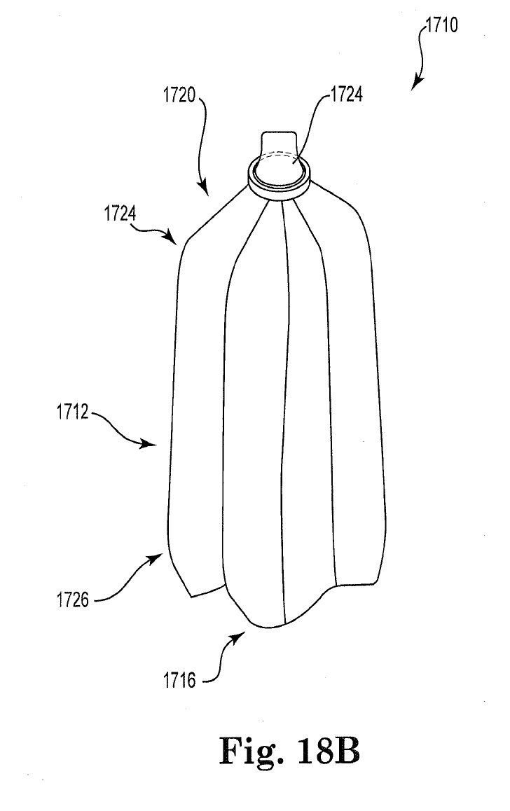

FIG. 18A shows an end view of one embodiment of a liner 1700 with predetermined folds, when the liner 1700 is in a collapsed state. In this embodiment, the liner 1700 has a 4-arm design, which means that in the collapsed state when viewed from the end, the liner 1700 has 4 arms 1702. Each arm 1702 may have generally the same proportions and dimensions in some embodiments. In other embodiments, the arms could have different or varying dimensions. The liner of the present embodiment may be used without a dip tube. In other embodiments, the liner may include a dip tube. As can be seen in FIG. 18B, the liner 1710 may have a body 1712, a fitment end 1720 that includes the fitment 1724, a resting end 1716 that contacts the bottom of the overpack container when the liner is inserted in the overpack, a transition area 1724 that connects the body nearest the fitment end to the fitment end 1720, and a transition area 1726 that connects the body near the resting end to the resting end 1716. As may be seen, all folds may be substantially vertically oriented when the liner 1710 itself is vertically oriented. The vertical fold lines may more easily allow for any bubbles that may exist in the contents of the liner to escape or be removed, as bubbles may tend to travel vertically along the fold lines up to the top of the liner 1710.

The body of a liner with a 4-arm design may generally be created with eight folds. As can best be seen with reference back to FIG. 18A, eight vertical folds 1704 may run from one end of the liner to the other end of the liner to generally form a four-armed star-like-shape when viewed from the end of the liner when the liner is in a collapsed state. While this embodiment is described and shown with reference to a 4-arm design, it should be understood that the present disclosure also includes embodiments of liners with a 3-arm, 5-arm, 6-arm, and any other number of arm designs.

With reference back to FIG. 18B, the fitment 1724 located on the fitment end 1720 may be integral with the liner 1710. In some embodiments, the fitment 1724 may be comprised of a thicker and in some embodiments a stronger material than the material comprising the rest of the liner. The fitment may be configured to couple with the opening 1602 in the overpack 1600 such that a connector and/or cap may be attached to the liner/overpack for closure and/or dispensing as described in detail in other portions of this disclosure.

The resting end 1716 of the liner 1710 may generally expand when the liner is filled in order to hold as much contents as possible and avoid wasting space. Similarly, the resting end 1716 of the liner 1710 may generally collapse substantially precisely along its fold lines upon collapse of the liner to ensure easy removal of the liner from the overpack and also to ensure that nearly all of the material may be dispensed from the liner 1710.

As may be seen in FIG. 19, in some embodiments of a liner 1802 with folds, one or more inversion points 1806 may be created around the transition area 1804 between the body 1810 of the liner and the resting end 1808 of the liner. Inversion points 1806 may be undesirable because these may be areas that buckle outward in a manner that makes dispense and/or collapse of the liner difficult, or that buckle inward in a manner that makes it difficult to substantially fully expand the liner in order to fill the liner completely with material.

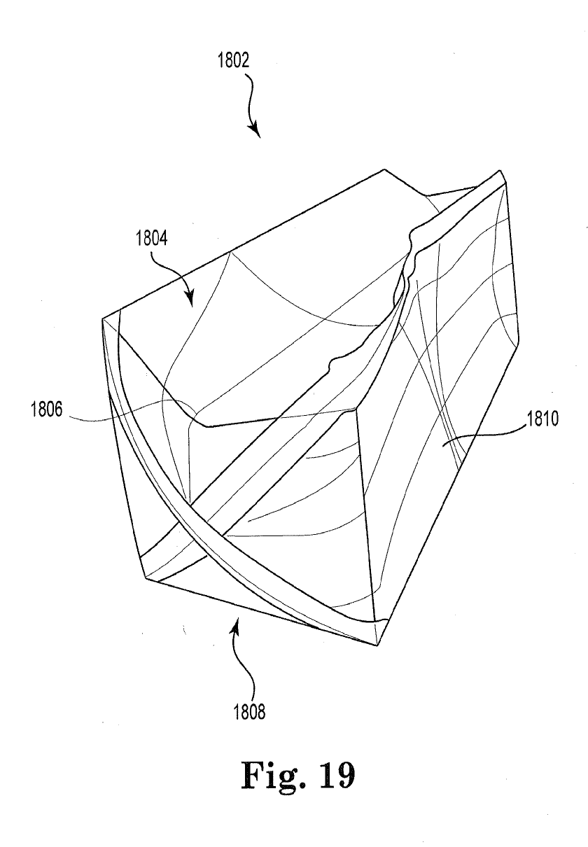

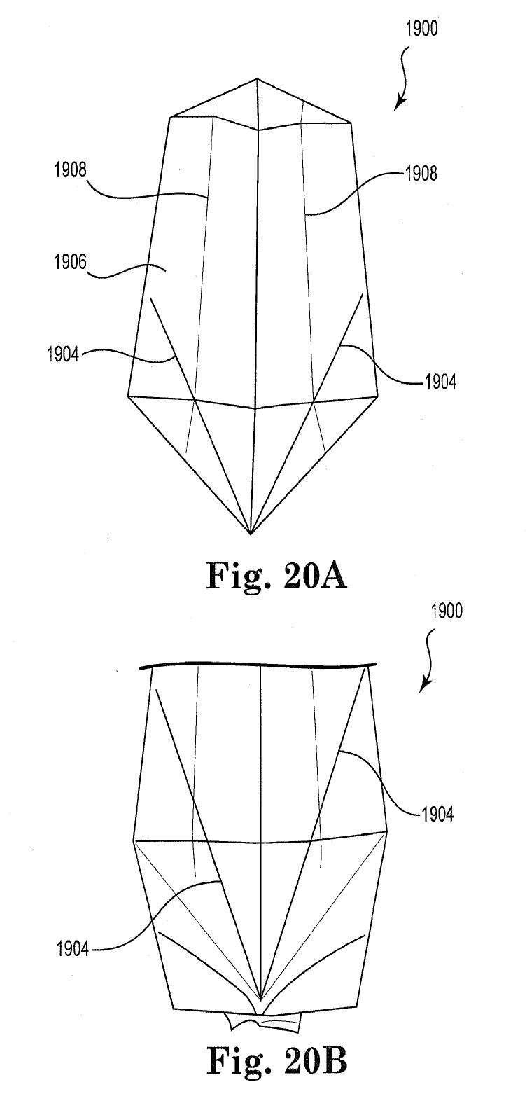

In some embodiments, inversion points may be limited or generally eliminated by including secondary folds at appropriate places in the liner. For example, as shown in FIGS. 20A and 20B, a secondary fold or pre-fold 1904 may be included in the liner that may extend as shown from the body of the liner 1906 through the transition area of the liner and to the apex 1908 of the resting end of the liner 1900. These secondary folds or pre-folds 1904 may help to avoid the inversion points such as that shown in FIG. 19. As can best be seen in FIG. 20B, the tendency of the liner to expand and collapse in a manner that is guided by the secondary folds 1904 or pre-folds may keep inversion points from forming.

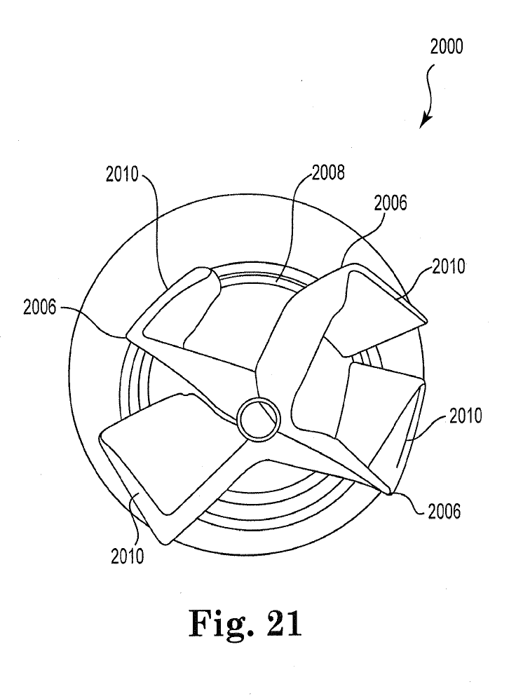

Similarly, additional vertical secondary fold lines may be included in the liner that may farther reduce the circumferential area of the liner when it is collapsed and inserted into and pulled out of the opening in the overpack. This may be seen in FIG. 21, which shows a liner 2000 being inserted into or being pulled out of an opening 2008. In the embodiment shown, the secondary folds 2006 are positioned about half way on the arms 2010, which allows the arms 2010 of the liner 2000 to take up less circumferential area than they would without the secondary folds 2006. It will be recognized, however, that the secondary folds 2006 may be positioned at any suitable position on the arms 2010.

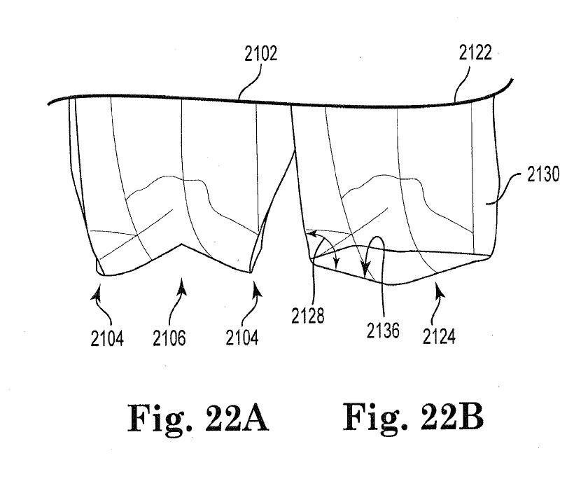

In some embodiments, as shown in FIG. 22A, the corners 2104 of the liner 2102 that are created by folds formed in the resting end 2106 of the liner 2102 may not be able to expand fully, thus limiting the amount of material that may be contained in the liner 2102. As discussed above, it may be preferable to have the resting end expand as much as possible so the liner may hold as much liquid as it can. As can be seen in FIG. 22B, the resting end 2124 of the liner 2122 of this embodiment may expand more fully. This may be achieved in one embodiment, for example, when the transition angle 2128 is between 35° and 55°, for example, preferably about 45°. The transition angle 2128 may be the angle formed between the substantially vertical lines and folds of the body 2130 of the liner 2122 and the apex 2136 of the resting end 2124. A transition angle of preferably about 45° in one embodiment may be a somewhat “magic” angle in that at that angle the resting end 2124 may expand more fully as shown in FIG. 22B. It will be recognized, however, that transition angles of greater or less than preferably about 45° are within the spirit and scope of the present disclosure.

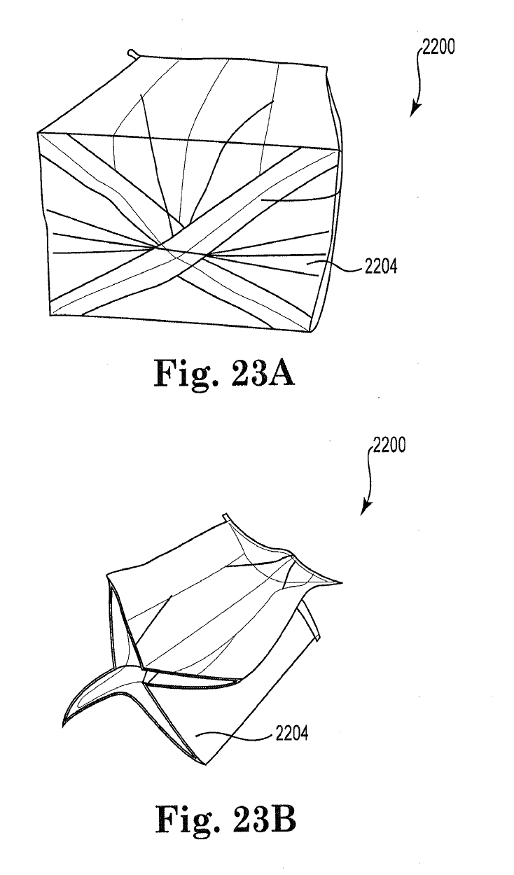

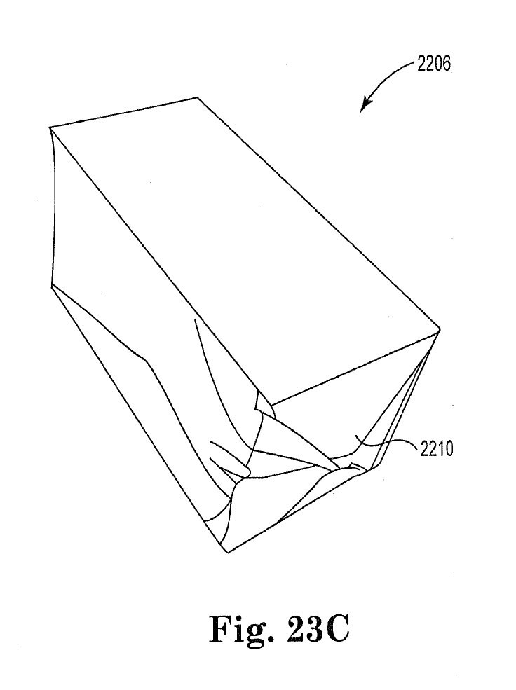

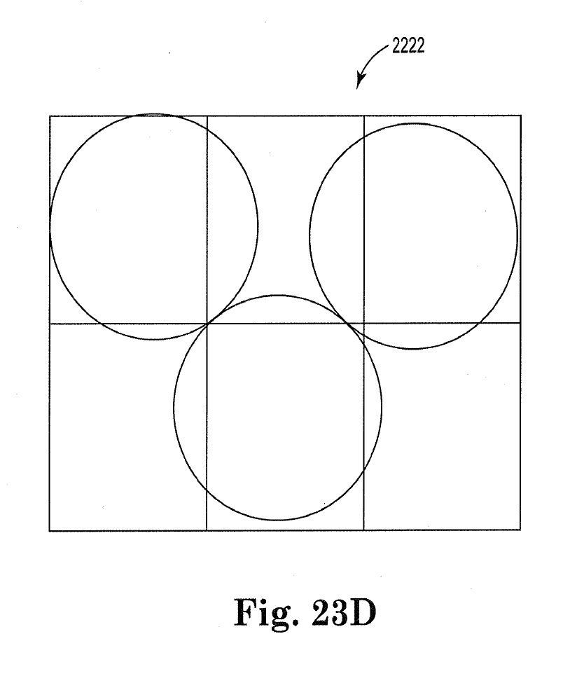

In some embodiments, the resting end 2204 of the liner 2200 in a collapsed state may collapse inside of the body of the liner 2200, as shown in FIG. 23B. The resting end 2204 may tend to do this when the height between the end of the body of the liner and the apex of the resting end of the liner is relatively short. Such a liner may advantageously reduce the height of the liner 2200 when the liner is being filled. As may be seen in FIG. 23A, a liner 2200 in accordance with this embodiment may have a resting end 2204 that generally expands fully in an expanded state.

In some embodiments of liners with folding patterns, the resting end 2210 of the liner may be configured to be substantially flat, as may be seen in FIG. 23C. In such an embodiment, the top of the liner may have any suitable configuration, including, for example, a flat geometry or a tapered geometry. Embodiments of liners with a substantially flat resting end may have any overall shape, for example, the liner may have any number of vertical folds and may have any desirable circumference. Additionally, as previously discussed for other embodiments above, some embodiments of liners with folds may be used as stand-alone containers and may not require the use of an overpack.

While some embodiments of liners, including liners that may be stand-alone containers as well as liners for use with overpacks, may have a geometry that approximates a cylinder, still other embodiments of liners with folding patterns may include liners 2206 with an overall geometry that more closely approximates a rectangular prism, for example. Liners of such embodiments may include resting ends and/or top ends of any desirable configuration, for example, one or both ends may be substantially flat or may have a tapered geometry, as described above. Liners with a generally more rectangular geometry may have the advantage of having a higher packing density for shipping and/or storing when the liners are expanded than generally cylindrically shaped liners, as may be seen in FIG. 23D, which shows a packing density of three generally cylindrical liners superimposed on a packing density of six generally rectangular liners. As shown, the same overall area 2222 may accommodate six generally rectangular liners but only three generally cylindrical liners.

In some embodiments of liners configured for use with an overpack, the liner may be inserted into an overpack through the overpack opening when the liner is in a collapsed state. Once the liner is inside of the overpack the liner may be filled with a desired substance through the liner fitment that may remain outside of the overpack and may couple with the overpack opening. When the liner is expanded upon filling, it may generally approximate a cylinder that may substantially conform to the interior shape of the overpack. After the contents of the liner have been removed, the liner may be relatively easily removed through the opening in the overpack by pulling the liner out through by the fitment of the liner. The pressure applied to the liner as it is pulled through the opening of the overpack may generally make the liner revert to its collapsed state along the liner fold lines. Stiff liners such as the liners of these embodiments may remember their folding patterns and tend to collapse along their fold lines as they are collapsed, similar to a bellows.

The embodiments of a liner including folds may be made by blow molding, welding or any other suitable method. In some embodiments, the liners may be configured to be used a single time and disposed of, while in other embodiments the liners may be configured to be used one or more times. The folds in the liner may act like hinges that allow the liner to collapse at very low pressures, for example at pressures down to approximately 3 psi in some cases. In some embodiments, these liners may achieve up to about 99.95% dispensability.

The liner of the present disclosure may be manufactured as a unitary component, thereby eliminating welds and seams in the liner and issues associated with welds and seams. For example, welds and seams may complicate the manufacturing process and weaken the liner. In addition, certain materials, which are otherwise preferable for use in certain liners, are not amenable to welding. The liner may be used alone or with an overpack.

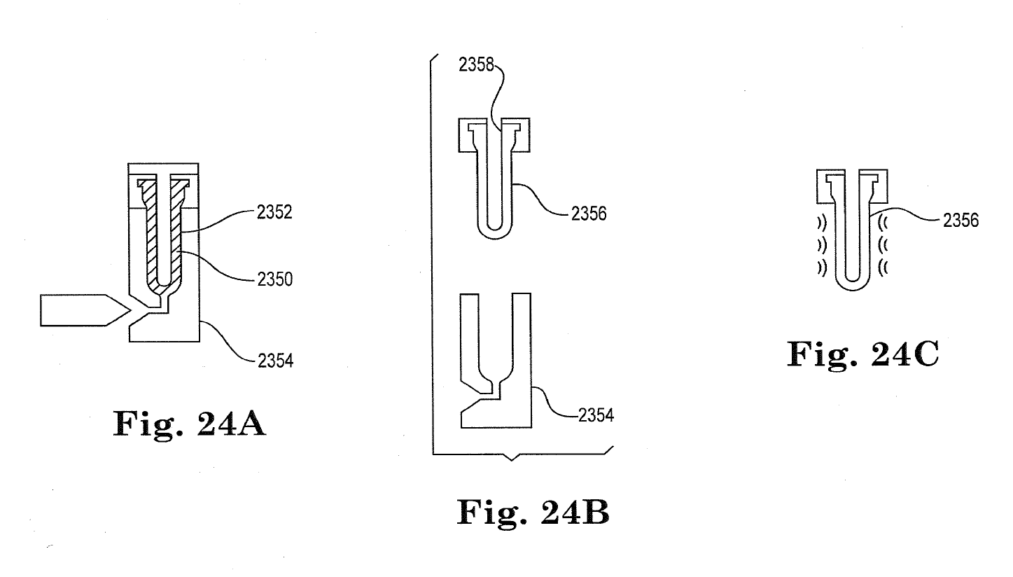

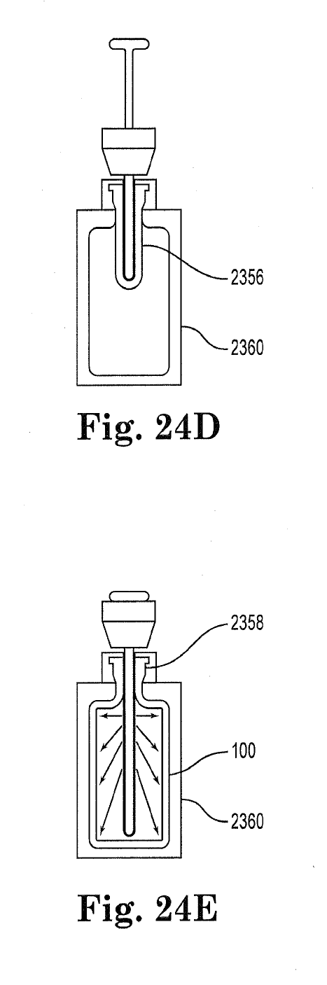

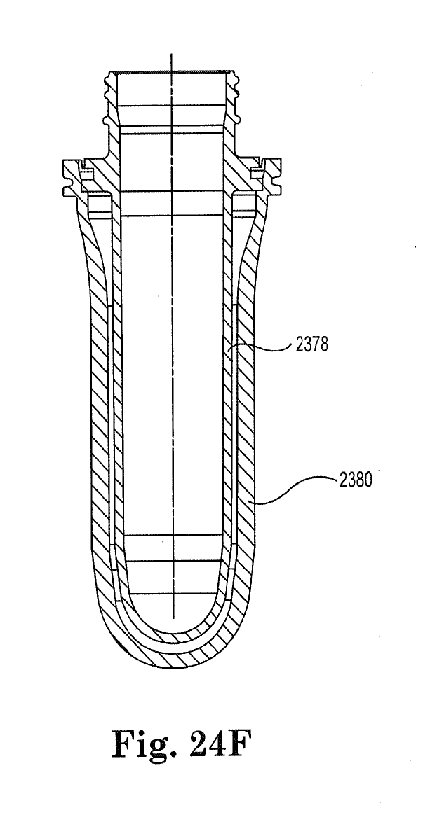

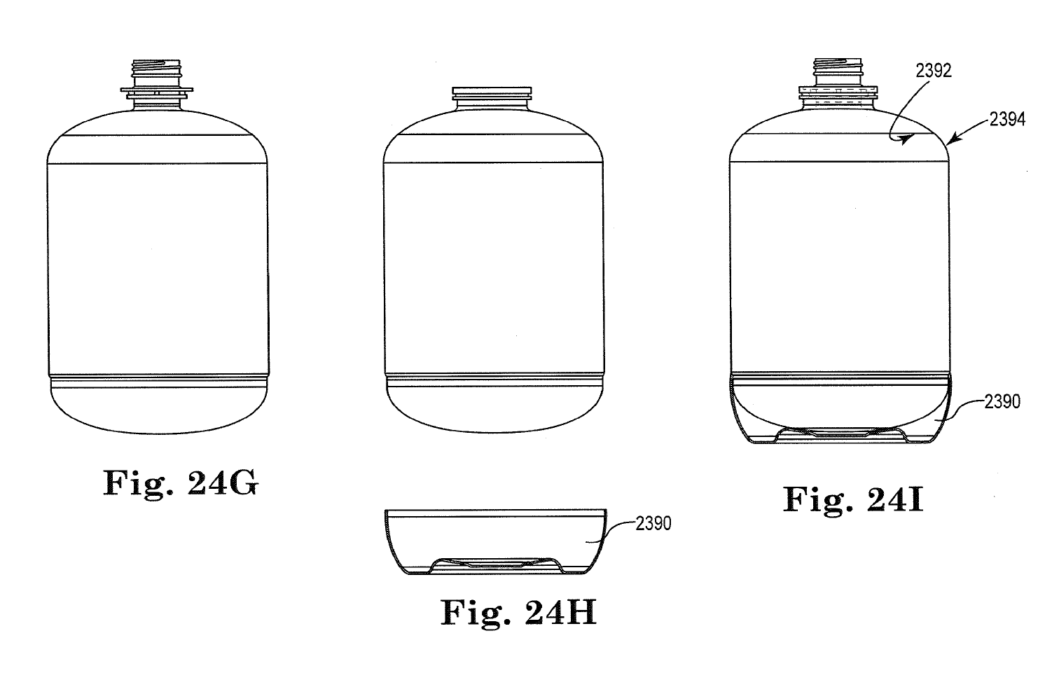

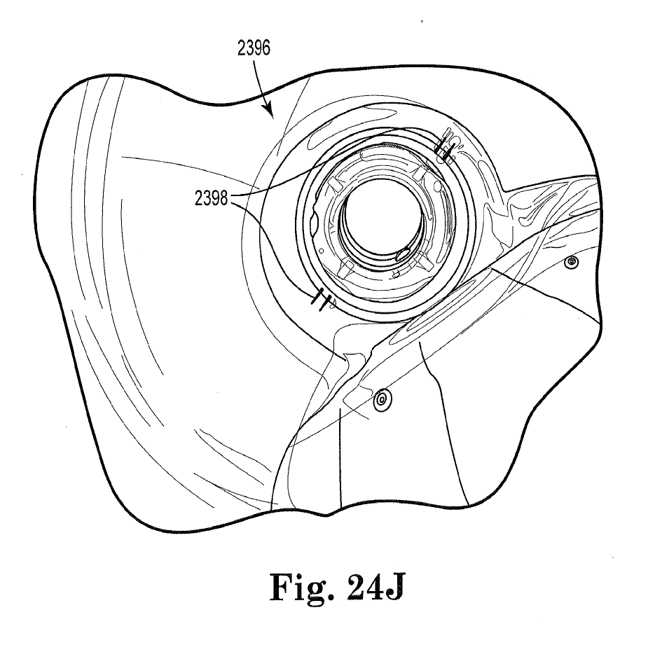

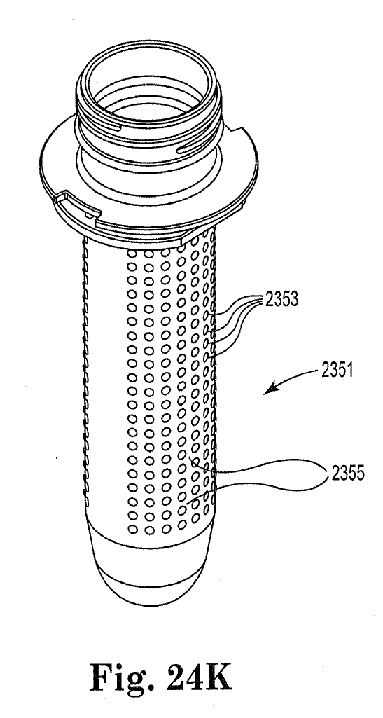

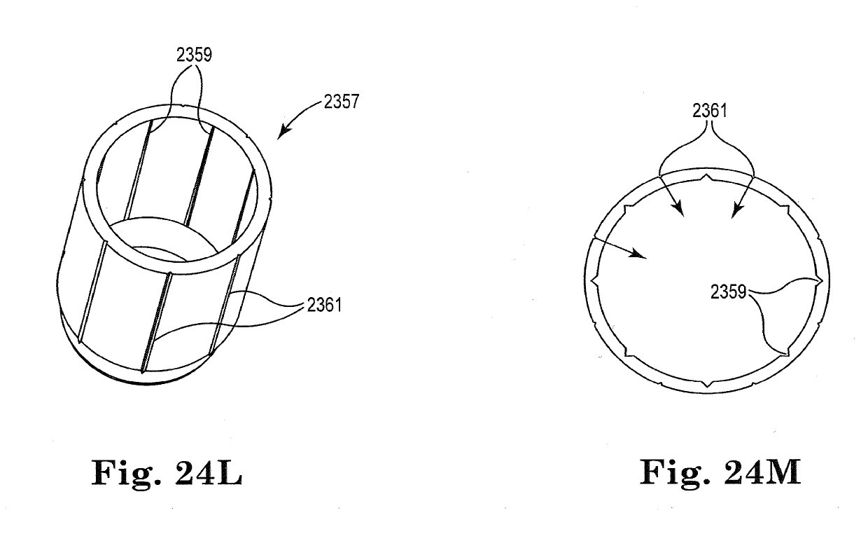

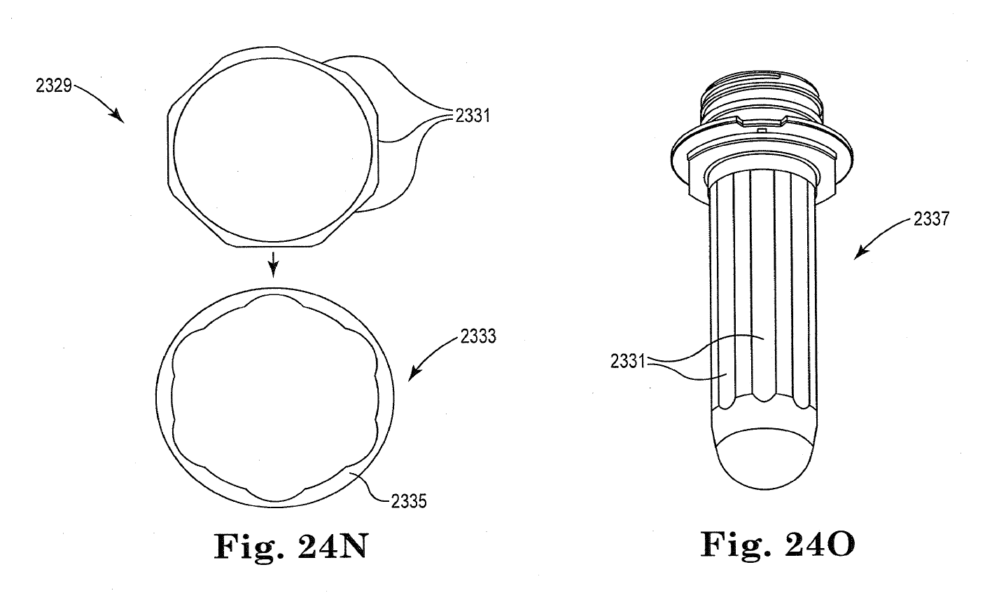

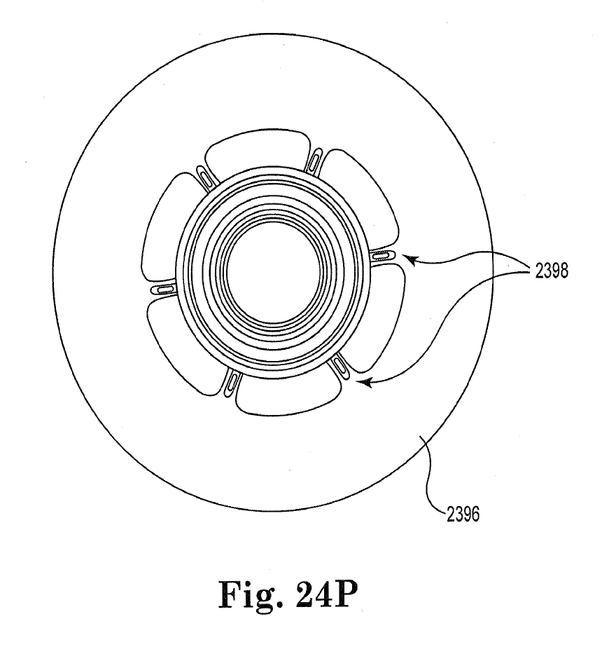

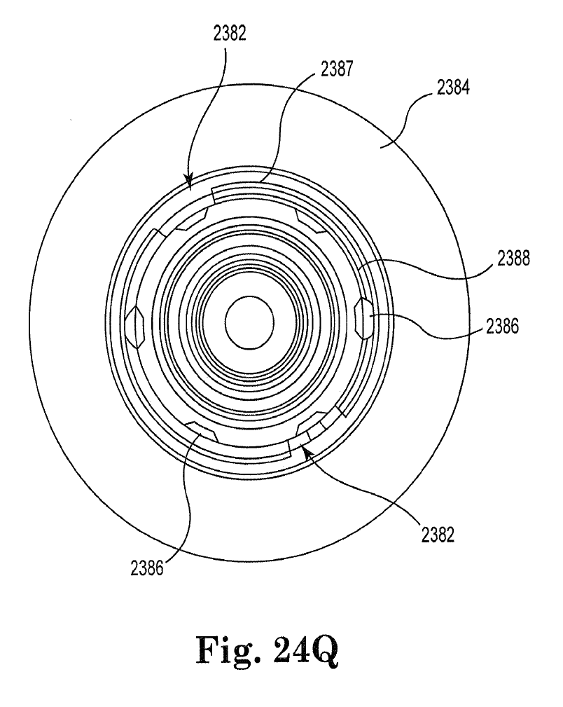

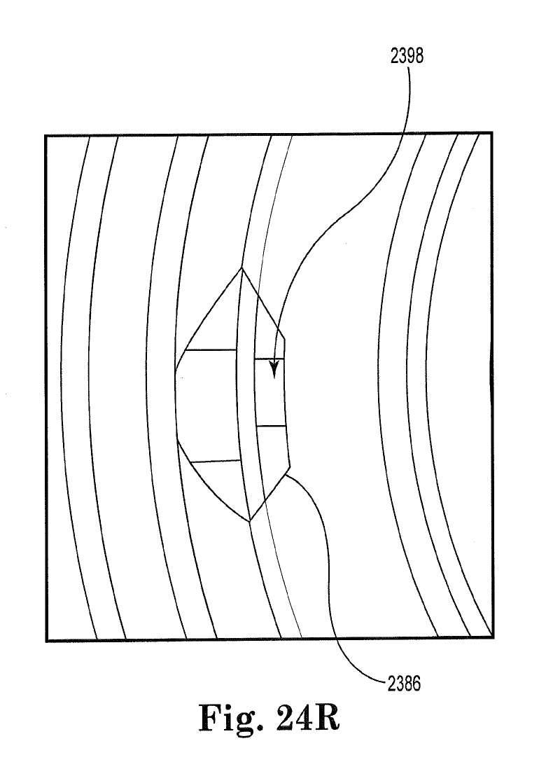

The liner can be manufactured using any suitable manufacturing process, such as extrusion blow molding, injection blow molding, injection stretch blow molding, etc. A manufacturing process utilizing injection blow molding or injection stretch blow molding can allow for liners to have more accurate shapes than other manufacturing processes. One example embodiment for manufacturing the liner using injection stretch blow molding is illustrated in FIGS. 24A-E. It is recognized that not all steps of the exemplary embodiment for manufacturing the liner are required, and some steps may be eliminated or additional steps may be added without departing from the spirit and scope of the present disclosure. The method may include forming a liner preform by injecting a molten form 2350 of a polymer into an injection cavity 2352 of a preform mold die 2354, as illustrated in FIG. 24A. The mold temperature and the length of time in the mold may depend on the material or materials selected for manufacturing the liner preform. In some embodiments, multiple injection techniques may be used to form a preform having multiple layers. The injection cavity 2352 may have a shape that corresponds to a liner preform 2356 (FIG. 24B) with integral fitment port 2358. The polymer may solidify, and the resultant liner preform 2356 may be removed from the preform mold die 2354. In alternative embodiments, a pre-manufactured preform, including a multilayer preform, can be used for the preform 2356 of the present disclosure.

In some embodiments, the liner preform 2356 may be cleaned and heated to condition the liner preform 2356 prior to stretch blow molding, as illustrated in FIG. 24C. The liner preform 2356, as illustrated in FIG. 24D, may then be inserted into a liner mold 2360 having substantially a negative image of the desired completed liner. The liner preform 2356 may then be blown, or stretched and blown, to the image of the liner mold 2360, as illustrated in FIG. 24E, to form the liner having an integral fitment port 2358. The blow molding air speed, as well as the blow molding temperature and pressure, may depend on the material selected for manufacturing the liner preform 2356.

Once blown or stretch blown to the image of the liner mold 2360, the liner may solidify and be removed from the liner mold 2360. The liner may be removed from the liner mold 2360 by any suitable method.

In some embodiments, the liner and the overpack may be blow molded in a nested fashion, also referred to as co-blow molded. Accordingly, the liner and the overpack may be blow-molded at generally the same time, with the liner preform nested within the overpack preform. In one embodiment, the material comprising the liner may be the same as the material comprising the overpack. In another embodiment, however, the material comprising the liner may be different from the material comprising the overpack. For example, in one embodiment, the liner may be comprised of PEN, while the overpack may be comprised of PET or PBN. In other embodiments, the liner and overpack may be comprised of any suitable same or different materials, such as any of the materials described throughout this specification, and each may include one or more layers of material or multiple materials. In some embodiments a co-blow molded liner and/or overpack may include a flexible system, while in other embodiments, the liner and/or overpack may include a semi-rigid, substantially rigid, or rigid collapsible system.

Co-blow molding a liner and overpack system may advantageously reduce the cost of manufacturing a liner and overpack, as the amount of time and labor involved in the process may be decreased. Additionally, co-blow molding may stress the liner and/or overpack less than traditional manufacturing processes that require the liner to be collapsed and inserted into the overpack. Similarly, particle shedding may be reduced with co-blow molding. Additionally, shipping and transportation may be more efficient and/or cost effective because the liner is already disposed inside of the overpack. While specific methods for providing a liner and overpack are described, such as molding, blow molding, co-blow molding, injection stretch blow molding, etc., a liner-based system of the present disclosure may also be provided according to other methods, such as those disclosed in U.S. patent application Ser. No. 12/450,892, titled, “Integral Two Layer Preform, Process and Apparatus for the Production Thereof, Process for Producing a Blow-Moulded Bag-in-Container, and Bag-in-Container thus Produced,” filed Apr. 18, 2008; European Patent No. EP 2,148,771 B1, titled. “Integrally Blow-Moulded Bag-in-Container Having Interface Vents Opening to the Atmosphere at Location Adjacent to Bag's Mouth; Preform for Making it; and Processes for Producing the Preform and Bag-in-Container,” filed Apr. 18, 2008; European Patent No. EP 2,152,486 B1, titled, “Integrally Blow-Moulded Bag-in-Container Comprising an Inner Layer and an Outer Layer Comprising Energy Absorbing Additives, Preform for Making it, Process for Producing it and Use,” filed Apr. 18, 2008; and European Patent No. EP 2,152,494 B1, titled, “Integrally Blow-Moulded Bag-in-Container Having a Bag Anchoring Point; Process for the Production Thereof; and Tool Thereof,” filed Apr. 18, 2008, each of which is hereby incorporated herein in its entirety.

FIG. 24F shows a cross-sectional view of a liner preform 2378 nested inside of an overpack preform 2380. FIG. 24G shows a blow molded liner, according to one embodiment of the present disclosure, while FIG. 24H shows a blow molded overpack. Also shown in FIG. 24H is a chime 2390. A chime may be used to help provide stability to the liner-based system, in some embodiments. As may be seen in FIGS. 24G and 24H, in some embodiments, the liner and/or overpack may have a generally round shaped bottom that may or may not be configured to keep the liner and/or overpack securely upright. Therefore, in some embodiments, the overpack may be placed in or connected to a chime 2390. As may be seen, the chime may have one or more feet or have any other feature that may allow the chime to provide a solid and secure base for the liner and overpack. The chime may be attached to the overpack by any suitable means, including snap-fit, complimentary threading, welding, or any other suitable means or combination of means. FIG. 24I shows a liner-based system, whereby the liner 2392 and overpack 2394 are co-blow molded. As may also be seen in FIG. 24I, although not necessary in all embodiments, a chime 2390 has been included in the system to provide stability. Embodiments of co-blow molded liner-based systems may or may not include a dip tube. Examples of liner-based systems and methods utilizing co-blow molding have been described in greater detail in U.S. Patent Appln. No. 61/484,523, titled “Nested Blow Molded Liner and Overpack,” filed May 10, 2011, which is hereby incorporated herein by reference in its entirety.

In some embodiments, features may be incorporated into the system that may help decrease the likelihood of pin holes. Pin holing may occur during dispense, such as during pressure dispense or pressure assisted pump dispense. This undesirable outcome may result if the gas introduced during pressure dispense (indirect or pressure assisted pump dispense) is not able to move freely in the annular space.

FIG. 24J shows a view from inside an overpack looking from the bottom of the overpack up to the top of the overpack. In some embodiments, including co-blow molded liner and overpack systems, one or more air channels 2398 may be provided between the liner and overpack, for example near the top of the liner and overpack 2396, to permit easier and/or more even flow of gas or air into the annular space between the liner and overpack. The air channels may be provided, such as integrally provided, on the liner or the overpack, or both. FIG. 24P shows a top view of an overpack 2396 with liner illustrating one embodiment of air channels 2398 formed between the liner and overpack. In some embodiments, the air channels 2398 may be designed to keep the liner from making complete contact with the overpack at the location of the air channels. The air channels 2398 may allow the gas or air that can be introduced during pressure dispense or pressure assisted pump dispense to flow more easily and/or more evenly throughout the annular space between the overpack and liner, thereby eliminating or reducing the occurrence of pin holes. Any number of air channels 2398 may be provided, such as but not limited to, from 2-12 air channels; of course, it is recognized that any fewer or greater suitable number of air channels may be provided. Further, the air channels 2398 may have any suitable geometry and may be disposed at any suitable place on the overpack. The air channels 2398 may be formed from the same material as the overpack in some embodiments, and may protrude from the walls of the overpack, such that the liner may be kept a certain distance from the overpack walls, thereby allowing gas to flow more freely into the annular space. In some embodiments, the overpack preform may be configured to create the one or more air channels 2398. For example, the air channels may be formed by wedge-like protrusions made in the overpack preform. In another embodiment, one or more air channels 2398 may be affixed to the overpack after the overpack is formed. In such embodiments, the air channels may be comprised of the same material or any suitable different material than the overpack.

In one embodiment, as shown in FIG. 24Q, air passages may also be provided in one or more support rings of the liner or overpack that permit gas or air from an external environment to pass to the air channels, discussed above, and then into the annular space between the overpack and liner. For example, a first support ring 2387 may have one or more notches or air passages 2382 permitting air flow through the first support ring from an external environment. In one embodiment, the air passages 2382 may be circumferentially disposed on the first support ring 2387 and may be generally rectangular in shape, as shown, or they may have any other suitable or desirable shape. In some embodiments, the air passages 2382 may allow gas or air to flow from the environment of the outer neck area of the overpack 2384 into an area between the first support ring 2387 and a second support ring 2388. The second support ring 2388 may comprise one or more additional notches or air passages 2386. The air passages 2386 may be circumferentially disposed on the second support ring 2388 and may be generally pyramidal in shape, as shown, or may have any other suitable or desirable shape. The air passages 2386 in the second support ring 2388 may allow air to flow from the area between the first support ring 2387 and the second support ring 2388 into the air channels 2398 near the top of the overpack (illustrated in FIG. 24P, and described above). As shown in FIG. 24R, the air channels 2398 in the overpack may generally align with the air passages 2386 in the second support ring 2388, thereby allowing air to pass through the system into the annular space between the liner and the overpack. The one or more support rings may be comprised of any suitable material and may be formed in any suitable way, including being integral with the liner or overpack necks in some embodiments, or being affixed, welded, or otherwise coupled to the liner or overpack in other embodiments.

In another embodiment, the ability for gas to flow through the annular space may be increased by including protrusions on the outside wall of a liner. As may be seen in FIG. 24K, protrusions or recesses 2353 may be provided on the liner preform 2351, such that when the liner is formed, the liner has areas that protrude out from the liner wall and/or or dimples that create recesses in the liner wall. The varying protrusions and/or dimples and flush areas 2355 may allow the gas to more freely move through the annular space during pressure dispense and/or keep the liner wall from adhering to the interior wall of the overpack. The geometry, pattern, and number of protrusions provided in the liner preform may include any suitable geometry, pattern or number.

In still other embodiments, the ability for gas to flow through the annular space may be increased by further controlling the manner in which the liner collapses during pressure dispense. Controlling the manner of collapse may advantageously keep the dispensing gas moving freely and/or may aid in attaining a high level of dispense. As may be seen in FIG. 24L, in one embodiment, a liner preform 2357 may include alternating indentations on the inside 2359 of the liner preform and/or on the outside 2361 of the liner preform. The indentations 2359, 2361 may be vertically disposed along the length of the liner walls, in some embodiments. The indentations 2359, 2361 may extend substantially the entire length of the liner or may extend any suitable shorter distance. Any suitable number of indentations 2359, 2361 may be provided. In some embodiments, for example, the same number of indentations may be provided on the inside 2359 as on the outside 2361 of the liner, whereas in other embodiments there may be more or less indentations on the inside 2359 of the liner as on the outside 2361 of the liner. The indentations may be spaced any suitable distance from one another, and may have any suitable shape. For example, an indentation may vary in thickness or may have a consistent thickness along the entire length of the indentation. The indentations may also curve in some embodiments, while in other embodiments the indentations may be substantially straight. As may be seen in FIG. 24M, a liner preform as shown in FIG. 24L, may generally collapse inward at the points where the outside indentations 2361 are located. Generally, the indentations 2359, 2361 may act as hinges that control the way the liner collapses.

In another embodiment shown in FIGS. 24N and 24O, panels may be formed in the liner preform in order to create relatively thinner areas that may help control the collapse of the liner. FIG. 24N shows a cross-sectional view of the geometry of the liner preform. As may be seen, a plurality of panels 2331 may be formed in the outside wall of the liner preform 2329. Any suitable number of panels may be provided. Further, the panels may be separated from one another any suitable distance, including varying distances from one another. For example, each panel may be the same distance away from the panel next to it. In other embodiments, however, the distance between neighboring panels may be different. The panels may have any suitable thickness. In some embodiments, the panels may each have the same thickness, while in other embodiments, some or each of the panels may have a different thickness. The panels 2331 may be areas that are thinner than areas of the preform that do not have panels. When the liner is formed to its expanded state 2333, the resulting liner wall 2335 may have areas of thickness that vary, based on which areas included panels and which did not. For example, the liner wall 2335 may be relatively thinner in panel areas than in non-panel areas of the original preform. FIG. 24O shows a perspective view of an embodiment of a preform 2337 with such panels 2331. During pressure dispense, the thinner areas of the liner may tend to collapse inward first, which may allow for a greater amount of material to be dispensed from the liner and/or may allow the gas to flow more freely through the annular space during dispense.

In some embodiments, the liner may include other features that may help control when and under what circumstances the liner may collapse. As discussed above, in some embodiments of the present disclosure a liner may be configured to collapse inside of an overpack when a gas or liquid is introduced into the annular space between the liner and the overpack, for example. The collapse of the liner generally forces the contents of the liner out of the liner for dispense. While the liner is intended to collapse during dispense, in some cases the liner may desirably be predisposed against collapsing prior to dispense. For example, when the liner is filled with material and sealed within the overpack at a first temperature and the temperature of the overall system is subsequently lowered, the resulting pressure difference, if significant enough, may cause the liner to undesirably dimple or collapse. For example, if the liner-based system is filled with material at 298° K. and the temperature is subsequently lowered to 258° K., there will be a resulting pressure drop inside of the liner-based system of about 20% (or −2.9 psig). Such a change in pressure may be sufficient to cause the walls to distort or “dimple.” Accordingly, in some embodiments the liner may be configured to include features that may make the liner generally resistant to this type of non-dispense related collapse or distortion.

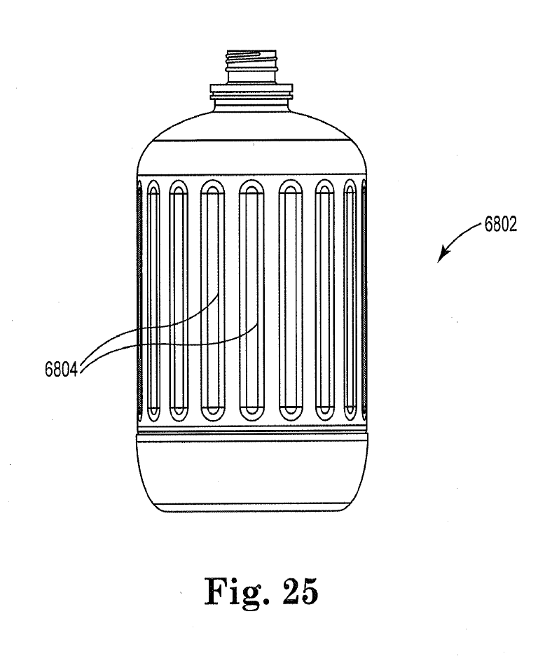

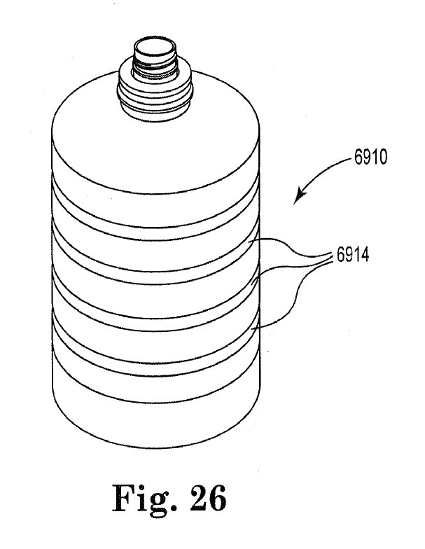

As may be seen in FIG. 25, in one embodiment, a liner-based system 6802 comprising a liner and an overpack may have a plurality of grooves or other indentation or protrusion pattern 6804. In other embodiments, either the liner or the overpack may have such surface features. The grooves 6804 may help maintain the structure of a liner prior to dispense, in the event of a pressure differential caused by, for example but not limited to, a change in temperature. As may be seen, in some embodiments, the grooves 6804 may be vertically disposed. The grooves 6804 may extend generally any suitable length along the liner and overpack walls. Further, the grooves 6804 may have any suitable width. In some embodiments, the plurality of grooves 6804 may all have the same height and/or width, while in other embodiments, the grooves may have different heights and/or widths. Any suitable number of grooves 6804 may be disposed on the liner and the overpack walls, spaced any suitable distance apart. The one or more grooves may protrude or indent any suitable amount. For example, in some embodiments the grooves may indent about 1.5 mm. In some embodiments, the grooves may be relatively shallow to minimize loss of internal volume. In another embodiment shown in FIG. 26, the grooves 6914 may be horizontally disposed. The horizontal grooves 6914 may have any suitable thickness and depth. Further, there may be any suitable number of horizontal grooves 6914 disposed along the walls of the liner and overpack. The horizontal grooves 6914 may extend around the entire circumference of the liner and overpack in some embodiments, while in other embodiments one or more of the grooves 6914 may extend less than the entire circumference of the liner and overpack.

In still other embodiments, other surface features may help reduce or eliminate liner and/or overpack distortion resulting, for example, from a change in temperature. In some embodiments, a liner-based system may include a plurality of geometric indentations or protrusions. For example, as may be seen in FIG. 27, a plurality of substantially rectangular indentations 7004 may be provided. While generally rectangular shaped features are shown, it will be understood that the features may have any suitable geometry or combination of geometries. For example, the features may be generally circular, hexagonal, oblong, or any other suitable shape. Similarly, the geometric shape or shapes (in cases where a pattern comprises more than one shape) may be arranged in any suitable pattern, including a substantially random pattern. In some embodiments, the surface features may protrude as opposed to indent. In still other embodiments, some surface features may protrude and other surface features may indent. The plurality of surface features may protrude and/or indent any suitable distance.

In some embodiments, surface features may be similar to those as discussed with respect to FIG. 27, but may include edges that are generally less defined than those shown therein. For example, the edging that may define a surface feature, such as but not limited to a generally rectangular panel as shown in FIG. 27, may be substantially more shallow, thereby generally blurring, obscuring, or making more vague the line between the indented (or in other embodiments, protruded) surface feature, and the remainder of the overpack wall. Generally lessening the definiteness of the surface-defining edging may lessen the likelihood that the liner will stick to the overpack during dispense, and/or during any non-dispense contraction caused by temperature change, as discussed above.

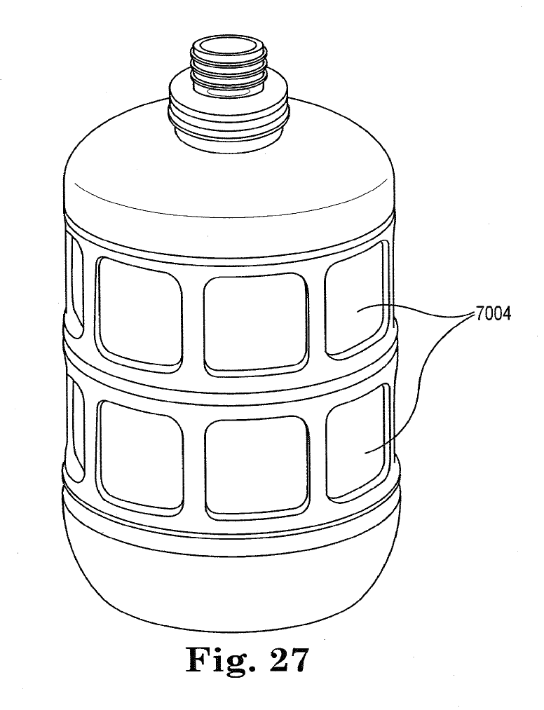

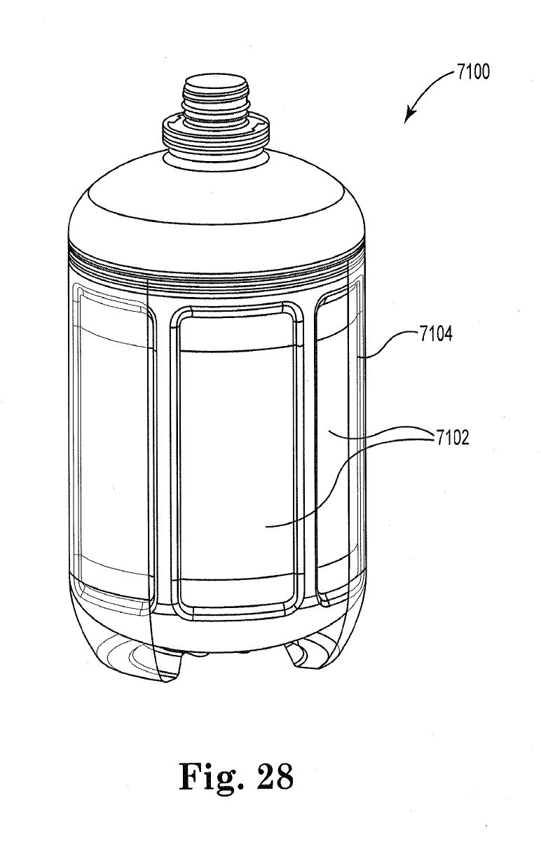

As may be seen in FIG. 28, one embodiment of a liner-based system containing surface features may include one or more surface features or panels having a generally rectangular shaped design. For example, as may be seen in FIG. 28, six generally rectangular shaped panels 7102 may be vertically disposed along the circumference of the liner and/or overpack walls; however, any other number of panels may be suitably used. As described above, the panels may each have substantially the same size and shape as the other panels, or in other embodiments, one or more panels may be differently sized and shaped than one or more other panels. Also as provided above, the boundary edge that defines a panel 7102 may have any suitable thickness and/or definition, including a shallow depth or a more defined and/or greater depth. In some embodiments, the edging depth may be generally the same for each panel and/or for the entire perimeter of a single panel, while in other embodiments the depth may vary from panel to panel or from one position along the perimeter to another position along the perimeter of the same panel. While the six-panel design is described and shown as a generally rectangularly shaped panels 7102, it will be understood that any suitable or desirable geometry is contemplated and within the spirit and scope of the present disclosure. Further, it will be understood that any suitable number of panels, spaced any suitable distance from one another is contemplated and within the spirit and scope of the present disclosure. Generally, surface features such as one or more panels may add strength and/or rigidity to the liner and/or overpack. However, in some embodiments, as previously described, a more shallow edging may also keep the liner from sticking to the overpack.

In some embodiments, the thickness of the walls of the overpack and/or liner may help or may also help prevent undesirable dimpling. For example, in some embodiments the wall thickness of the overpack may be from about 1 to about 3 mm to help prevent temperature related wall distortion.

In some embodiments, the surface features shown in FIGS. 25-28 and described herein may be formed as described generally above by nested co-blow molding. For example, the liner and the overpack, once co-blow molded, will have substantially the same form, including substantially the same number and placement of grooves or shapes, in accord with the co-blow molding process described above. In other embodiments, the liner and/or overpack may be formed by any suitable process other than co-blow molding, such as by extrusion blow-molding, stretch blow molding, or any other suitable means described herein. In some embodiments, only the liner may have the horizontal or vertical grooves or geometric patterns, while in still other embodiments, only the overpack may have the surface features.

In some embodiments, the overpack may be blow molded separately from the liner, which may substantially reduce or eliminate the potential for the completed liner to undesirably stick to the overpack at one or more points during pressure dispense and/or non-dispense related collapse, as discussed above. In such an embodiment, the overpack may be blown into an expanded state. The liner preform may then be disposed within the expanded overpack and the liner may be blown inside thereof, such that the expanded liner may substantially take the shape of the expanded overpack. In some cases a gas stream, for example air or N₂, may be introduced into the annular space between the exterior of the liner walls and the interior of the overpack walls while the liner is being blown, thereby reducing the possibility of the liner adhering to the overpack. In some embodiments the gas may be controlled so as to create a larger gap between the bottom of the overpack and the bottom of the liner, relative to the smaller gap that may exist between the walls of the overpack and the walls of the liner. The gap between the bottom of the liner and the overpack may allow the liner to respond to changes in pressure, for example, by expanding or contracting without the overpack also similarly distorting. The gap at the bottom may be any suitable amount of space.

In still another embodiment, the overpack and liner may each be blown into an expanded state separately. The expanded liner may then be collapsed and introduced into the expanded overpack. The inserted collapsed liner may then be re-expanded within the overpack by introducing air, for example, into the liner, or in other embodiments, the liner may remain generally collapsed until it may be filled with a desired substance.

In some cases, a label may desirably be affixed to the outside of a liner-based system. In liner-based systems that include external surface features as have been described herein, a sleeve may be provided over the overpack so as to provide a smooth surface to which the label may adhere. The sleeve may completely surround the overpack in some embodiments, while in other embodiments the sleeve may only partially surround the overpack. In other embodiments, a sleeve may additionally or alternatively provide additional support for the overpack. The sleeve for the overpack may extend any suitable height, including substantially the entire height, or any suitable lesser height of the overpack. The additional support provided by the sleeve, may help the overpack resist deformation, particularly prior to pressurized dispense, for example. The sleeve may be substantially completely adhered to the overpack in some embodiments, while in other embodiments, the sleeve may only be secured to the overpack at one or more particular locations. The sleeve may be affixed to the liner or overpack by any suitable means, such as but not limited to adhesive or any other suitable means, or combination of means. The sleeve may be comprised of any suitable material or combination of materials, including, but not limited to, plastic, sturdy paper board, rubber, metal, glass, wood and/or any other suitable material. The sleeve may comprise one or more layers and may include one or more coatings. In some embodiments, a sleeve may also be configured to act as a UV shield that may cover some or substantially all of the overpack and/or liner. The UV shield may be attached to some or all of the overpack by any suitable means, for example by adhesive, shrink wrapping, snap-fit, or any other suitable means or combination of means.

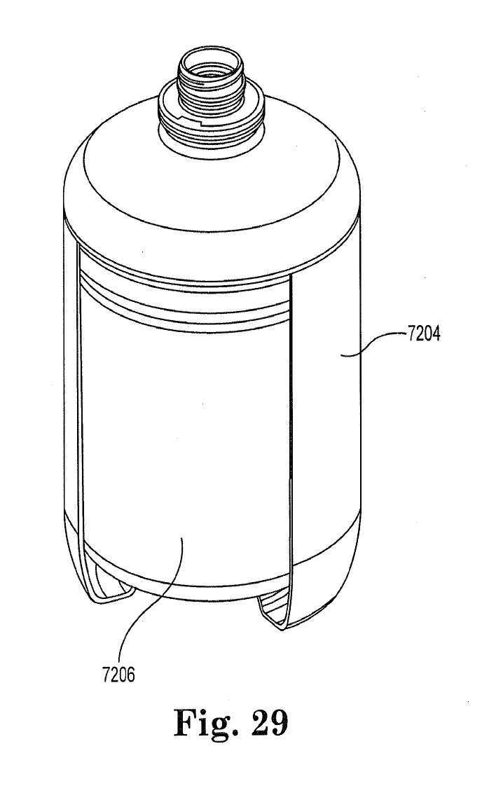

In other embodiments, a chime, similar to those shown in FIGS. 24H and I, may be used to provide a smooth generally rigid exterior surface for the liner-based system, which may hide any dimpling effects created by temperature changes, as discussed above, and/or may create a surface for labels and the like. However, in contrast to the chime shown in FIGS. 24H and I, which only covers a generally bottom portion of the liner-based system, a modified chime may cover a greater amount of the liner-based system. In some embodiments, the modified chime may extend generally the entire height of the liner-based system, while in other embodiments, the modified chime may extend any suitable lesser height. As may be seen in FIGS. 28 and 29 for example, a chime 7104, 7204 may extend toward a top portion of the liner or overpack 7206, and in some embodiments may couple to or connect to an upper portion of the liner/overpack 7206 by any suitable means, including, but not limited to, snap-fit, friction fit, complementary threading, adhesive, or any other suitable means. Accordingly, in some embodiments, an upper peripheral edge of the chime 7204 may be glued to the overpack, while in other embodiments the chime 7104, 7204 may be snapped onto the overpack 7206 by means of snap-fit or friction fit for example at any suitable or desirable location or height on the overpack 7206. As noted above, because the chime may be comprised of a relatively rigid material in some embodiments, and because the chime may generally fit over a substantial portion of the liner/overpack, if the liner/overpack collapses, dimples, or otherwise distorts, the chime may generally maintain a smooth and rigid shape. As such, any distortion of the liner/overpack may be generally unobservable from the exterior of the liner-based system. Further, the smooth exterior surface of the chime may provide a generally undistorted surface for adhering a label. The chime 7104, 7204 may be comprised of any suitable material, including plastic, for example high density polyethylene (HDPE), PET or any other suitable polyester, or any other suitable material or plastic, or combination thereof.

As explained herein, various features of liner-based systems disclosed in embodiments described herein may be used in combination with one or more other features described with regard to other embodiments. For example, as shown in FIG. 28, a liner-based system comprising surface features, for example a six-panel design, may also include a chime 7104, as described above.

In one particular embodiment, a liner-based system may include a blow-molded liner and overpack with substantially co-extensive surface features and a base cup or chime, as may be seen in FIG. 28. The liner may be what has been referred to herein as a substantially rigid collapsible liner. The liner and/or overpack may include one or more barriers and/or coatings as described herein. The liner and/or overpack may be substantially smooth surfaced or may include surface features as generally described above, including rectangular shaped panels, such as six panels, around the circumference of the liner and overpack. The panels may be generally evenly spaced and of substantially the same size and shape. The panels may have a height generally equal to the non-sloping height of the liner and overpack; that is, the panels may not extend to cover the top or bottom portions of the liner and overpack that begin to slope or curve toward the mouth or bottom of the liner and overpack. The embodiment may also include a base cup or chime that may have a height sufficient to generally cover the rectangular panel surface features. The chime may provide added strength to the system and may also provide a smooth surface for attaching labels. The base cup may include a colorant or other additives to protect the liner and overpack from, for example, UV or infrared light. The overpack may include connecting features for connecting to the chime, including adhesive or snap-fit features that allow the chime to be detachably coupled to the overpack. The mouth and/or neck of the liner and/or overpack may be configured to couple with existing glass bottle pump dispense systems, such that the liner and overpack may be used as a replacement for existing glass bottles. In addition, the mouth and/or neck of the liner and/or overpack may be configured to couple with and/or existing pressure dispense connectors. As pressurized gas or liquid is introduced into the annual space between the interior walls of the overpack and the exterior walls of the liner during pressure dispense, the liner may be particularly configured to collapse in upon itself and away from the walls of the overpack.

In one embodiment, non-dispense related distortion may be minimized or substantially eliminated by configuring a closure or cap to respond to changes in pressure within the liner-based system, generally like a bellows. For example, a cap that may be secured to the liner and/or the overpack during shipping and/or storage may be configured similar to a vertically disposed accordion. The accordion section of the closure may generally be flexible enough to move vertically up and/or down in response to a change in pressure. For example, if the contents of the container are filled at room temperature, the closure is secured, and the temperature subsequently drops, the resulting change in pressure will tend to make the liner-based system collapse inward. Instead of the liner and/or overpack walls collapsing inward, however, the flexible bellows-like closure may be pulled downward into the liner to take up more space in the liner and thereby help equalize the pressure without the liner and/or overpack walls distorting inward, in some embodiments. The bellows-like closure may be comprised of any suitable material or combination of materials, for example, but not limited to plastic, rubber, or any other material, or combination of materials. Further, the bellows-like closure may have any suitable length and/or thickness. In other similar embodiments, a cap may instead generally be a pressurized ballast cap.

Similarly, in some embodiments, the bottom of the overpack and/or liner may be configured with a folding pattern or predetermined fold lines that allow for flexible reaction to pressure changes within the liner-based system, so as to reduce or eliminate non-dispense related distortion. Fold lines at or near the bottom of the overpack and/or liner may take any general shape that may allow the liner-based system to react to non-dispense related changes in pressure. For example, one or more fold lines may be generally configured as a bellows-like closure described above, thereby allowing the bottom of the liner-based system to extend or compress at the flexible fold lines in response to a change in pressure within the liner-based system, resulting from a change in temperature, for example. In other embodiments, the fold lines may create a generally gusseted bottom portion that may allow the sides of the bottom portion of the liner and/or overpack to bend inward or expand outward at the fold lines in response to a change in pressure in the liner-based system. The number and/or placement of the fold lines is not limited and may generally include any number of fold lines or configuration of fold lines that may allow for the generally flexible and controlled movement of the liner and/or overpack in response to a change in pressure.

In some embodiments one or more valves, for example one-way valves or check valves, may be incorporated into the liner-based system to substantially equalize any change in pressure that may occur during storage and/or shipping, for example. In such embodiments, a valve may be configured as part of a closure that may allow air to either enter or exit (depending on the configuration of the one-way valve) the annular space between the exterior walls of the liner and the interior walls of the overpack. For example, a closure or connector may have a passageway from the annular space to an external area, a valve may be positioned in the passageway. Allowing air to enter or exist the annular space in response to a change in pressure in the liner-based system may substantially reduce or eliminate non-dispense related distortion. In some embodiments a vent may additionally or alternatively serve a similar purpose. The vent, like a valve, may allow air to enter and/or exit the annular space, in some embodiments, so as to equalize a change in pressure that may occur in the liner-based system. In embodiments that include a valve and/or vent, a desiccant may also be included in the liner-based system. The one or more desiccants may be disposed in the annular space and may generally attract and hold any moisture that may be introduced therein via the vent and/or valve, thereby reducing or preventing the risk of contamination of the contents of the liner.

In some embodiments, additional strength may be provided to the liner-based system by configuring the overpack in two pieces that may couple to one another, as may be seen in FIGS. 15A and B, 34B, 35, 44-45B, for example. The two sections of the overpack, for example a top half and a bottom half, may be separately molded and then secured together by any suitable means, for example, but not limited to, snap-fit, friction fit, complementary threading, welding, and/or adhesives. The additional strength that may be provided by configuring the overpack in two sections may generally reduce the risk of the overpack distorting due to a non-dispense related change in pressure for example.

In still another embodiment, the overpack may, or may also be, comprised of carbon fiber for example. Carbon fiber may provide advantages for the overall system and its users at least because it may be generally relatively light weight and strong. The carbon fiber overpack may be any suitable thickness.

In other embodiments, one or more coatings may be applied to the exterior of the liner/overpack to provide additional strength and support for the liner/overpack, such that the liner/overpack may generally resist non-dispense related distortion. Such strengthening coatings may be applied in any suitable thickness, or in any suitable number of layers. Further, one or more different coatings may be applied to the overpack in order to provide suitable strength. The coating(s) may be applied by any suitable method or combination of methods, including by dip coating, spraying, or any other suitable method. In other embodiments, a coating may, or may also be applied to the interior of the overpack.

While described herein under the heading for rigid collapsible liners, it will be understood that the surface features and/or designs described in this section for the liner and/or overpack may be equally applicable to any of the various embodiments of containers and/or liners for replacing glass bottles discussed further below.

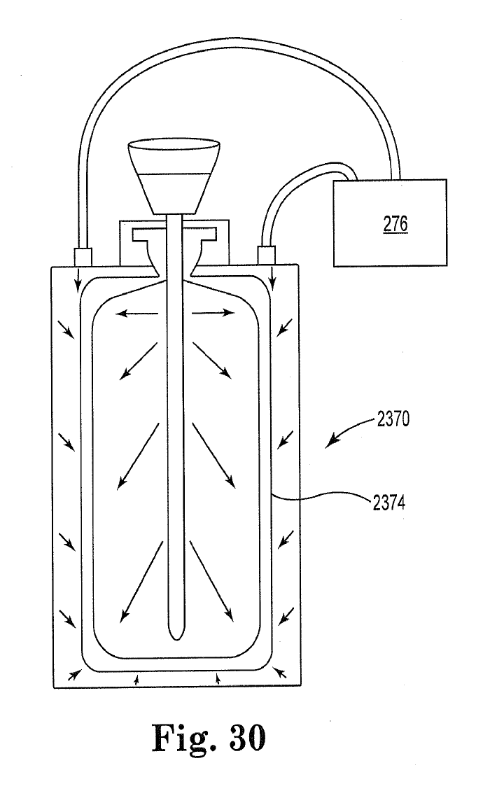

In some embodiments, the blow molding or stretch blow molding process may include an additional step. Once the liner is removed from the liner mold 2360 as described above, the liner may be positioned in another liner mold 2370, as shown in FIG. 30. The liner body 2374 may be heated. The liner mold 2370 may be operably coupled to an air source 276 that may direct a gas into the space between the exterior surface of the liner body 2374 and the interior surface of the liner mold 2370. Accordingly, the gas, which may in some embodiments be heated, may push and stretch the liner material inward, thereby thinning the liner walls. In some embodiments, the liner mold 2370 may be configured to direct the air into specific areas of the liner mold 2370 in order to more precisely control where the thinning of the liner walls occurs. Further, in some embodiments, the air source 276 may be coupled to a control mechanism that allows the amount of air that enters the liner mold 2370 to be monitored and/or controlled, such that the degree of pressure exerted on the liner body 2374 can be controlled. In other embodiments, there may additionally or alternatively be a gas pushing the liner material outward onto the interior surface of the liner walls, in order to thin or further thin the liner walls and/or to obtain more control over the degree of thinning and/or the placement of the thinning. Accordingly, in some embodiments, the liner may be stretched both inwardly and outwardly at the same time, or the liner may be stretched inwardly first and then outwardly in an alternating way, for example, or the liner may be stretched and/or thinned in any suitable way using inward and/or outward stretching techniques. In some embodiments, the use of inward and/or outward stretching techniques as described herein may allow for the controlled ability to create geometric form features, for example, on the interior and/or exterior surface of the liner walls.

In use, the liner may be filled with, or contain, an ultrapure liquid, such as an acid, solvent, base, photoresist, dopant, inorganic, organic, or biological solution, pharmaceutical, or radioactive chemical. It is also recognized that the liner may be filled with other products, such as but not limited to, soft drinks, cooking oils, agrochemicals, health and oral hygiene products, and toiletry products, etc. The contents may be sealed under pressure, if desired. When it is desired to dispense the contents of the liner, the contents may be removed through the mouth of the liner. Each of the embodiments of the present disclosure may be dispensed by pressure dispense or by pump dispense. In both pressure dispense and pump dispense applications, the liner may collapse upon emptying of the contents. Embodiments of liners of the present disclosure, in some cases, may be dispensed at pressures less than about 100 psi, or more preferably at pressures less than about 50 psi, and still more preferably at pressures less than about 20 psi, in some cases, the contents of the liners of some embodiments may be dispensed at significantly lower pressures, as described in this disclosure. Each embodiment of a potentially self-supporting liner described herein, may be shipped without an overpack, in some embodiments, and then placed in a pressurizing vessel at the receiving facility in order to dispense the contents of the liner. To aid in dispense, any of the liners of the present disclosure may include an embodiment that has a dip tube. In other embodiments, the liners of the present disclosure may not have a dip tube.

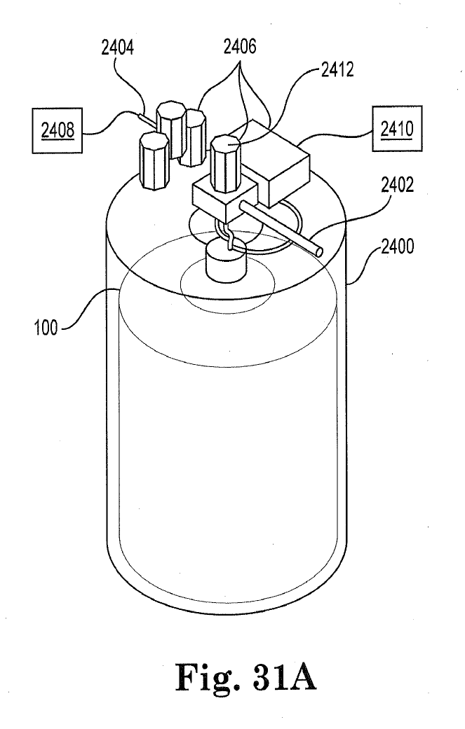

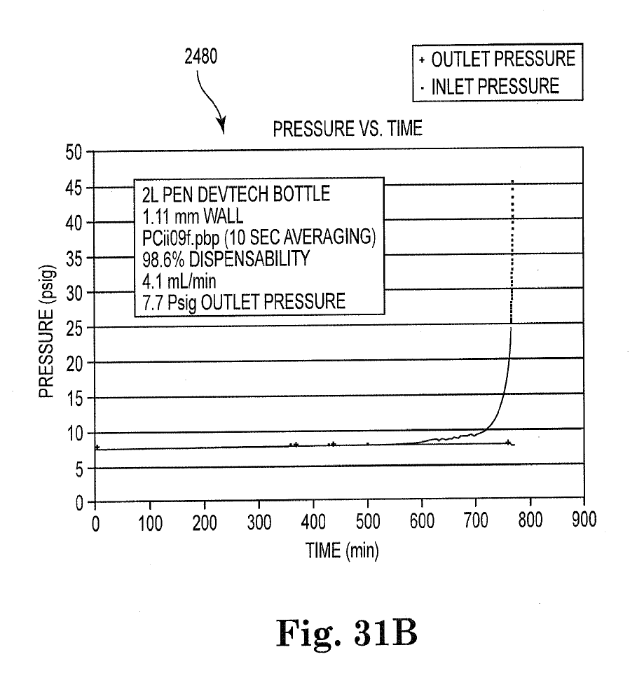

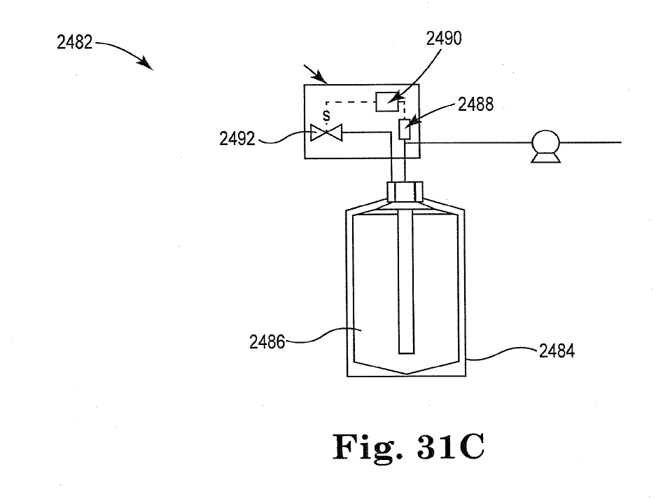

In one embodiment, to dispense liquid stored in the liner, the liner of the present disclosure may be placed in a dispensing canister, for example a pressurizing vessel, such as the canister 2400 illustrated in FIG. 31A. Particularly, a gas inlet 2404 can be operably coupled to a gas source 2408 to introduce gas into the canister to collapse the liner and pressure dispense the liquid stored within the liner inside canister 2400 through a liquid outlet 2402. Canister 2400 may also include the control components 2406 to control the incoming gas and outgoing liquid. A controller 2410 can be operably coupled to control components 2406 to control the dispense of the liquid from the liner. One or more transducers 2412 may also be included in some embodiments to sense the inlet and/or outlet pressure.

Generally, the outlet liquid pressure may be a function of the inlet gas pressure. Typically, if the inlet gas pressure remains constant, the outlet liquid pressure may also be generally constant in the dispensing process but decreases near the end of dispense as the container nears empty. Means for controlling such dispense of fluid from the liner are described for example in U.S. Pat. No. 7,172,096, entitled “Liquid Dispensing System,” issued Feb. 6, 2007 and PCT Application Number PCT/US07/70911, entitled “Liquid Dispensing Systems Encompassing Gas Removal,” with an international filing date of Jun. 11, 2007, each of which is hereby incorporated herein by reference in its entirety.

In embodiments where inlet gas pressure is held generally constant, as further described in detail in PCT Application Number PCT/US07/70911, the outlet liquid pressure can be monitored. As the container or liner nears empty, the outlet liquid pressure decreases, or droops. Detecting or sensing such decrease or droop in outlet liquid pressure can be used as an indication that the container is near empty, thereby providing what may be referred to as droop empty detect.

In some embodiments, however, it can be desirable to control the outlet liquid pressure such that it is substantially constant throughout the entire dispensing process. In some embodiments, in order to hold the outlet liquid pressure substantially constant, the inlet gas pressure and outlet liquid pressures may be monitored, and the inlet gas pressure may be controlled and/or vented in order to hold the liquid outlet pressure constant. For instance, relatively low inlet gas pressure may be required during the dispensing process due to the relatively full nature of the liner, except when the liner is near empty. As the liner empties, higher inlet gas pressure may generally be required to further dispense the liquid at a constant outlet pressure. Accordingly, the outlet liquid dispensing pressure may be held substantially constant throughout the dispensing process by controlling the inlet gas pressure, as can be seen in FIG. 31B, which shows the inlet gas pressure increasing as the liner nears complete dispense.

At a certain point in the dispensing process, the amount of inlet gas pressure required to empty the liner can quickly become relatively high, as shown in the graph 2480 of FIG. 31B. In some embodiments, monitoring the rising inlet gas pressure throughout the dispensing process may be used to provide an empty detect mechanism. For example, in one embodiment, the inlet gas pressure may be monitored, and when the inlet pressure reaches a certain level, it may be determined that the liner is empty and the dispensing process is complete. An empty detect mechanism such as this may help save time and energy, and consequently money.

For example, in some embodiments the inlet gas pressure and/or the liquid outlet pressure may be monitored and/or controlled during dispense. In some embodiments, the liquid outlet pressure may be sensed by an outlet pressure transducer 2412, for example. The signal from the outlet pressure transducer 2412 may be read by the controller 2410. If the liquid outlet pressure is too low, the inlet gas pressure on the area between the liner 100 and the overpack 2400 may be increased via one or more inlet solenoids, for example, which may comprise a portion of the control components 2406. If the liquid outlet pressure is too high, the area between the liner 100 and the overpack 2400 may be vented by one or more venting solenoids, for example, which may comprise a portion of the control components 2406. A pressure sensor positioned in the annular space between the liner 2486 and the overpack 2400 may determine if the dispensing end point has been reached, for example, if the high inlet gas pressure limit has been reached, as described above, or by any other suitable method of determining when dispensing should end.

In another embodiment, an alternative pressure control system 2482 may be used, as shown in FIG. 31C. In some embodiments, such an alternative pressure control system 2482 may be a simplified system 2482, that may in some cases be a relatively lower-cost dispensing system. A pressure switch or transducer 2488, for example, may measure the liquid outlet pressure. A microcontroller 2490 may read the sensor provided by the pressure switch or transducer 2488. If the liquid outlet pressure is below a desired pressure, a signal may be set to be emitted, for example. In some embodiments, the triggering of the signal may act to increase the inlet gas pressure to the system 2482, which would increase the outlet liquid pressure. In addition, the system 2482 may monitor the number and/or frequency of signals emitted. In one embodiment, a dispense end point, or substantially full dispense, may be detected based on the number of signals emitted over a set period of time. In further embodiments, the gas source 2492 providing the inlet gas pressure may be regulated to the desired pressure limit of the overpack 2484. In other embodiments, the alternative pressure control system 2482 may also incorporate a venting mechanism, in the event that if the inlet gas pressure becomes too high, the pressure may be suitably reduced.

In another embodiment, the alternative pressure control system 2482 may be used as a pressure assist device for use with pump dispense systems. When the contents of a liner are dispensed by pump dispense, a vacuum may be created in the liner as the pump draw proceeds. Stiction created by the liner may make the pump dispense more difficult and/or increase the force required to dispense the contents of the liner as dispense proceeds. Using the alternative pressure control system 2482 and a pressure assists device in conjunction with pump dispense may allow the dispense to proceed more quickly and with less effort, in some embodiments. During pressure-assisted pump dispense the liner may collapse vertically as well as radially, in some embodiments. For example, as pump dispense proceeds and the contents of the liner are nearing depletion, the liquid outlet pressure may drop below a desired value due to, for example, stiction in the liner, etc. As such, in some embodiments, as the liner nears depletion, the force required to pump dispense the remaining material may be greater. Typically, if the force is not increased, the liquid outlet pressure will decrease and/or the dispense flow rate may be reduced. In some embodiments, accordingly, the liquid outlet pressure may be monitored and/or controlled during dispense. Similar to embodiments described above, the liquid outlet pressure may be sensed by an outlet pressure transducer 2412, for example. If the liquid outlet pressure drops and/or drops below a set value, for example, a signal may be emitted. The signal from the outlet pressure transducer 2412 may be read by the controller 2410. In some embodiments, the emission of a signal from the outlet pressure transducer 2412 may cause the system 2482 to add pressurized gas into the annular space between the liner 2486 and the overpack 2484, which may help maintain the liquid outlet pressure at which the contents may be dispensed, in some cases at a desired level. In other embodiments, instead of reacting to a single signal from the outlet pressure transducer 2412, the system 2482 may introduce pressurized gas into the system 2482 when a specified number of signals have been emitted, for example, over a specified period of time. In some embodiments, a user may program the system 2482 to control the rate of dispense, including when pressurized gas may be introduced into the system during dispense. The system 2482 may also detect a dispense end point, or substantially full dispense, in some embodiments. For example, the system 2482 may be controlled to end dispense based on the number of signals emitted over a set period of time, which again, in some embodiments may be set by the user. In further embodiments, the gas source 2492 providing the inlet gas pressure may be regulated to the desired pressure limit of the overpack 2484. In other embodiments, the alternative pressure control system 2482 may also incorporate a venting mechanism, in the event that if the inlet gas pressure becomes too high, the pressure may be suitably reduced.

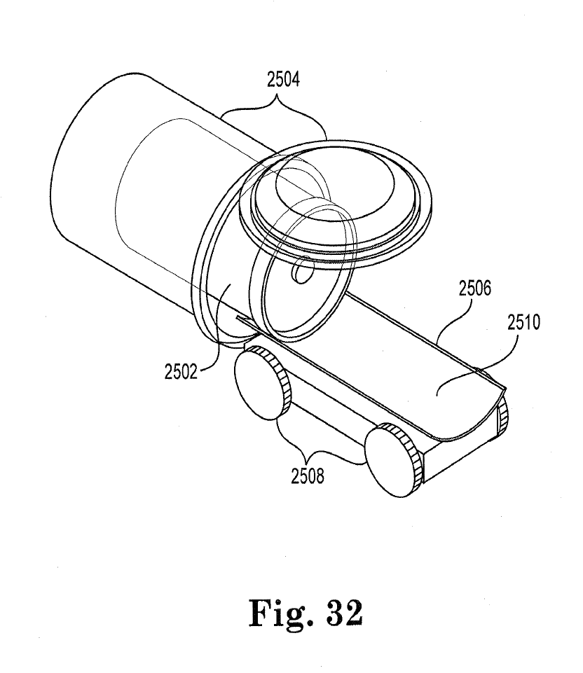

In some cases, the size and associated weight of a liner, including metal collapsible liners as described above, storing a significant volume of contents (such as over 19 L) can make it difficult for one or two people to lift the filled liner into a standard pressure dispense vessel. Accordingly, in some embodiments, to make it generally easier to position the liner within a pressure dispense vessel, the rigid collapsible liner may be loaded for pressure dispense into the pressure vessel while it is substantially horizontally positioned, as shown in FIG. 32. Loading the liner 2502 into a horizontally positioned pressure vessel 2504 may be particularly advantageous for liners holding more than about 19 L of material.

Generally, a loading system may include a horizontally positioned pressure vessel 2504, a transport cart 2506, and a liner 2502. The horizontally positioned pressure vessel 2504 may be a customized or standard pressure vessel that may be horizontally positioned. In some embodiments, a horizontal pressure vessel may be supported on a table, cradle, or other surface at a height that is generally compatible with the height of a transport cart 2506. In still further embodiments, the pressure vessel 2504 may be placed on a table, cradle, or other surface that has wheels or rollers affixed to a bottom surface so as to permit a user to easily move the pressure vessel that is placed upon the table, cradle, etc. closer to a liner 2502 that may or may not be positioned on a transport cart 2506. In still other embodiments, a pressure vessel itself may have wheels or rollers detachably or fixedly attached to it so as to allow the pressure vessel 2504 to be easily moved about in a horizontal position. In some cases, the attached wheels may raise the pressure vessel to a height relative to the ground that is generally compatible with, i.e., of generally the same height as, or of a slightly greater height than the height of a transport cart. The number of wheels or rollers that may be attached to a pressure vessel or to a table, or cradle for holding a pressure vessel can vary from one wheel or roller to any suitable number of wheels or rollers. Wheels may be comprised of any known suitable material, such as, for instance, rubber, plastic, metal, or any suitable material or combination of materials. Additionally, in embodiments where a horizontally positioned pressure vessel has wheels or rollers, the pressure vessel may also include a wheel break or breaks or stoppers so that once the pressure vessel has been moved to a desired location, the pressure vessel may be generally safely and securely kept in that position. This may be particularly important during the process of loading the liner into the vessel. In such embodiments, there may be one or any other suitable number of breaks positioned on the pressure vessel. Similarly, a wheel break or breaks may also be added to the underside of a table, or cradle for holding a pressure vessel.

A transport cart 2506 in some embodiments may include a liner transport surface 2510 and wheels or rollers 2508. The transport surface 2510 itself may be comprised of metal, plastic, rubber, glass, or any other suitable material, or combination of materials. The surface 2510 may be textured in some embodiments such that the liner may remain in position when the transport cart 2506 is being moved. The texturing may also help to minimize the contact area with the inside of the pressure vessel, which could restrict the ability of the user to load the liner into the pressure vessel. In some embodiments, for example, the surface 2510 of the transport cart may have small raised circles thereupon to act as a gentle grip that may help secure the liner 2502 during transport. It is recognized that any type of texture may be applied to the surface of the transport cart, including any type of geometric shape or pattern, including for instance a random pattern. In some embodiments that include a textured surface, the texturing may not be so great as to impede a user from relatively easily moving or sliding the liner 2502 along the vertical distance of the surface 2510 of the transport cart in order to load the liner 2502 into a pressure vessel 2504. The support surface may include brackets, supports, movable rails, etc.

In other embodiments, the transport surface 2510 may be configured to enhance the slidability of a liner 2502 across the transport surface. For instance, the surface may be configured to be slick and smooth. In such embodiments, the transport cart may include at least one lip or lock that may be detachably or movably fixed on at least one end of the transport cart 2506. The at least one lip or lock may keep the liner 2502 from sliding off of the transport cart 2506 when the transport cart is being moved.

The liner transport surface 2510 may be generally shaped such that the transport surface 2506 may easily accommodates a rigid collapsible liner 2502, such as the liners described herein. In some embodiments, the transport surface 2510 may be generally curved across the horizontal length of the surface, thereby creating a cradle-like surface for a substantially rounded liner to be securely positioned upon. The degree of curvature of the transport surface may vary to accommodate liners of different sizes. In other embodiments, the degree of curvature may be such that liners of most sizes may be substantially safely and securely positioned on the transport cart 2506. In other embodiments, the transport surface 2510 may be customized to generally fit a specific shaped liner. In yet other embodiments, the transport surface 2510 may be substantially flat with relatively narrow elevated surfaces positioned along the vertical distance of each of the sides of the transport surface 2510 that may act as bumpers to keep a liner 2502 securely and safely positioned on the transport cart 2504. The raised surfaces, bumpers, or rails may be comprised of any suitable material, such as rubber, plastic, or any other suitable material or combination of materials.

The transport cart may also have wheels 2508 in some embodiments so as to allow for generally easy movement of the transport cart. The transport cart 2506 may have any suitable number of wheels, for example, 3 wheels or more. The wheels may be comprised of any known suitable material, such as, for instance, rubber, plastic, metal, or any suitable material or combination of materials.

In use, the liner 2502 may be shipped on a transport cart, or alternately a liner 2502 may be placed, either manually or by automation, on a transport cart when the liner arrives at its destination. Once the liner is placed on the transport cart 2506, the rollers 2508 on the transport cart may allow the cart with the liner to be moved about relatively easily, regardless of the size or weight of the liner 2502. The transport cart 2506 may be used to transport the liner 2502 to a horizontally positioned pressure vessel 2504. Alternately, in embodiments with a movable pressure vessel, the pressure vessel may be transported to the transport cart. The transport cart with the loaded liner may be positioned generally end-to-end with the pressure vessel such that the liner may be slid along the transport surface 2506 of the transport cart 2506 and into the pressure vessel 2504 for dispense.

Container and/or Liner for Replacing Glass Bottles

In further embodiments, liners and liner-based systems of the present disclosure may be used as alternatives to, or replacements for, simple rigid-wall containers, such as those made of glass. As discussed above, such rigid-wall containers can introduce air-liquid interfaces when pressure-dispensing the liquid. This increase in pressure can cause gas to dissolve into the retained liquid, such as photoresist, in the container and can lead to undesired particle and bubble generation in the liquids in the dispense train. Additionally, such containers can have increased overall cost when all factors are considered, including the cost of ownership, shipping, sanitizing, etc.

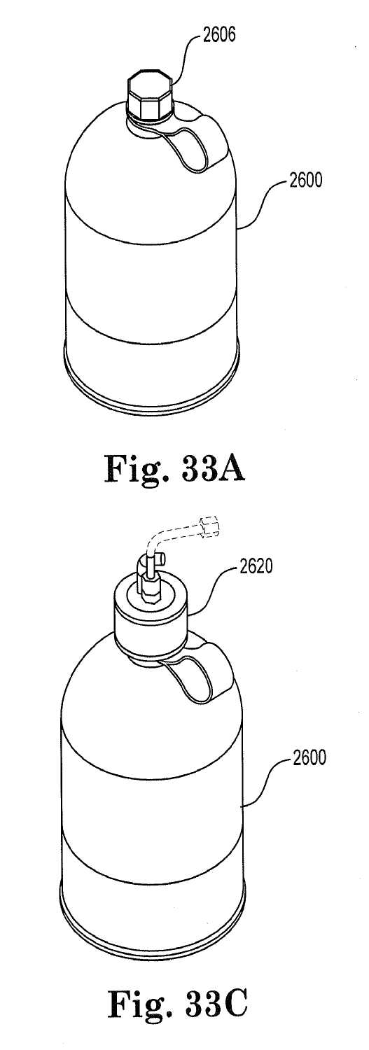

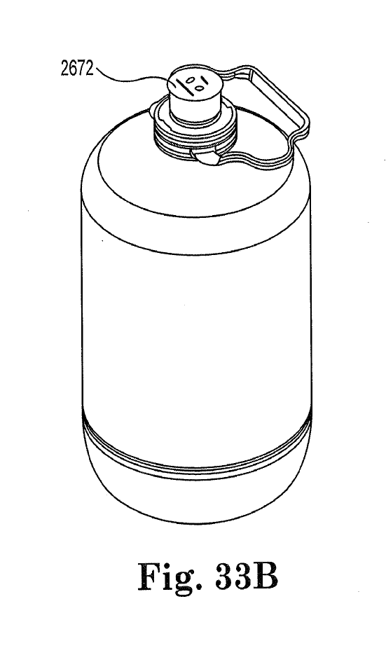

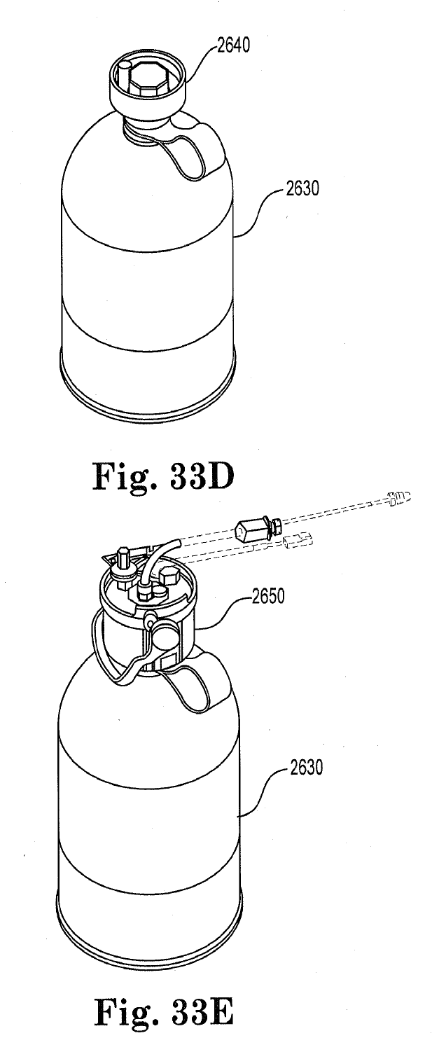

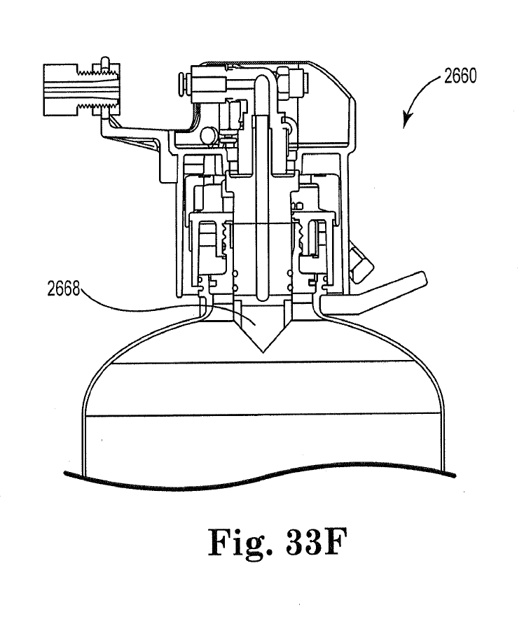

Accordingly, in one embodiment, shown in FIG. 33A, a liner 2600, according to the various embodiments disclosed herein, may include a cap 2606 of the type typically used with glass bottles. The mouth of the liner 2600 may be threaded, or otherwise configured, so as to be compatible with existing glass bottle caps. The cap 2606 may be secured on the liner 2600 after filling the liner 2600, but before the contents are dispensed; for instance, the cap 2606 may be secured on the liner 2600 during storage or shipment of the liner 2600. One embodiment of a cap 2672 that may serve as a temporary cap or “dust” cap is shown in FIG. 33B. Such a dust cap 2672 may be suitable for use with glass bottle replacement systems, or with any other suitable system. In another embodiment, liner 2600 may include a connector 2620 of the type typically used with glass bottles, as is shown in FIG. 33C and as disclosed in U.S. Pat. Appl. No. 61/299,427, titled “Closure/Connector for Dispense Containers,” which was filed on Jan. 29, 2010, the contents of which is hereby incorporated by reference in its entirety. Liner 2600 may be an advantageous alternative for a glass bottle for all of the reasons already discussed, in addition to the fact that liner 2600 may be compatible with existing glass bottle equipment, such as the connector 2620. The connector 2620 may also be used with any of the other embodiments of liners disclosed herein, in some embodiments. The liner 2600 may be used in some embodiments as a stand-alone self-supporting liner, while in other embodiments, the liner 2600 may be used with an overpack.

In yet another embodiment, shown in FIGS. 33D and E, the liner 2630 may include a misconnect prevention closure 2640 as well as a misconnect prevention connector 2650. The misconnect prevention closure 2640 and misconnect prevention connector 2650, in some embodiments, may be configured such that they are compatible with the NOWPak® dispense system, such as that disclosed in U.S. patent application Ser. No. 11/915,996, titled “Fluid Storage and Dispensing Systems and Processes,” which was filed Jun. 5, 2006, the contents of which are hereby incorporated by reference in their entirety herein. Samples of the misconnect prevention connector 2650 may be that of ATMI of Danbury, Conn., or those disclosed in U.S. Pat. No. 5,875,921, titled “Liquid Chemical Dispensing System with Sensor,” issued Mar. 2, 199; U.S. Pat. No. 6,015,068, titled “Liquid Chemical Dispensing System with a Key Code Ring for Connecting the Proper Chemical to the Proper Attachment,” issued Jan. 18, 2000; U.S. Patent Application No. 60/813,083 filed on Jun. 13, 2006; U.S. Patent Application No. 60/829,623 filed on Oct. 16, 2006; and U.S. Patent Application No. 60/887,194 filed on Jan. 30, 2007, each of which is hereby incorporated by reference in its entirety. In still another embodiment, a misconnect prevention connector may be provided with punched key codes, RFID (Radio Frequency Identification) chips, or any other suitable mechanism or combination of mechanisms that may be used to prevent misconnection between a connector and the various embodiments of liners and/or overpacks described herein. Another embodiment of liner with a connector may include a connector that does not include a dip tube that extends into to the container, sometimes referred to as a “stubby probe.” The misconnect closure 2640 and the misconnect prevention connector 2650 may be used with any of the embodiments of liners disclosed herein, in some embodiments. In other embodiments, the packaging systems of the present disclosure may include, or permit use of connectors or connection mechanisms traditionally used for glass bottle storage, transportation, and/or dispense systems. In some embodiments, the connectors or connection mechanisms may be made of any suitable material, which in some cases may depend on its use, and the connectors or connection mechanisms may be sterile, aseptic, etc. In still further embodiments, the connectors or connection mechanisms may be configured for applications that involve recirculation of the contents of the packaging systems.

In some embodiments, a connector may be used with a glass bottle replacement system, or any other suitable system for pressure dispense. In some embodiments, as may be seen in FIG. 33F, a connector 2660 may be configured to remove headspace in order to minimize gas dissolution into the contents of the container. Further, in some embodiments the stubby probe may be a relatively short probe 2668 but in some cases the probe 2668 may have a relatively larger diameter flow passage than traditional probes, such as up to but not limited to about a 1 inch diameter or more. The connector 2660 may improve utilization and allow for high pressure dispense of for example, up to about but not limited to 100 kPa drive pressure, in some embodiments.

Liner-based systems for use with a glass bottle replacement system, or any other suitable system may include one or more of a dust cap or temporary cap 2680, a UV protective cover 2682, and/or a neck insert 2684, as may be seen in FIG. 33G. When positioned in the inside of the liner fitment, the neck insert 2684 may generally decrease the diameter of the neck of the liner, such that the liner may be compatible with one or more existing fill or dispense systems that may require a smaller and/or different size or shape opening. The neck insert 2684 may be comprised of any suitable material, such as, but not limited to any plastic or combination of plastics. The neck insert 2684 may be sized such that the exterior of the insert 2684 may generally snuggly fit in the liner fitment, for example, and also such that the interior of the insert 2684 may allow for any desirable fill and/or dispense equipment to compatibly fit therein.

In addition to the disadvantages of simple rigid-wall containers mentioned above, it can also be costly and spatially inefficient to transport empty conventional rigid-wall containers because such containers require a specific amount of area to accommodate their full size. Accordingly, in further embodiments, as discussed above and illustrated, for example, in FIGS. 18A-23B, a liner or container may include predetermined folds, allowing the container to have a flattened and predetermined collapsed state for shipping and storing when empty. Thus, prior to filling, for example but not limited to, with ultrapure liquids, such as acids, solvents, bases, photoresists, slurries, detergents and cleaning formulations, dopants, inorganic, organic, metalorganic and TEOS, and biological solutions, DNA and RNA solvents and reagents, pharmaceuticals, hazardous waste, radioactive chemicals, and nanomaterials, or other materials, for example but not limited to coatings, paints, polyurethanes, food, soft drinks, cooking oils, agrochemicals, industrial chemicals, cosmetic chemicals, petroleum and lubricants, adhesives, sealants, health and oral hygiene products, and toiletry products, etc. the container may be shipped in a predetermined collapsed state, thereby taking up much less space and lowering shipping costs. Upon arrival at the filling location, the container may be expanded along the predetermined folds to its full potential size and filled with the desired contents. The container may have an expanded size that substantially matches or approximates the size of traditional rigid-wall containers, such as glass wall containers, in order that such containers may be easily incorporated into existing pump dispense or pressure dispense systems presently using glass wall containers. In some embodiments, in addition to the predetermined folds, the container may include one or more locking structures, such as dimples, folds, indents, protrusions, or the like, that may be strategically located on the container such that once the container is expanded, the locking structures provide support or assistance for substantially maintaining the container in an expanded state.

Containers described in this section may be made by any method described within the disclosure, including: blow molding, co-blow molding, stretch blow molding, injection or extrusion blow molding, or any other method or combination of methods. Similarly, such a container may be made from any of the suitable materials discussed above, such as but not limited to PEN, PET, or PBN, or any suitable mixtures or copolymers thereof, and may exhibit any of the advantageous properties discussed herein. Also, such container may be any suitable thickness as described above, and may generally be thick and rigid enough to substantially reduce or eliminate the occurrence of pinholes. In addition to taking up much less space during transportation and storage, the embodiments of containers disclosed herein may substantially avoid breakage, which is one disadvantage of some conventional rigid-wall containers, such as glass wall containers. Further, the embodiments of containers disclosed herein may perform better, and in some cases substantially better, than glass bottles during transport, e.g., embodiments of the liners of the present disclosure can be much more resistant and in some cases entirely resist breakage. Liners of the present disclosure may also be inherently shatter-proof, as opposed to glass, making the liners of the present disclosure better able to withstand shock associated with, for example, shipping. The liners of the present disclosure may also be designed to pass UN/DOT tests. The various embodiments of containers described herein may be free-standing and used alone, such as for use with pump dispense systems, or may be used in combination with an overpack, such as for use with pressure dispense systems.

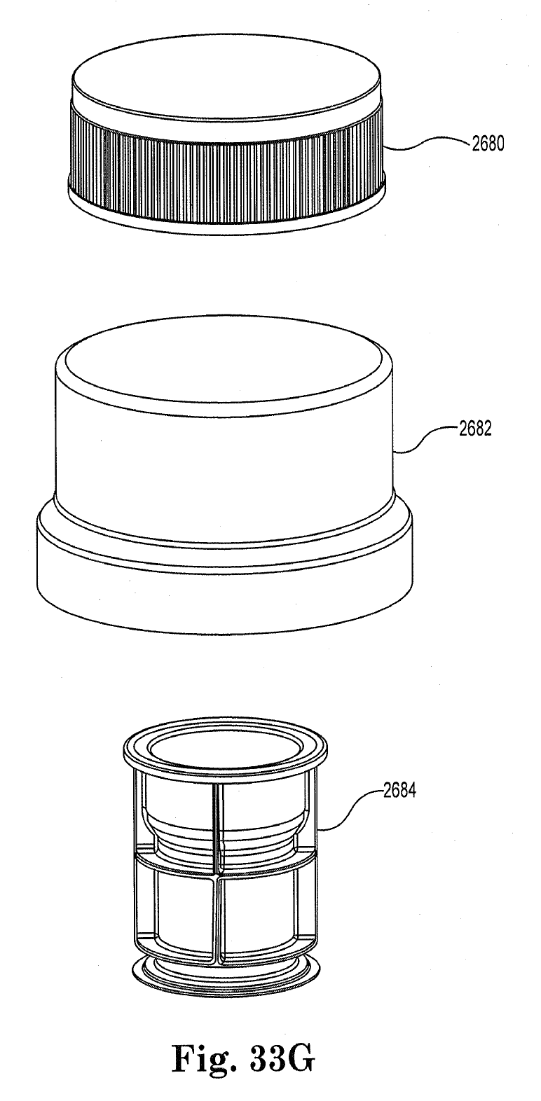

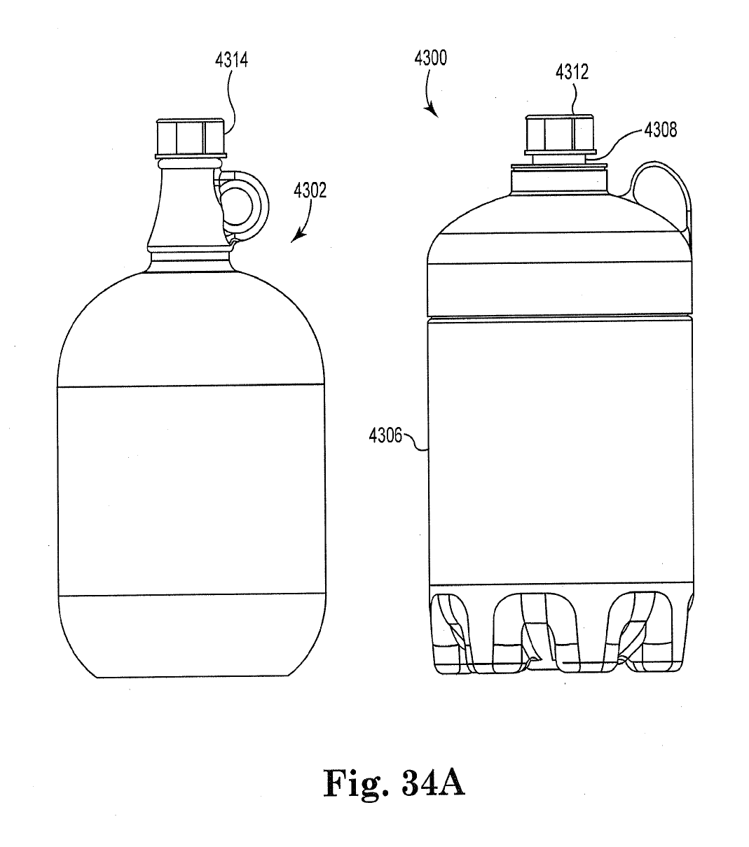

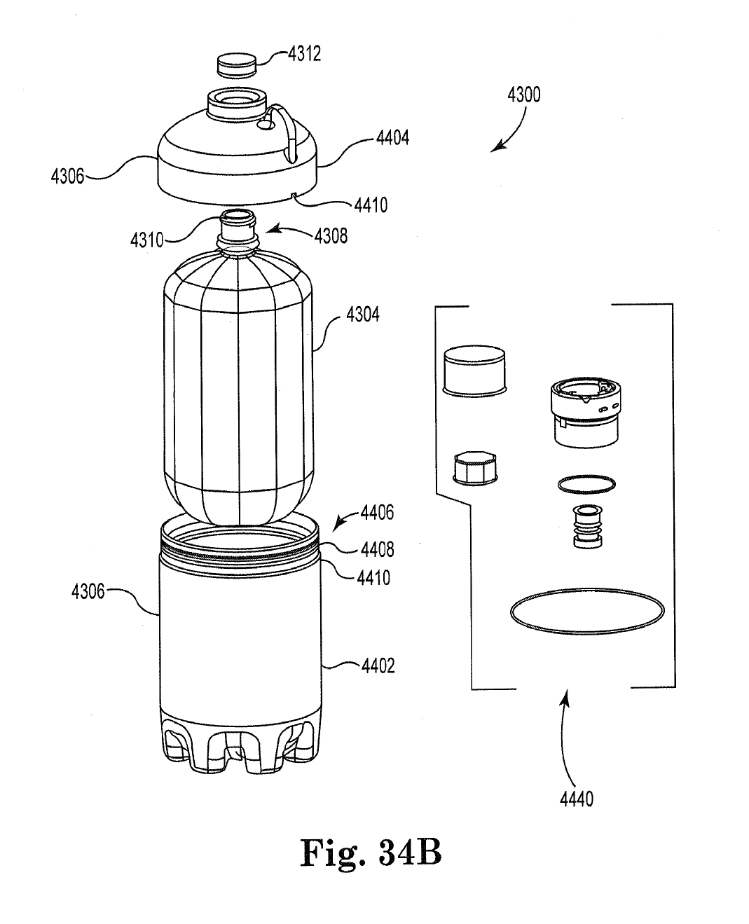

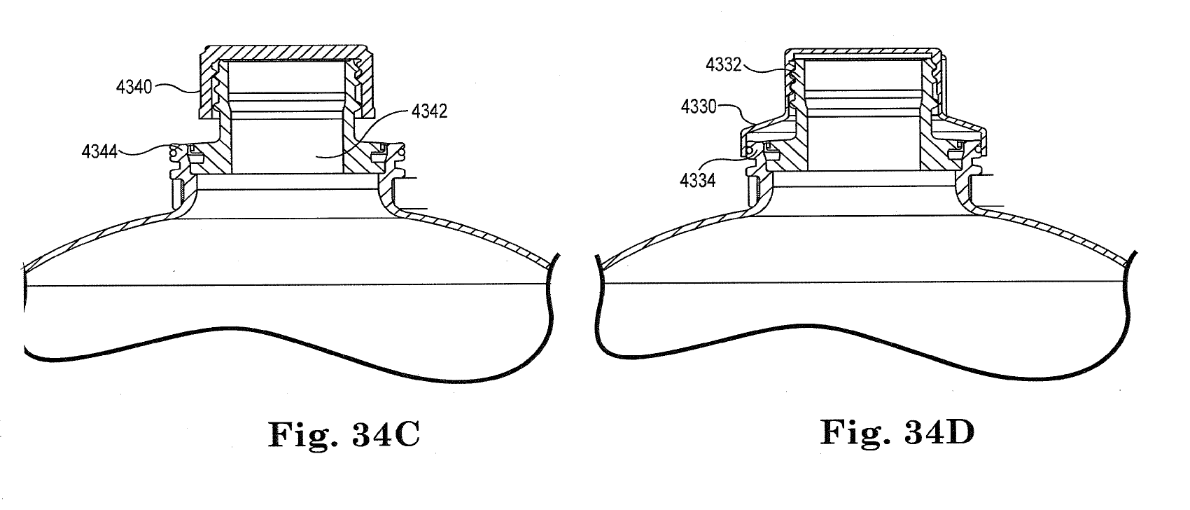

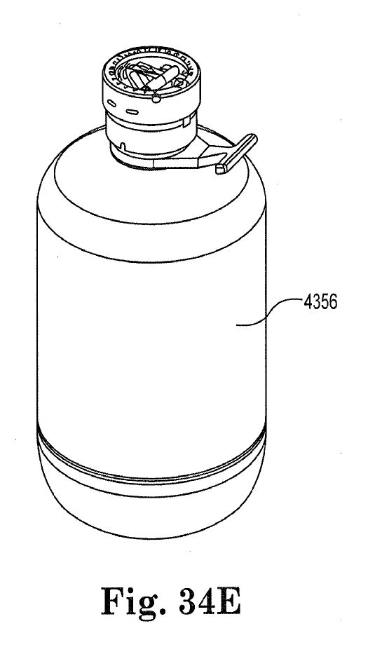

In yet further embodiments, as will be discussed with regard to FIGS. 34A-45C, a liner and overpack system may be designed to be a replacement for conventional rigid-wall containers, and may be specifically designed to be a replacement for conventional glass wall containers, or glass bottles. Accordingly, as shown in FIG. 34A, one embodiment of a liner and overpack system 4300 as disclosed herein may be designed to substantially match one or more of the height, diameter, and volume of a conventional rigid-wall container, such as a glass wall container, or glass bottle 4302. Thus, such liner and overpack system 4300 may be generally easily compatible with existing glass bottle equipment and dispensing systems, allowing end users to generally easily replace their glass bottles with the various embodiments of liner and overpack systems described herein.

As shown in FIG. 34B, system 4300 may include a liner 4304 and an overpack 4306. The liner 4304 may be any suitable liner, such as any of those described in the present application, or any other suitable liner, such as a pillow-type liner. The liner 4304 may include a neck portion 4308, which may have a threaded portion 4310 for receiving a cap 4312. While illustrated with threaded portion 4310, it is recognized that any suitable connection mechanism may be used, such as but not limited to, snap-fit, bayonet connection, friction fit, etc. The cap 4312 may be custom made to connect and seal with neck portion 4308 of the liner 4304. However, in other embodiments, the neck portion 4308 may be configured such that a conventional bottle cap 4314, such as those typically used with glass bottles, may be used, as illustrated in FIGS. 34A and C.

As shown in FIG. 34C, however, a cap 4320 according to another embodiment of the present disclosure may provide more protection than traditional caps such as that shown in FIGS. 34A and C. As may be seen, the cap 4340 shown in FIG. 34C is secured to the liner fitment 4342, but is not secured to the overpack neck 4344. In contrast, the cap 4330 shown in FIG. 34D is secured to or may at least cover both the liner fitment 4332 and at least a portion of the overpack neck 4334. The additional coverage provided by cap 4330 may advantageously shield the contents of the liner from light; may prevent or reduce the risk of environmental moisture entering the contents of the liner; and/or may provide secondary containment because the cap 4330 may be secured to and/or cover both the liner fitment and the overpack, in some embodiments.

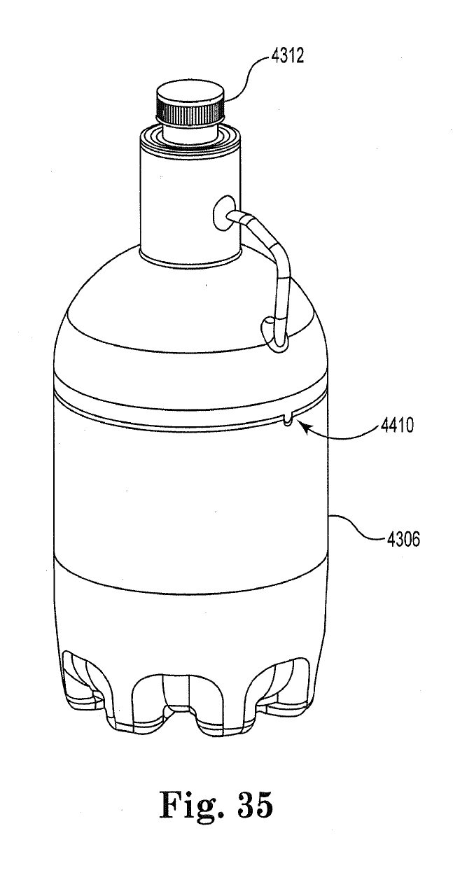

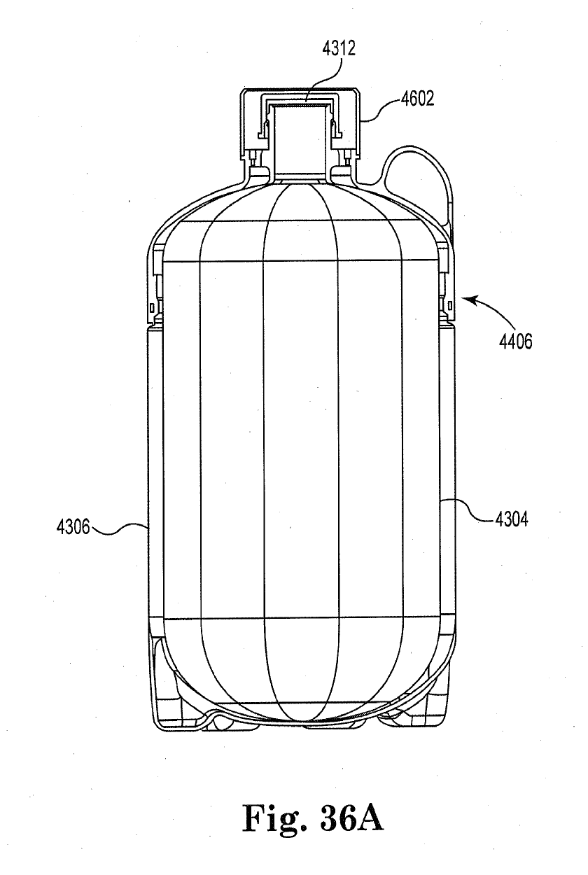

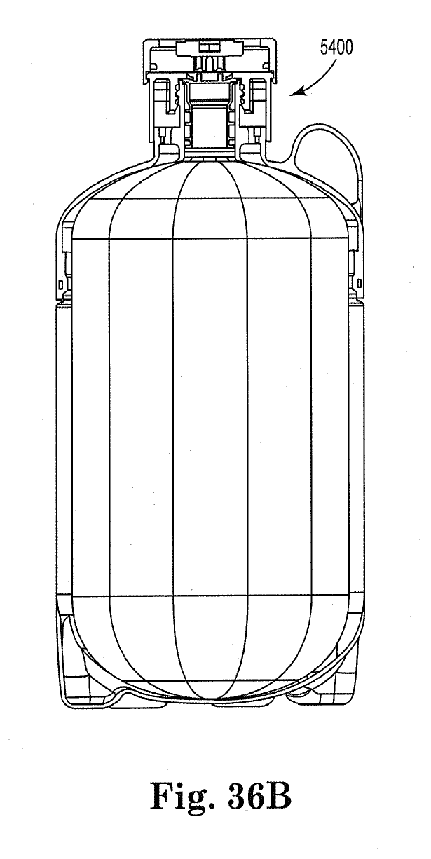

As shown in FIG. 34E, in one embodiment, the overpack 4356 may be a unitary component. However, in other embodiments, the overpack 4306 may include one or more interconnecting portions. As illustrated in FIG. 34B, an overpack 4306 may include a bottom portion 4402 and a top portion 4404, which may interconnect with one another by interconnecting mechanism or means 4406. In some embodiments interconnecting mechanism 4406 may be a snap-fit connection 4408, such as shown in FIGS. 34B and 36A. However, it is recognized that any suitable interconnecting mechanism may be used, such as but not limited to, threading, bayonet connection, friction fit, etc. In some embodiments, shown in both FIGS. 34B and 35, the overpack 4306 may include alignment means 4410, which may assist in the correct alignment of the bottom portion 4402 with the top portion 4404. In one embodiment, the alignment means 4410 may include a tab on the bottom portion 4402 and a corresponding notch on the top portion 4404 for receiving the tab, or vice versa. It is recognized, however, that any other suitable mechanism for assisting alignment of the bottom 4402 and top 4404 portions may be used. While illustrated with two interconnecting portions and as fully surrounding the liner 4304, the overpack 4306 may alternatively comprise a sleeve, such as the sleeve previously described with reference to FIG. 14A, or may have openings in the side walls, so as to save on overpack material. These alternative embodiments may more likely be used with pump dispense systems, where gas or fluid pressure between the overpack 4306 and liner 4304 is not required to dispense the contents of the liner. As may be seen in FIG. 34B, a liner-based system may also comprise one or more caps and/or closures and/or closure assemblies 4440. Such assemblies are discussed elsewhere herein, but may include closure caps, dust caps, temporary caps, connectors, neck inserts, and/or sealing means, such as o-rings, for example.

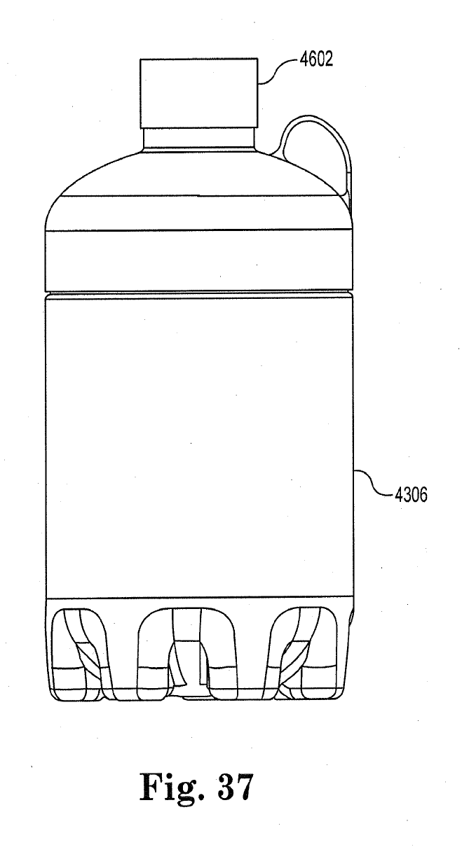

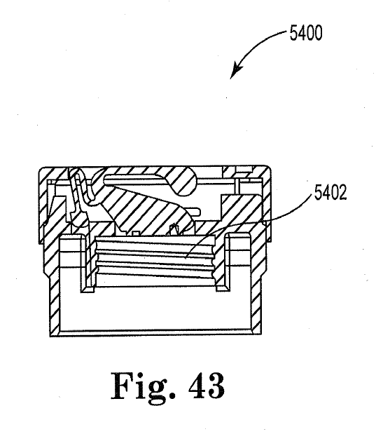

In some embodiments, and particularly in systems using conventional glass bottle caps, the system 4300 may include a protective cap sleeve 4602, as shown in FIGS. 36A and 37, which can help block ultraviolet (UV) light from reaching the liner 4304 and the contents therein once the liner is filled. Similar to the cap 4312, the protective cap sleeve 4602 may be connected to the overpack 4306 using any suitable connection mechanism, such as but not limited to, threading, snap-fit, bayonet connection, friction fit, etc. FIG. 36B shows another cap 5400 that may be used in alternative embodiments, which is described in further detail with respect to FIG. 43.

The liner 4304 and overpack 4306 may each be made from any of the suitable materials discussed above, such as but not limited to PEN, PET, or PBN, or any suitable mixtures or copolymers thereof. Additionally, the liner 4304 and/or overpack 4306 may include one or more UV blocking dyes to prevent the passage of UV light to the contents of the liner. However, in some cases, it may not be desirable that the liner 4304 contain a UV blocking dye as contamination from the dye to the contents of the liner may occur. Thus, in some embodiments, only the overpack 4306 may contain a UV blocking dye, thereby reducing or eliminating the likelihood of contamination to the contents of the liner. This may be another advantage over conventional rigid-wall containers, such as glass bottles, where UV blocking dyes may result in contamination of the contents of the containers.

In some embodiments, moisture-resistant or water-resistant properties of a liner may be, or may also be enhanced. For example, the moisture or water permeation properties of a PEN liner that may be used as a glass bottle replacement, for example, may be improved. While a PEN liner is specifically discussed, it will be understood that the moisture or water permeation properties of liners comprised of other materials, for example, but not limited to PET, PBN or any other suitable material or combination of materials may also be improved in a similar way. Improving the moisture-resistant or water-resistant properties of a liner may advantageously reduce or substantially eliminate the ability of moisture or water to seep into the contents of the liner through the liner walls. As has been discussed in detail herein, many materials must remain substantially pure and uncontaminated. Therefore, reducing or eliminating the risk of contamination from any source, including moisture or water, can be advantageous. Increased moisture or water resistant properties may be particularly useful for storing certain materials, such as, for example but not limited to, photoresist, which may be described as a substantially dry material that may easily become contaminated with the introduction of even a small amount of moisture or water.

In one embodiment, a liner may be coated with a material that enhances the ability of the liner to resist the movement of moisture or water from outside of the liner into the interior of the liner. As was discussed above, any suitable coating material may be used to coat the wall of the liner. For example, aluminum, silica, silica-alumina, or any other suitable material or combination of materials may be used to increase the moisture or water resistance of the liner. The enhancing layer or coating may be of any suitable thickness and may be deposited onto the exterior surface of the liner by, for example, vacuum techniques such as electron beam deposition, plasma discharge, vacuum evaporation, sputtering, and chemical plasma-enhanced deposition techniques, such as liquid and/or gas followed by post-treatment, or any other suitable technique or combination of techniques. While the enhancing layer or coating has been described as being on the exterior of the liner, in other embodiments the coating may line the interior of the liner.

In another embodiment, a PEN liner, for example, may be comprised of one or more layers. In embodiments comprising multiple layers, one or more layers of the PEN liner may be comprised of a material with moisture-barrier properties, for example, but not limited to polyethylene, metallized film, or any other suitable material, or combination of materials.

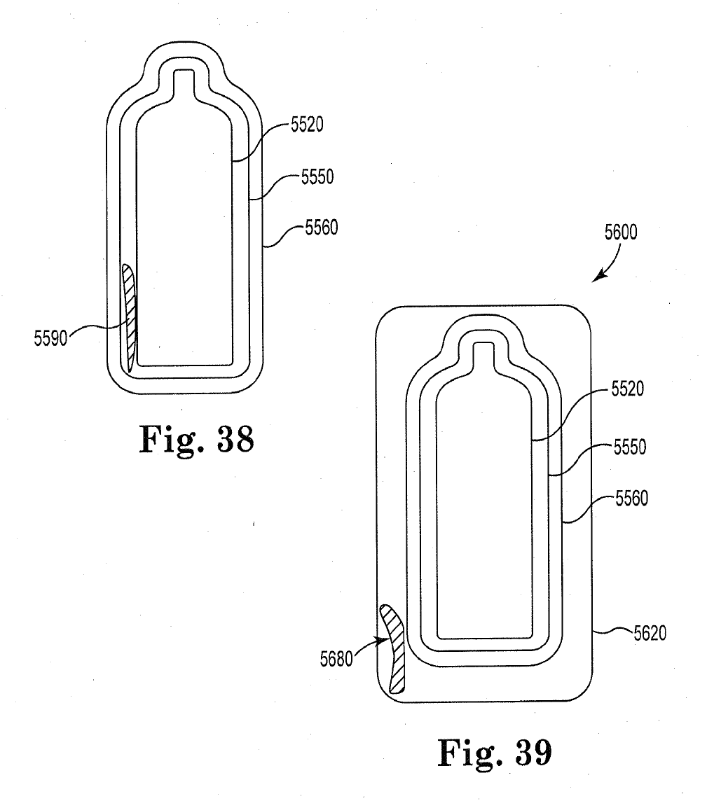

In another embodiment, a desiccant may be used in conjunction with a liner, such as a PEN liner, for example, to help reduce or substantially eliminate the permeation of moisture or water into the liner. While a PEN liner is specifically discussed, it will be understood that the moisture or water permeation properties of liners comprised of other materials, for example, but not limited to PET, PBN or any other suitable material or combination of materials may also be improved in a similar way. In one embodiment, a desiccant may be used in conjunction with a rigid PEN liner that may be used as a glass bottle replacement, as described herein. Typically, a rigid liner may be filled with a desired substance and then stored and/or shipped. Prior to storing or shipping, a conventional rigid liner may be placed in one or more bags, such as for example, one or more polyethylene bags. In some cases, the bagged liner may then be placed in an additional shipping and/or storage container, such as, but not limited to a cardboard box. In some particular embodiments of the present disclosure, a PEN rigid liner may be filled and then placed in a shipping/storage bag that may be comprised of, but not limited to polyethylene, or any other suitable material. As may be seen in FIG. 38, a liner 5520 may be placed inside of a bag 5550. In the space between the liner 5520 and the bag 5550, a desiccant 5590 may be placed. The desiccant 5590 may take any appropriate shape and may have any appropriate size. A desiccant 5590 in one embodiment can perform substantially the same function as the enhancing layer or coating described above, for example, the desiccant can reduce or prevent moisture or water from moving from outside of the liner 5520 to inside of the liner 5520. In some embodiments, as shown, the bag 5550 may be placed inside of a second bag 5560. While FIG. 38 shows an embodiment where a desiccant is placed in the space between the liner 5520 and the first bag 5550, in other embodiments, a desiccant may be alternatively or additionally placed in the space between the first bag 5550 and the second bag 5560. It will be understood that any suitable number of bags may be used to secure, store, and/or ship the liner 5520. Further, it will be understood that any number of desiccants may be placed in indicated positions.

In another embodiment, shown in FIG. 39, the liner 5520 placed in one or more bags 5550, 5560 may be placed in an outer container 5620 for storage and/or shipping. The outer container may be any suitable outer container including, for example, but not limited to an overpack, a cardboard box, or any other suitable container. A desiccant 5680 may be placed in the space between the outer container 5620 and the outermost bag 5560, for example. In other embodiments, one or more desiccants may be placed at any suitable position in the system 5600, including between the liner 5520 and the innermost bag 5550, and/or between the innermost bag 5550 and the next or outermost bag 5560, and/or between the outermost bag 5560 and the outer container 5620.

While described herein under the heading for containers and/or liners for replacing glass bottles, it will be understood that the apparatus and methods for reducing or preventing the movement of moisture or water into the contents of the liner may be equally applicable to any of the various embodiments of liners described herein and are not limited to use with only containers and/or liners for replacing glass bottles.

Other advantages of using, for example, PEN, PET, or PBN, or any suitable mixtures or copolymers thereof, over glass bottles include recyclability. The recycling process for liners of the present disclosure can result in substantially less harmful carbon dioxide (CO₂) emissions. For example, using a liner of the present disclosure may reduce CO₂ emissions by about 55% when incinerating the liners of the present disclosure as compared to incineration of rigid glass bottles. Similarly, CO₂ emissions may be reduced by about 75% when using a thermal recycling process to recycle liners of the present disclosure as compared to incineration of rigid glass bottles.

Yet another advantage of using for example, PEN, PET, or PBN, or any suitable mixtures or copolymers thereof, over glass bottles may include a reduction in total consumable cost, including lower containment, packaging material, shipping and disposal cost. By way of example, costs typically incurred by a chemical supplier employing glass bottles relate to: receiving the bottles; blooming processes; cleaning, rinsing, and drying the bottles; inspection of the empty bottles; filling; inspection of the outgoing bottles; custom packaging configured specifically for the transport of the bottles; freight up-charges because of weight, and breakage costs. In contrast, using some embodiments of the present disclosure, the costs that may typically be incurred by a chemical supplier can be reduced to costs relating to: receiving the liners; filling; and inspection of the outgoing liners. Standard packaging with no freight up-charges can be used and breakage is substantially reduced or eliminated. There can be up to approximately an 80% reduction in weight over glass bottles. As may be appreciated, the significantly more streamlined process for some embodiments of the present disclosure may result in a significant cost savings and time savings over the use of glass bottles.

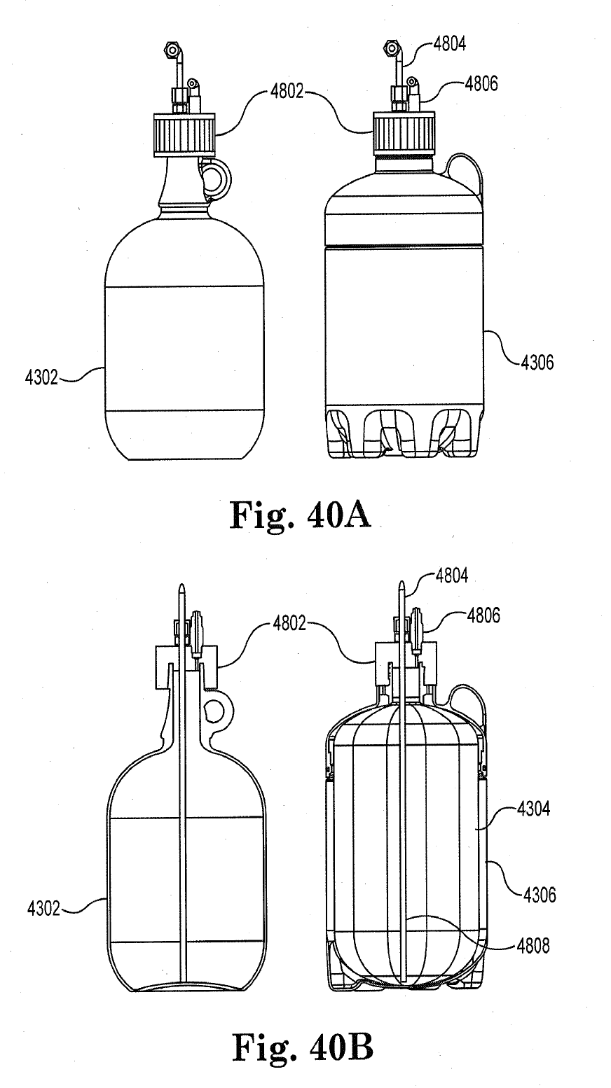

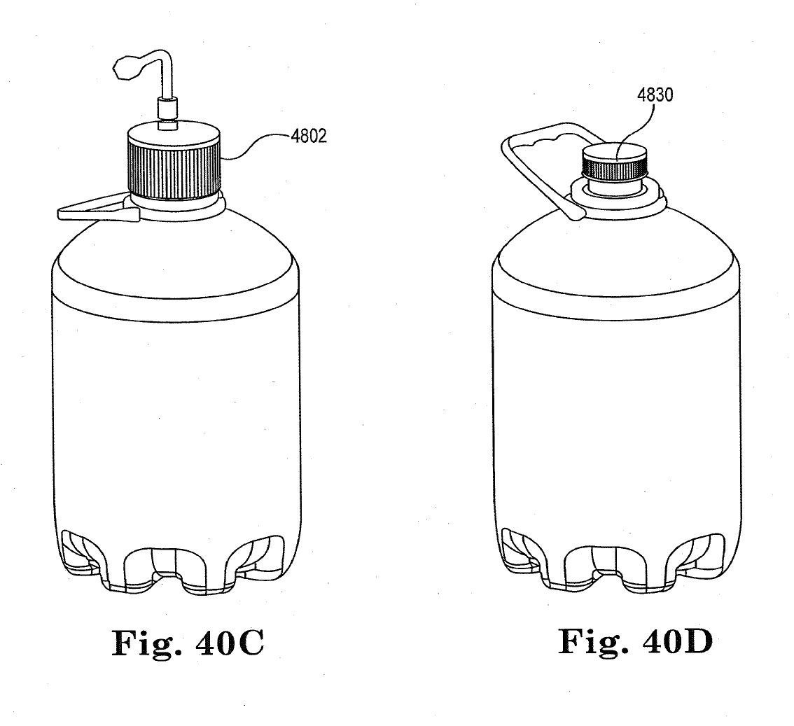

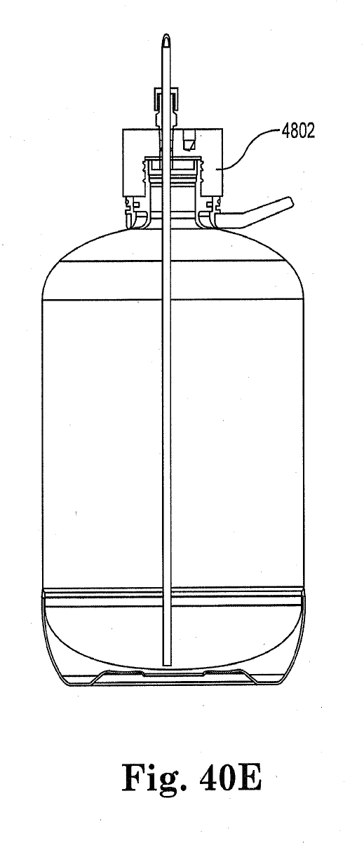

In one embodiment, the system 4300 may be used with existing pump dispense systems, as illustrated in FIGS. 40A and B. That is, the system 4300 may be configured to work with an existing pump dispense connector 4802, such as that typically used with conventional glass bottles. Such connector 4802 may include a liquid outlet 4804, for dispensing the contents of the liner 4304 using a pump, and a gas inlet 4806, for replacing the space within the liner left void by the emptying contents. In some embodiments, the liquid outlet 4804 may include, or have affixed thereto, a diptube 4808, similar to that discussed previously. As shown in FIGS. 40A and B, a conventional pump dispense connector 4802 may be used with system 4300 without or near without substantial modification. Further, FIG. 40C shows another embodiment of a liner-based system utilizing a connector 4802 configured for pump dispense, such as used in existing glass bottle systems. FIG. 40D shows a cap 4830 that may be used with the embodiment shown in FIG. 40C. However, as discussed above, the cap shown in FIG. 34D may provide better protection. After filling the liner-based system with the desired material, the cap 4830 may be affixed to the system. Prior to dispense, an end user may remove the cap 4830 and attach the connector 4802 for pump dispense. FIG. 40E shows a cross sectional view of a connector 4802 configured for pump dispense using existing pump dispense systems.

In some embodiments, the liner-based system 4840 may include a handle, such as handle 4842 illustrated in FIGS. 48F-J, discussed in detail above. As discussed above, in some embodiments the handle 4842 may be configured so as not extend beyond the circumference of the container 4846 when the handle is in a generally horizontal position; however, the handle 4842 may have one or more bulge areas, or expansion areas, 4854 that may be configured to generally straighten out when the handle 4842 is pulled generally vertically, or otherwise in use by the user.

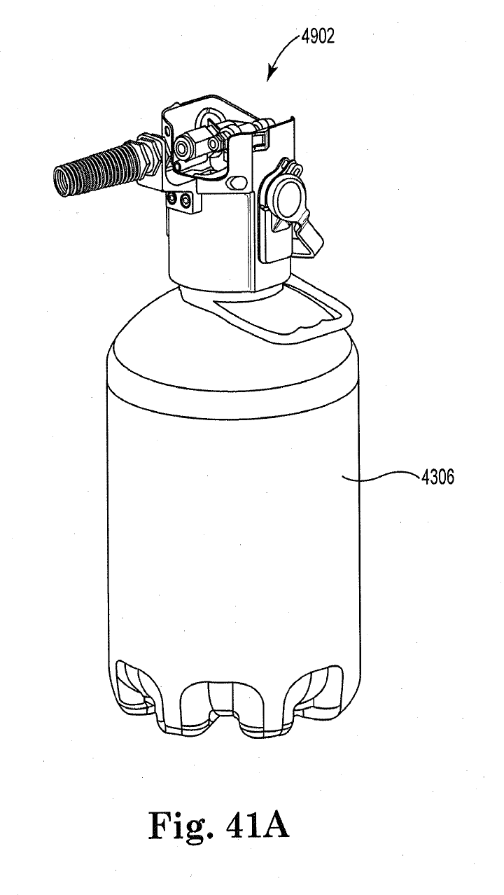

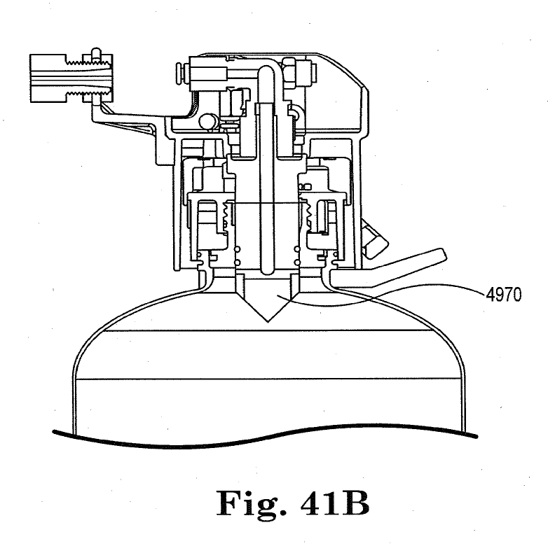

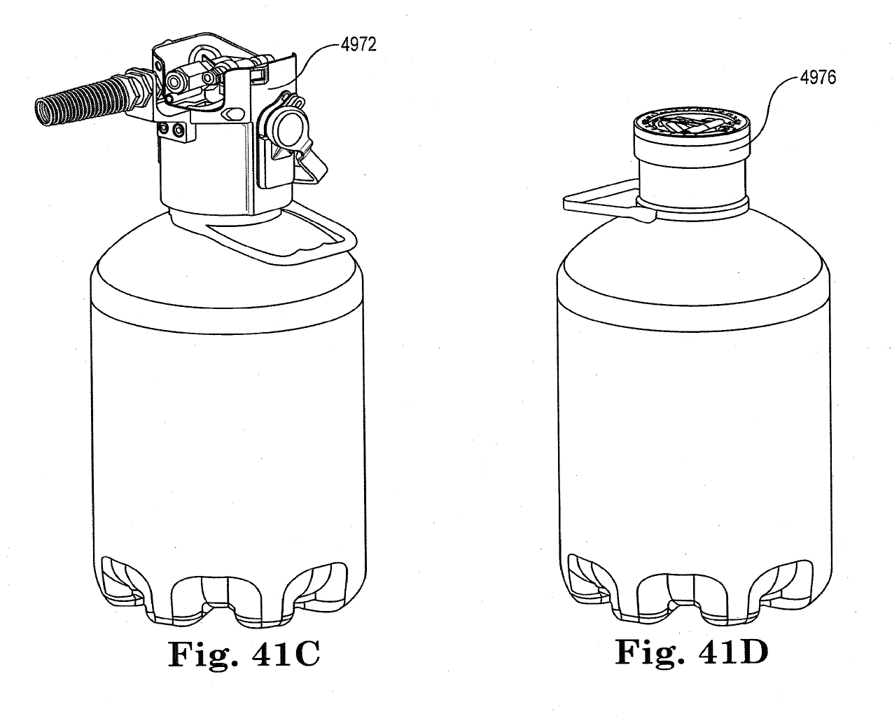

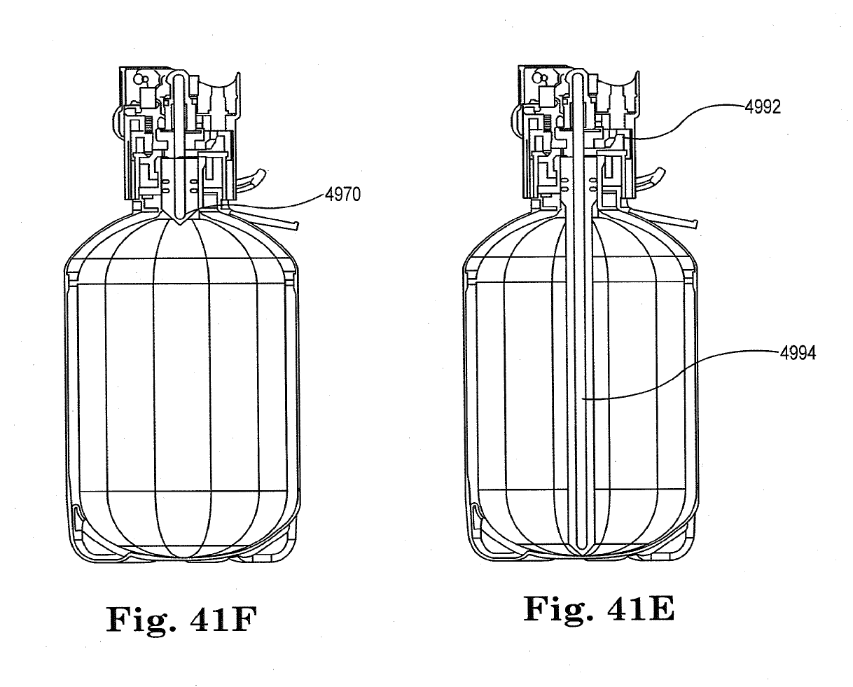

In further embodiments, the system 4300 may be used in pressure dispense systems. For example, the system 4300 may include a misconnect prevention closure as well as a misconnect prevention connector, such as those described above with reference to FIGS. 33D and E. Accordingly, as illustrated in FIG. 41A, the system 4300 may be configured such that it is compatible with the NOWPak® pressure dispense system 4902, such as that disclosed in U.S. patent application Ser. No. 11/915,996, the contents of which were previously incorporated by reference in their entirety herein. In some embodiments a coded lock cap and/or connector may be used in conjunction with one or more embodiments of a liner and/or overpack of the present disclosure. The coded lock, in some embodiments, may include a sleeve attached around a bottle opening that may be sealed by a cork plug, a screw-top, and a turning device, for example. A screwed opening may be formed at a location on the sleeve corresponding to the cork plug, and the screw-top may be screwed into the screwed opening of the sleeve to mask the cork plug of the bottle, for example. A cipher hole having a given profile may be disposed on the screw-top, and the turning device may be provided at an end thereof with a key that generally matches with the cipher hole. The screw-top may be turned to expose the cork plug only when the key of the turning device fully matches with the cipher hole on the screw-top. An example of such a coded lock cap and/or connector, as well as additional embodiments of coded lock caps and/or connectors, is described in greater detail in Chinese Patent No. ZL 200620004780.8, titled, “Coded Lock for Identifying a Bottled Medicament,” which was filed Mar. 3, 2006, which is hereby incorporated herein by reference in its entirety. In another embodiment, a misconnect prevention connector may be provided with punched key codes, RFID (Radio Frequency Identification) chips, or any other suitable mechanism or combination of mechanisms that may be used to prevent misconnection between a connector and the various embodiments of liners and/or overpacks described herein.

In yet another embodiment, a connector may or may also permit recirculation of the contents of the liner, which may be particularly useful for the recirculation of pressure sensitive or viscous materials. As stated above, the storage and dispensing systems of the present disclosure may be used for transporting and dispensing acids, solvents, bases, photoresists, dopants, inorganic, organic, and biological solutions, pharmaceuticals, and radioactive chemicals. Some of these types of materials may require recirculation while not being dispensed, otherwise they may become stale and unusable. As some of these materials can be very expensive, it can be desirable to keep the contents from becoming stale. Accordingly, in one embodiment, the connector may be used to recirculate the contents of the liner. A detailed description of embodiments of such a connector are provided in U.S. Provisional Patent Application No. 61/438,338, titled, “Connectors for Liner-Based Dispense Containers,” filed Feb. 1, 2011, which is hereby incorporated herein by reference in its entirety.

As also recognized above, another embodiment of a connector may include a dip tube that extends into the top or bottom of the container. In some embodiments, a dip tube may not extend the full vertical distance of the liner, but may rather extend some lesser distance. This is sometimes referred to as a “stubby probe.” One example of such a “stubby probe” is shown in FIG. 41B. Further, FIG. 41C shows another embodiment of a liner-based system utilizing a connector 4972 configured for pressure dispense. FIG. 41D shows a cap 4976 that may be used with the embodiment shown in FIG. 41C. After filling the liner-based system with the desired material, the cap 4976 may be affixed to the system, for example, by the chemical supplier. Prior to dispense, an end user may remove a tab on the cap 4976 and attach the connector 4972 to the cap for pressure dispense. Alternatively, as shown in FIG. 41E, a connector 4992 may be configured for pressure-assisted pump dispense. As such, the connector 4992 may also include a dip tube 4994 in order to allow the contents to be pumped out of the liner while at the same time, a gas or liquid may be introduced into the space between the liner and overpack in order to help collapse the liner during dispense. As discussed previously and as shown in FIG. 41F, a “stubby probe” or shortened dip tube 4970 may be used with connectors using pressure dispense.

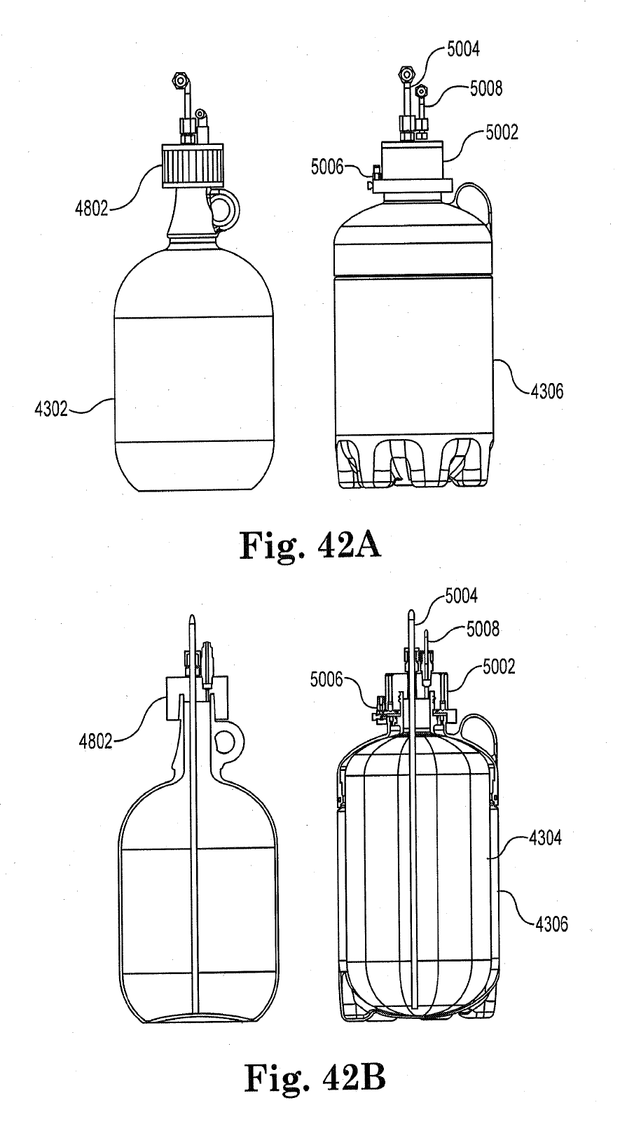

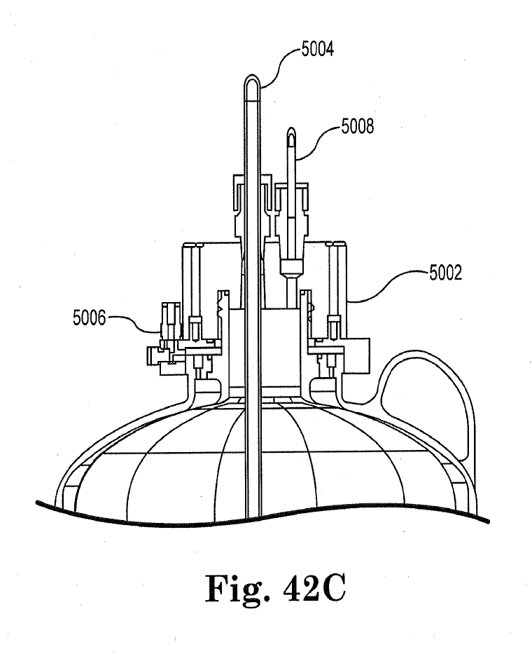

In alternative embodiments, illustrated in FIGS. 42A-C, a conventional pump dispense connector 4802 may be modified for use as a pressure dispense connector 5002, so that an existing glass bottle pump dispense system can generally easily accommodate the various embodiments of liner and overpack systems 4300 described herein. In other embodiments, it is recognized that a conventional pump dispense connector need not be required and modified, and that a pressure dispense connector 5002 may alternatively be custom manufactured. In one embodiment, the pressure dispense connector 5002 may use an existing or similar liquid outlet 5004 as that of pump dispense connector 4802. In addition, pressure dispense connector 5002 may include a gas inlet 5006 that provides a path for gas to enter the interstitial space between the overpack 4306 and the liner 4304, so as to provide pressure against the liner, thereby causing the liner to collapse and dispense the contents therefrom via the liquid outlet 5004. While shown relocated to the side of the connector 5004, the gas inlet 5006 may be positioned at any suitable location on the connector. The pump dispense connector 4802 gas inlet 4806 can be modified for use as a headspace gas outlet 5008, so that headspace in the liner 4304 can be removed. Head space may be removed through the headspace gas outlet 5008, which may include a tube or canal that leads into the liner, in some embodiments. Accordingly, the headspace in the liner may be removed or reduced by first pressurizing the annular space between the liner and the overpack via the gas outlet 5008 so that the liner begins to collapse, thereby forcing any excess gas out of the liner through the headspace gas outlet 5008. In some embodiments, it may take no more than about 3 psi to remove the headspace. Once the headspace gas is substantially removed, the contents of the liner may then be dispensed through the dispense port by either pressure dispense or pump dispense.

As discussed above, embodiments of liners disclosed herein may advantageously be used with existing pressure dispense systems, such as NOWPak® dispense systems, or alternately may be used with existing systems for dispensing from rigid glass bottles. Because some embodiments of containers disclosed herein can include neck sizes, or fitment sizes, that are configured to work with existing glass bottle systems, a modified connector, as shown in FIG. 43, may be configured so that existing pressure dispense connectors, such as NOWPak® dispense connectors, may also be used. As may be seen, the connector 5400 may have threading 5402 that is appropriately configured to mate with the fitment on embodiments of the container disclosed herein.

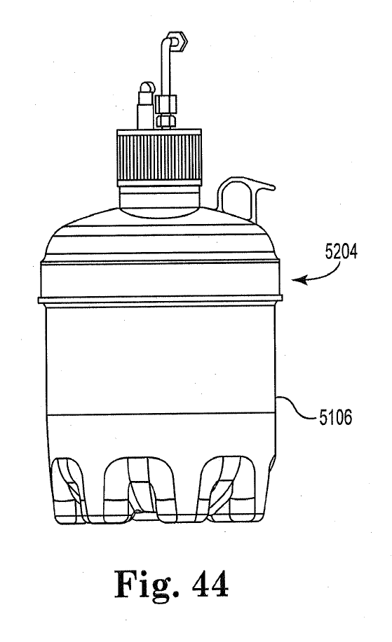

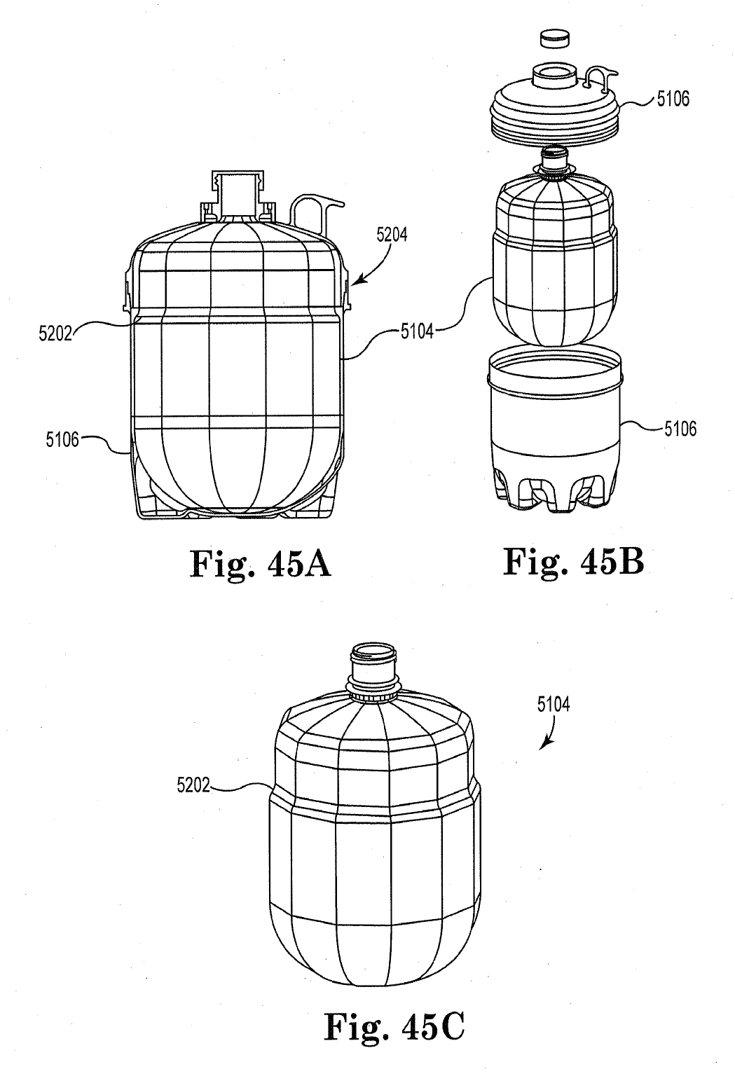

While discussed generally above as a replacement for conventional rigid-wall containers, such as glass wall containers, the above liner and overpack system may be sized and configured for use in any pump dispense or pressure dispense system. In some embodiments, as shown in FIGS. 44-45C, in order to fit a specific volume of contents in a specifically sized interconnecting overpack 5106, a liner 5104 may include one or more generally concentric girdles, or reducing areas 5202, such that the liner can generally conform to the interior wall of the overpack. In the case shown in FIGS. 45A-C, the liner 5104 includes a girdle or reducing area 5202 to accommodate for an increased width in the overpack where the interconnecting mechanism 5204 connects the bottom and top portions of the overpack 5106. It is recognized that other changes in the overpack 5106 can lead to similar changes to the liner 5104, so that the liner can generally conform to the interior wall of the overpack, thereby substantially maximizing the usable volume within the liner.

While various embodiments of a liner and overpack system have been described above, it is recognized that other embodiments exist. Appendix A, for example, provides further views of the embodiments described above, including views of a liner and overpack system superimposed over a conventional glass bottle, as well as other embodiments.

### Enhanced Flexible Liners

In some embodiments, any of the characteristics and or features of the liners described above may be implemented for a liner wherein the walls are substantially flexible. Such liners may be manufactured using any of the manufacturing processes disclosed herein. Such characteristics and or features, as already described above, can improve a liner's resistance to pin-holes, tears, fold gas, and choke-off, which are prevalent in conventional welded flexible liners.

### Choke-Off

As was noted above, choke-off may generally be described as what occurs when a liner necks and ultimately collapses on itself, or a structure internal to the liner, to form a choke point disposed above a substantial amount of liquid. When choke-off occurs, it may preclude complete utilization of the liquid disposed within the liner, which is a significant problem, as specialty chemical reagents utilized in industrial processes such as the manufacture of microelectronic device products can be extraordinarily expensive. A variety of ways of preventing or handling choke-off are described in PCT Application Number PCT/US08/52506, entitled, “Prevention Of Liner Choke-off In Liner-based Pressure Dispensation System,” with an international filing date of Jan. 30, 2008, which is hereby incorporated herein by reference in its entirety. Several additional systems and methods of choke-off prevention means are herein provided. Some choke-off systems and methods may apply to rigid collapsible liners, while other methods may apply to flexible liners, and still other methods may apply to any type of liner disclosed herein, or otherwise known in the art.

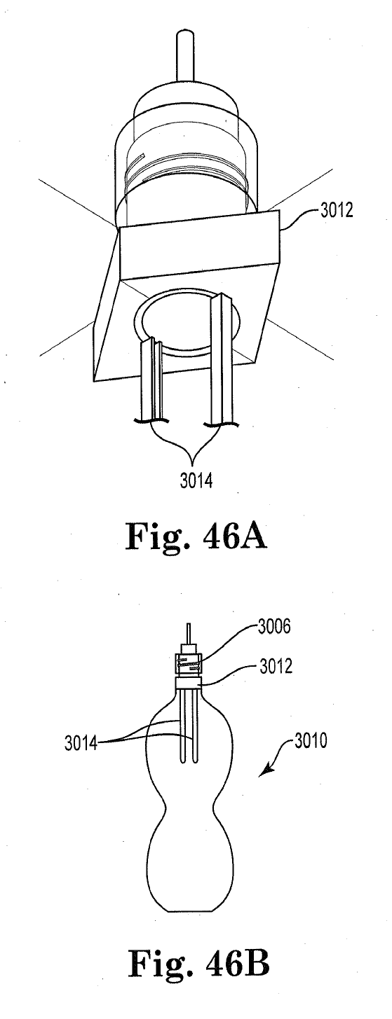

In some embodiments, choke-off may be eliminated or reduced by providing a channel insert inside the liner, as shown in FIGS. 46A and B. Providing a channel insert, such as that shown and described, as well as other suitable embodiments of the channel insert, may help to keep the liner from collapsing in on itself. Because the channels create a passageway that keeps the walls from fully meeting with one another, an opening for fluid to flow out of the liner may be provided that would otherwise be trapped. Channel insert 3014 may be integral with a connector 3012, which may be positioned in the mouth 3006 of the liner 3010, as described previously. In other embodiments, channel insert 3014 may be detachably secured to the connector 3012. Channel insert 3014, in some embodiments, may have a cross-section that is generally U-shaped. However, it is recognized that in other embodiments, the channel insert may have a cross-section that is generally V-shaped, zigzagged, curved, or any other suitable cross-sectional shape which creates a barrier to prevent the walls from fully meeting with one another and allows fluid, which would otherwise be trapped, to flow to the connector 3012. While the channel insert(s) shown in FIGS. 46A and B includes two channels, it will be appreciated by those skilled in the art that any other suitable number of channels, including but not limited to a single channel, is within the spirit and scope of the present disclosure. The channels may descend into the liner any distance sufficient to ameliorate the effects of choke-off, such as but not limited to, approximately ⅔ of the way down the liner, ½ of the way down the liner, ⅓ of the way down the liner, or any other suitable distance, which in some embodiments, may depend on the shape of the liner and/or the area or areas of the liner with the highest probability of being a choke-off area. In one embodiment, an advantage of using relatively shorter channel inserts is that they do not interfere so much with collapse of the liner, and thus may not greatly impede dispensation of fluid from the liner.

In an alternate embodiment to prevent choke-off during the delivery of material from a liner using pressure dispense, one or more high-purity polymer structures in the shape of a hollow sphere may be welded to the interior of the liner to prevent choke-off and increase dispense. Because the structure may be hollow, the contents of the liner may still flow through the liner of the hollow sphere, thereby preventing complete choke-off.

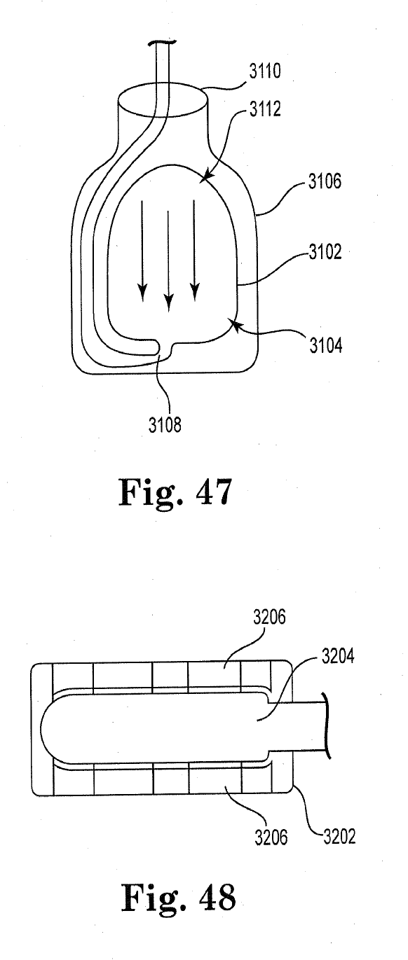

In other embodiments gravity may be used to help dispense the contents of a liner. As shown in FIG. 47, a liner 3102 may be inserted into an overpack 3106. The liner may have a delivery tube that in some embodiments may be a rigid delivery tube 3108 made of, for example, any suitable plastic or other material or combination of materials. The liner may be positioned in the overpack 3106 such that the delivery tube end of the liner 3104 is positioned at the bottom of the overpack and the closed end of the liner 3112 is positioned toward the top of the overpack 3106 when the liner is filled. The delivery tube 3108 may extend from the delivery tube end of the liner 3104 to and through the mouth 3110 of the overpack 3106. Upon dispense, the contents of the liner will drain from the bottom of the liner 3112 first. During, for example, pressure or pump dispense, the liquid in the liner 3102 will move downward toward the dispense tube 3108. Due to the force of gravity, the liquid may dispense through the dispense tube 3108 without creating creases or folds that may trap the liquid.

In another embodiment, a liner and overpack system may use a dispense method that includes pumping a liquid that is heavier than the contents of the liner into the area between the overpack and the liner. The buoyancy of the contents of the liner created by the liquid outside of the liner being heavier may lift the liner and collapse the bottom of the liner which may help the dispense process.

In yet another embodiment, as seen in FIG. 48, a liner 3204 may be inserted into an overpack 3202. The overpack 3202 may also contain one or more bladders 3206. The bladders 3206 may be made of an elastomeric material in some embodiments, while in other embodiments the bladders 3206 may be made of any suitable material. The bladders 3206 may be inflated by a pump for example such that when they inflate they press on the liner to uniformly collapse the liner. In some embodiments, the bladder 3206 may be a serpentine like bladder that inflates in a generally coil-like way to press the contents of the liner out. In other embodiments, the bladders 3206 may be coupled to an elastic or spring-like device to ensure that the bladders inflate at substantially the same rate.

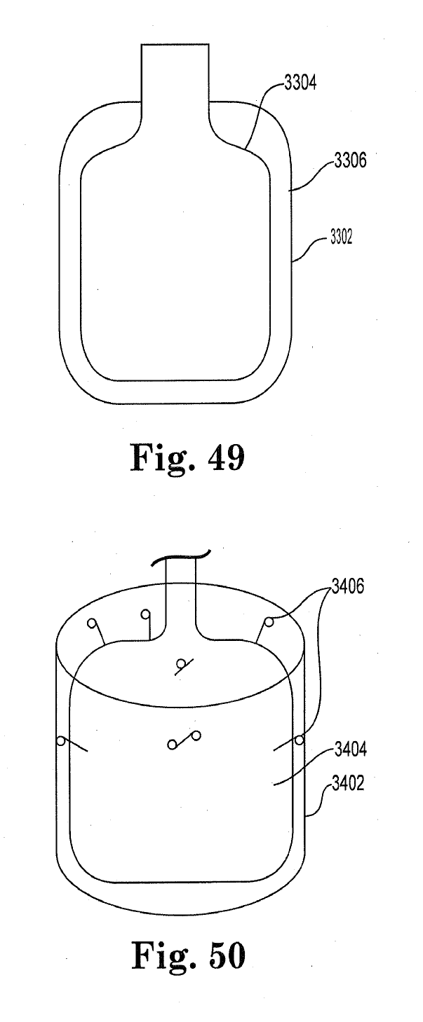

In another embodiment shown in FIG. 49, a liner 3304 may be placed within an overpack 3302 that is comprised of an elastic balloon-like material. A relatively small amount of a lubricating fluid 3306, for example water or saline or any other suitable liquid may be included between the overpack 3302 wall and the liner 3304 wall. Upon pump dispense, for instance, the elastic overpack walls will collapse substantially evenly thereby helping to minimize creases or folds forming in the liner.

In another embodiment shown in FIG. 50, a liner 3403 may be suspended in an overpack 3402. The liner may be suspended by any suitable means, such as by hooks or any other connective means 3406. Anchoring the top of the liner 3404 in such a manner to the top of the overpack 3402 at a plurality of points may limit how much the sides of the liner can collapse. The liner may be suspended by any number of points including one, two, three, four or more points.

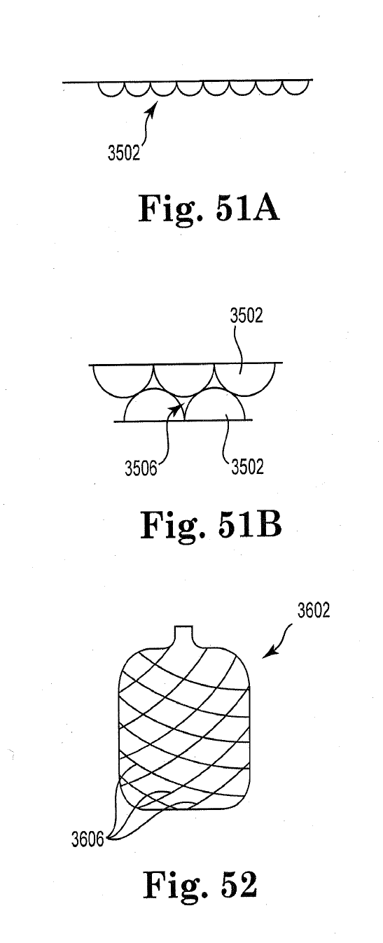

In another embodiment, the surface of the inside of the liner may be comprised of a textured surface 3502 as shown in FIGS. 51A and B. When the liner collapses, dispense channels 3506 may form between the textured surfaces 3502 of the liner such that liquid may still be able to flow through areas where the sides of the liner may have collapsed upon itself, thus increasing dispensability.

In still another embodiment, as shown in FIG. 52, a liner 3602 may comprise a number of folds formed in a criss-crossing-like manner such that when the liquid contents of the liner are dispensed, the liner may twist along the folds, thus increasing dispensability. The number of folds may be any appropriate number.

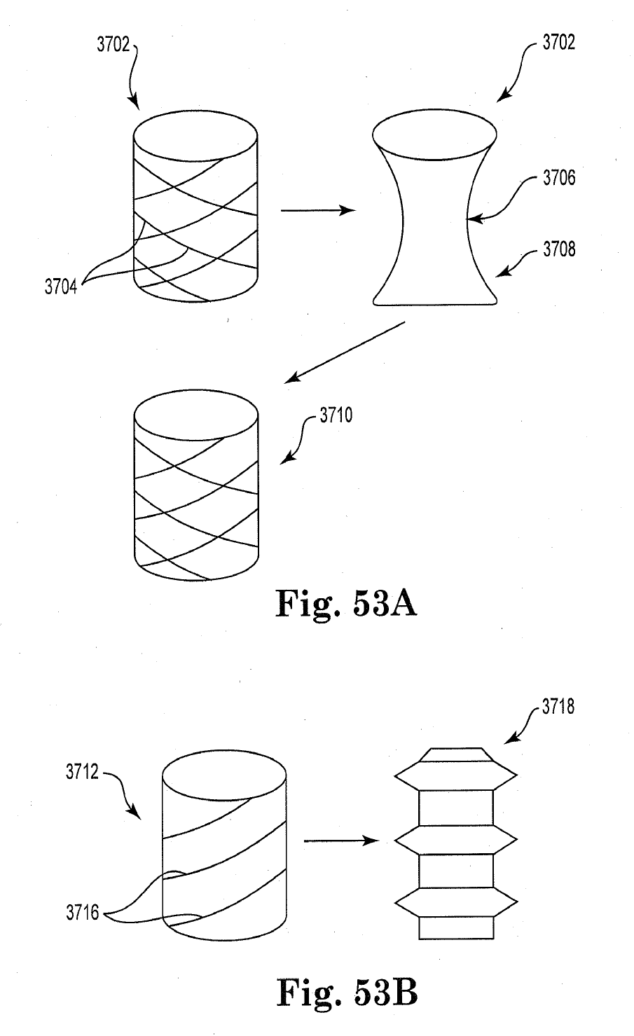

In another embodiment, as shown in FIGS. 53A and B, a liner 3702 may include an external elastomeric mesh 3704 that may help to adjust the collapse points of the liner 3702 upon dispense. As may be seen in FIG. 53A, in one embodiment, when the liner is subjected to either pump or pressure dispense the force of the elastomeric mesh 3704 on the liner 3702 may collapse the liner 3702 inward at different points 3706 due to the pressure applied by the dispensing action. The portions that are briefly pulled inward 3706 may cause the non-inward moving parts 3708 of the liner to stretch more. The liner 3702 will naturally become balanced again 3710 by the stretched parts of the liner returning to their relaxed state 3710. Such movement of the liner 3702 upon dispense may help the contents of the liner 3702 to be dispensed more quickly and/or more completely. FIG. 53B shows another embodiment of a liner 3712 using elastomeric mesh 3716, whereupon when pressure is applied during dispense, the liner 3712 may expand 3718 and contract in a substantially uniform manner.

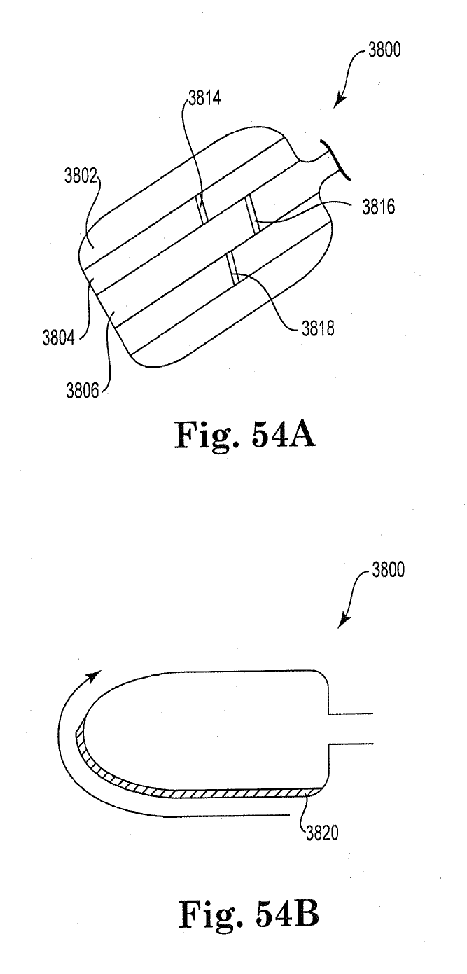

In yet another embodiment, a shape memory polymer may be used to direct liner collapse upon dispense to help prevent choke-off, as may be seen in FIGS. 54A and B. For example, a shape memory polymer may be used as at least one side of the liner 3800 or attached to at least one side of the liner. The memory shape may be applied to the liner, for example, in strips 3802, 3804, 3806, in some embodiments. The strips 3802, 3804, 3806 may be kept separated by, for example, rigid spacers 3814, 3816, 3818. The shape memory polymer 3820 may cause the liner 3800 to coil up upon dispense, as shown in FIG. 54B, much like a party whistle curls up when a user blows air into it.

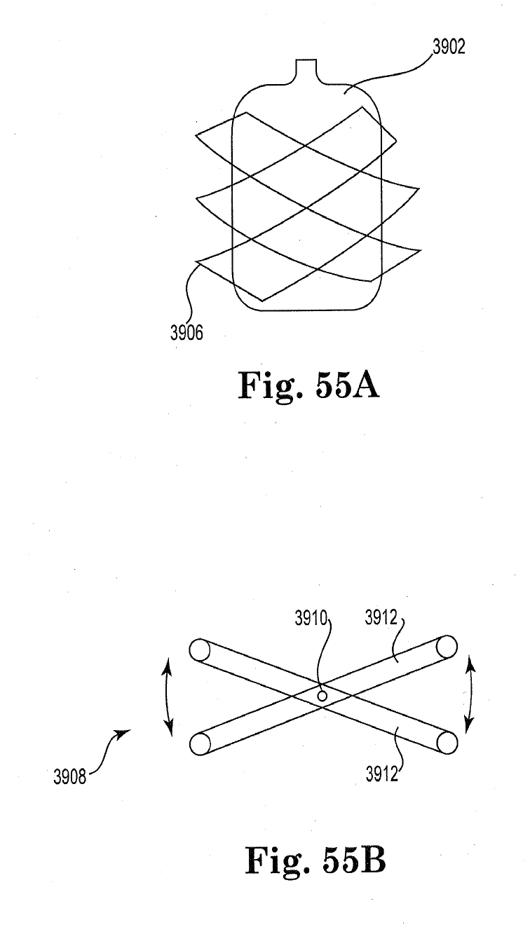

In another embodiment, shown in FIG. 55A, an external framework, similar to a hoberman sphere, may be used to control the shape of the liner upon dispense in order to, for example, help prevent choke-off. A hoberman sphere is capable of folding down to a fraction of its normal size by the scissor-like action of its joints. Such a framework 3906 may help the liner 3902 collapse in a pre-determined way that avoids choke-off. As may be seen in FIG. 55B, each lattice 3908 of the framework 3906 may comprise a pivot 3910 that allows the arms 3912 of the lattice 3908 to move closer or further away from one another. In a framework 3906, the lattices may all work together, similar to a hoberman sphere to direct collapse during dispense. In some embodiments a flexible tether may also be used.

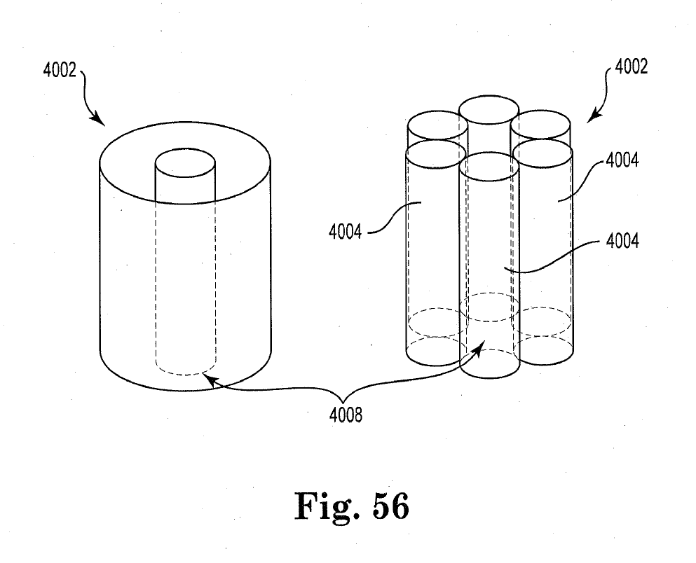

FIG. 56 shows another embodiment of a liner 4002 that may help limit or eliminate choke-off. As may be seen, the liner 4002 may comprise a plurality of interconnected tubes. The tubes 4004 may be connected in such a manner as to allow the contents of the liner to flow freely between the tubes 4004. The inner wall of the liner 4002, in some embodiments, may be comprised of an elastomere that may inflate during dispense. As shown, the center of the liner 4002 may be hollow. In some embodiments, the pressure applied to the liner 4002 during dispense may prevent the center hollow tube 4002 from deformation and thus help stabilize the liner 4002 from collapse and choke-off.

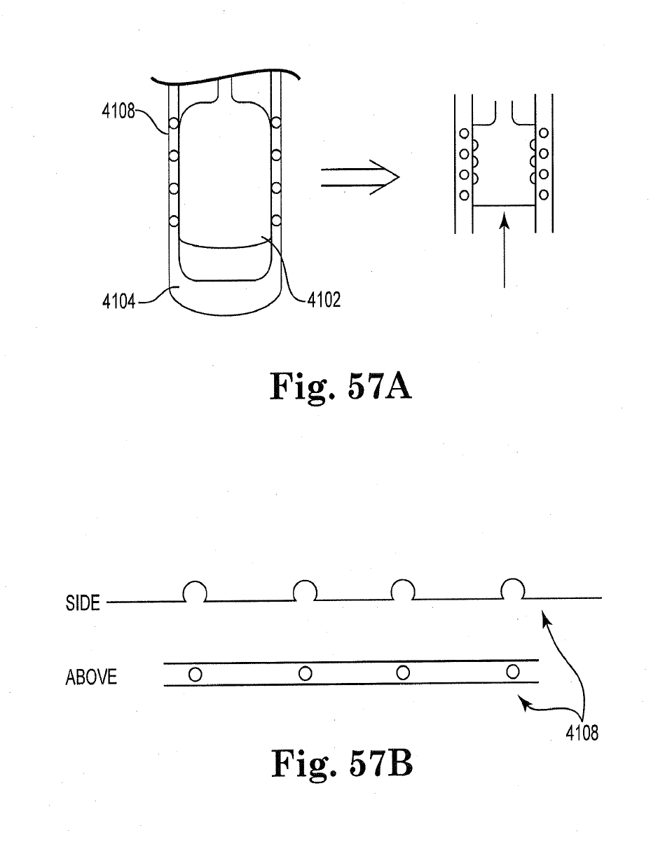

In another embodiment, shown in FIGS. 57A and B, slide point rails 4108 may be used to secure portions of the side of a liner 4102 to an overpack 4104, thereby keeping the liner 4102 from collapsing in upon itself during dispense. FIG. 57B shows a view of the slide point rails from the side and from above. The liner 4102 may have nubs that fit into channels in the rails 4108 of the overpack 4104. As the contents of the liner are dispensed the liner 4102 may be pushed upward, but the walls of the liner 4102 may stay attached to the walls of the overpack 4104.

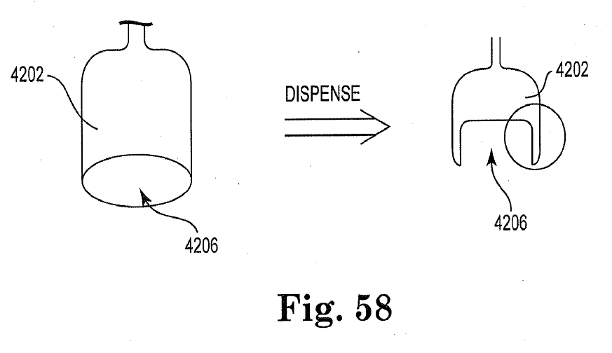

As may be seen in FIG. 58, another embodiment for helping to limit or eliminate choke-off may include an integrated piston. In such an embodiment, a liner 4202 may include a bottom 4206 that may be more rigid than the sides of the liner. Accordingly, upon dispense the liner walls may be prevented from collapsing toward one another because the rigidity of the bottom 4206 of the liner 4202 may act as a piston keeping the walls apart.

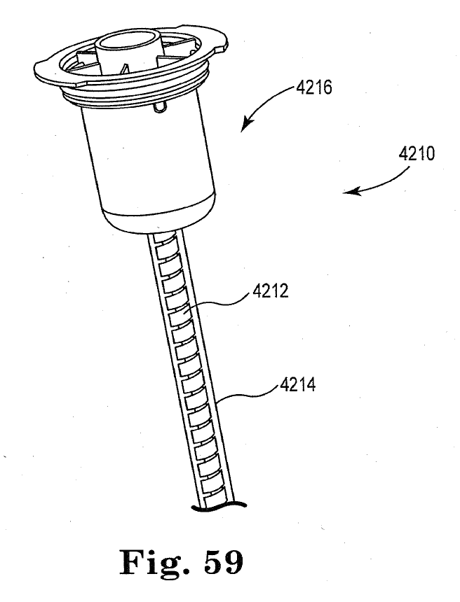

In addition, in some embodiments, choke-off may be eliminated or reduced by providing a choke-off preventer as shown in FIG. 59. The choke-off preventer 4210 may be configured to be operably secured to existing liner fitments and/or special adaptors for use in coupling the choke-off preventer to the liner fitment or the dispense connectors. The preventer 4210 may include a flexible, generally spiral-shaped wrap tube 4212 comprised of any chemically compatible material, for example PE, PFA, or any other suitable material or combination of materials. In some embodiments, the preventer 4210 may also include a sheath 4214 that may surround the wrap tube 4212. As with the wrap tube 4212, the sheath 4214 may be comprised of any chemically compatible material. The wrap tube 4212 may be comprised of the same material as or a different material than the sheath 4214. The preventer head 4216 may be inserted into the fitment of the liner, while the wrap tube 4212 and/or sheath 4214 may extend any suitable distance into the liner itself. The spiral wrap tube 4212 may help keep a channel open as the liner collapses during dispense to ensure a continuous flow of material. Because the preventer 4210 may work in part due to its vertical positioning in the liner and also due to gravity, in some embodiments, the preventer 4210 may have a flexible wrap tube 4212 to ensure the proper positioning of the preventer 4210. Further, in some embodiments, the preventer 4210 may be disposable and configured for a one-time use. In some embodiments, the preventer 4210 may also be used repeatedly.

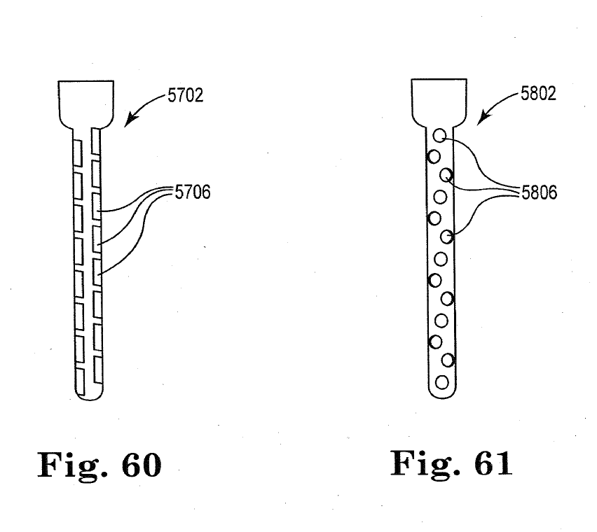

In another embodiment, as shown in FIGS. 60 and 61, an elongated tube 5702, 5802 may extend into a liner to assist in preventing choke-off. The tube 5702, 5802 may have any geometry, including being substantially cylindrical, or any other shape. In some embodiments, the tube 5702, 5802 may have a plurality of holes 5706, 5806 cut into the body of the tube 5702, 5802. As may be seen in FIG. 60, in one embodiment, the holes 5706 may be arranged in columns, for example, thereby forming longitudinal ribs in the side wall of the tube 5702. In another embodiment, shown in FIG. 61, the holes 5806 may be offset, in a pattern or randomly, relative to one another. The holes 5706 may be rectangular as shown in FIG. 60, for example, or the holes 5806 may be circular as shown in FIG. 61, for example. In other embodiments, the holes may have any suitable geometry, including holes with varying geometries. The tube may extend any suitable distance into the liner and may be comprised of any suitable material or combination of materials including, but not limited to, plastic, metal, or glass. Further such choke-off prevention tubes are disclosed and described in greater detail, for example, in U.S. patent application Ser. No. 11/285,404, titled “Depletion Device for Bag in Box Containing Viscous Liquid,” filed Nov. 22, 2005, which is hereby incorporated herein by reference in its entirety.

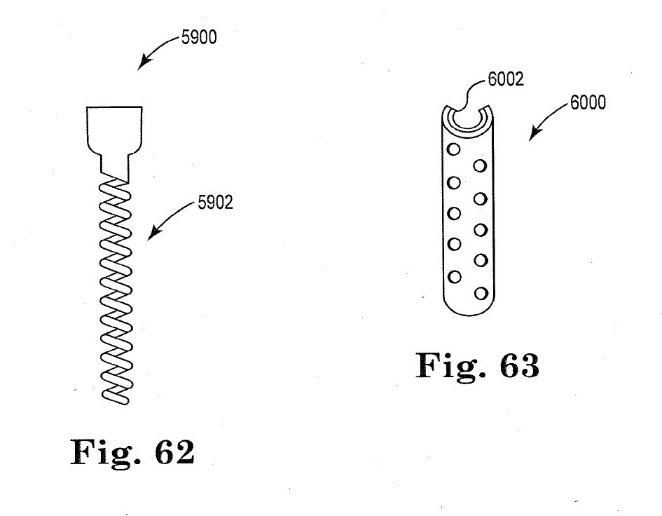

In another embodiment, as shown in FIG. 62, a tube 5900 may be inserted into a liner. The body 5902 of the tube may have a spiraled, spring-like, or coiled shape, for example, in order to prevent or reduce choke-off. Tubes of this type are further disclosed and described, for example, in U.S. Pat. No. 4,138,036, titled “Helical Coil Tube-Form Insert for Flexible Bags,” filed Aug. 29, 1977, which is hereby incorporated herein by reference in its entirety.

In yet another embodiment, choke-off may be reduced or prevented by inserting a tube into a liner, wherein the tube may have a plurality of spring members that connect the fitment of the liner to the tube. In some embodiments, the tube may be similar to the tubes shown in FIG. 60, 61, or 62, for example. Tubes of this type are further disclosed in greater detail, for example, in U.S. Pat. No. 7,004,209, titled “Flexible Mounting for Evacuation Channel,” filed Jun. 10, 2003, which is hereby incorporated herein by reference in its entirety.

Another method for preventing choke-off in some embodiments may be seen in FIG. 63, which shows a cross-section of a contractible layer 6000 that may be attached to a surface of a liner. A contractible layer 6000 may attach to the inner wall of a liner, for example. The contractible layer 6000 in some embodiments may be comprised of a laminate 6002 of two dissimilar materials. For example, one material may be non-hygroscopic and the other material may be hygroscopic. When moisture or liquid is introduced into the liner, the hygroscopic layer of the contractible layer 6000 may expand causing the contractible layer 6000 to generally curl and form a thick tube that may prevent the liner from chocking-off during dispense. Further such apparatus are described, for example, in U.S. Pat. No. 4,524,458, titled “Moisture Responsive Stiffening Members for Flexible Containers,” filed Nov. 25, 1983, which is hereby incorporated herein in its entirety.

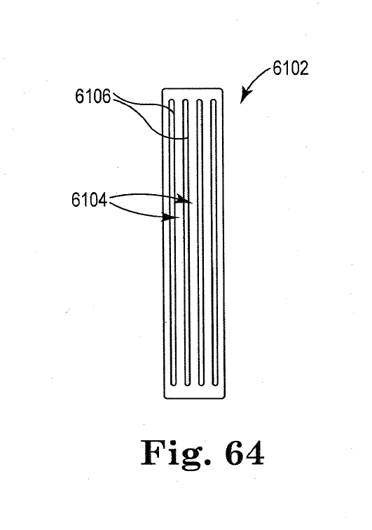

In other embodiments, a strip may be fixedly or detachably attached, or in other embodiments may be integral with a liner, in order to help prevent choke-off. As may be seen in FIG. 64, a strip 6102 may have a plurality of channels, which will also necessarily form a corresponding plurality of raised portions 6106. The strip 6102 may be formed of any suitable material, or combination of materials including the same material as the liner, or a different material than the liner. The strip 6102 may be comprised of one or more layers and/or one or more materials. The one or more strips 6102 may be positioned inside of the liner, for example, and/or attached to the fitment, in some embodiments. Such strips are further disclosed in U.S. Pat. No. 4,601,410, titled “Collapsed Bag with Evacuation Channel Form Unit,” filed Dec. 14, 1984, which is hereby incorporated herein in its entirety. Alternately, one or more strips 6102 may be affixed to the exterior surface of the liner film, such that the film conforms to the generally ridged shape of the strip 6102. Such strips are further disclosed in U.S. Pat. No. 4,893,731, titled “Collapsible Bag with Evacuation Passageway and Method for Making the Same,” filed Dec. 20, 1988, which is hereby incorporated herein by reference in its entirety. In still another embodiment, the strip 6102 may be integral with the film of the liner, examples of which are further described in detail in U.S. Pat. No. 5,749,493, titled “Conduit Member for Collapsible Container,” filed Nov. 10, 1987, which is hereby incorporated herein by reference in its entirety.

In some embodiments, the strip 6102 may be sized such that the strip 6102 may be attached, for example, but not limited to, by welding to the top and/or bottom of the liner. For example, the strip 6102 may be welded into the weld lines of the liner at the top and/or bottom of the liner. Examples of such strips according to this embodiment are further disclosed in detail in U.S. Pat. No. 5,915,596, titled “A Disposable Liquid Containing and Dispensing Package and Method for its Manufacture,” filed Sep. 9, 1997, which is hereby incorporated herein in its entirety. The strip 6102 may be placed at any suitable position relative to or integral with the liner. For example, in some embodiments, the strip 6102 may be located centrally or off-center. In other embodiments, the strip 6102 may be attached to the liner but may be relatively distant from the liner fitment. Suitable placements for the strip 6102 are further described in detail, for example, in U.S. Pat. No. 6,073,807, titled “Flexible Container with Evacuation From Insert,” filed Nov. 18, 1998, and U.S. Pat. No. 6,045,006, titled “Disposable Liquid Containing and Dispensing Package and an Apparatus for its Manufacture,” filed Jun. 2, 1998, each of which is hereby incorporated herein in its entirety.

In some embodiments, the skirt portion of the liner fitment may also have channels to further reduce choke-off. Examples of such types of channels in the skirt portion are further described, for example, in U.S. Pat. No. 6,179,173, titled “Bib Spout with Evacuation Channels,” filed Oct. 30, 1998, and U.S. Pat. No. 7,357,276, titled “Collapsible Bag for Dispensing Liquids and Methods,” filed Feb. 1, 2005, each of which is hereby incorporated herein by reference in its entirety. In some embodiments, a liner may be made by a process wherein a strip may be advanced by a machine or a person a predetermined length during the manufacturing of the liner, such that a liner may be formed that may include an inserted strip. An example of such a process is described in further detail in U.S. Pat. No. 6,027,438, titled “Method and Apparatus for Manufacturing a Fluid Pouch,” filed Mar. 13, 1998, which is hereby incorporated herein by reference in its entirety.

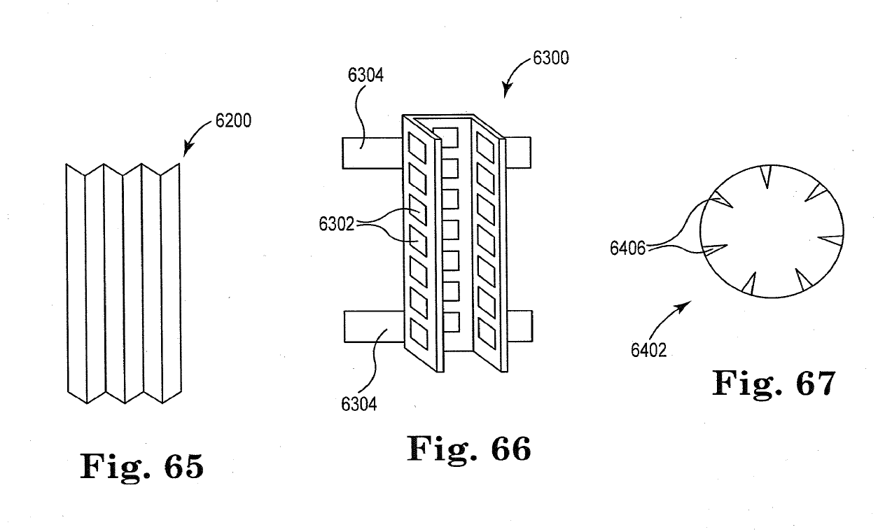

Another method for reducing or preventing chock-off may include, in some embodiments, inserting a corrugated rigid insert 6200, as shown in FIG. 65, into a liner. In some embodiments, the width of the corrugated rigid insert 6200 can be up to substantially the same width as that of the liner. In another embodiment, the insert 6300 may be relatively more narrow than the width of the liner, as shown for example in FIG. 66. In some cases, such as shown in FIG. 66, the insert 6300 may be generally U-shaped, but in other cases, the insert 6300 may have any suitable geometry, for example, but not limited to a C-shape, H-shape, or any other suitable shape. The insert 6300 may also be perforated 6302, in some embodiments. Because the insert 6300 may be narrower than the liner in some embodiments, the insert 6300 may include one or more arms 6304 that may be generally the same width as the liner in order to support the insert 6300 in the liner. In another embodiment, shown in FIG. 67, a liner 6402 may have integral vertical ribs 6406 on the interior surface of the liner to help reduce or prevent choke-off when the liner is collapsed. Further such inserts are described in detail in U.S. Pat. No. 2,891,700, titled “Collapsible Containers,” filed Nov. 19, 1956, which is hereby incorporated herein by reference in its entirety.

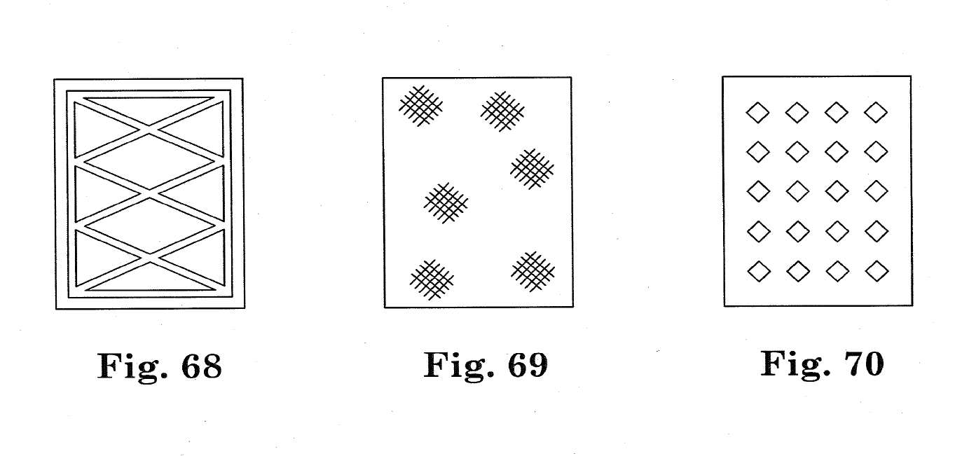

In other embodiments, choke-off may be prevented by altering the surface structure of the film of the liner. For example, FIGS. 68-70 illustrate a variety of different patterns that may be applied to the interior surface of a liner. In some embodiments, the structures may comprise integrated grooves, such grooves being further described, for example, in U.S. Pat. No. 7,017,781, titled “Collapsible Container for Liquids,” filed Aug. 2, 2005, which is hereby incorporated herein in its entirety. Alternately, the structure may comprise a plurality of features on the interior surface of the liner that may define a plurality of pathways by which the contents of the liner may flow, such pathways being further described in detail, for example, in U.S. Pat. No. 6,715,644, titled “Flexible Plastic Container,” filed Dec. 21, 2001, which is hereby incorporated herein by reference in its entirety. Features or structures may be incorporated into the liner film by, for example, mechanically or ultrasonically embossing the features into the film or by using bubble cushion, sealed pleats or accordion folds, for example. Integral features according to such embodiments are further described, for example, in U.S. Pat. No. 6,607,097, titled “Collapsible Bag for Dispensing Liquids and Method,” filed Mar. 25, 2002, and U.S. Pat. No. 6,851,579, titled “Collapsible Bag for Dispensing Liquids and Method,” filed Jun. 26, 2003, each of which is hereby incorporated herein by reference in its entirety. Surface features including protrusions may be formed on the surface of the liner in some embodiments by molding and quenching heat sealable resins. Features formed according to such embodiments are further disclosed in detail, for example, in U.S. Pat. No. 6,984,278, titled “Method for Texturing a Film,” filed Jan. 8, 2002, and U.S. Pat. No. 7,022,058, titled “Method for Preparing Air Channel-Equipped Film for Use in Vacuum Package,” filed Jun. 26, 2002, each of which is hereby incorporated herein in its entirety.

### Further Enhancements

Further enhancements to substantially rigid collapsible liners, container and/or liners for replacing glass bottles, and/or flexible gusseted or non-gusseted liners are provided below. Some embodiments may include one or more enhancements provided below and may also include one or more enhancements or other features provided elsewhere in this disclosure.

In some embodiments, the exterior and/or interior walls of the liner and/or overpack may have any suitable coating provided thereon. The coating may increase material compatibility, decrease permeability, increase strength, increase pinhole resistance, increase stability, provide anti-static capabilities or otherwise reduce static, etc. Such coatings can include coatings of polymers or plastic, metal, glass, adhesives, etc. and may be applied during the manufacturing process by, for example coating a preform used in blow-molding, or may be applied post manufacturing, such as by spraying, dipping, filling, etc.

The storage and dispensing systems of the present disclosure may include one or more ports, which may be used for the processes of filling and dispensing, and may include, for example: a liquid/gas inlet port to allow a liquid or gas to enter the packaging system; a vent outlet; a liquid/gas outlet; and/or a dispense port to permit the contents of the liner to be accessed. The ports may be provided at any suitable location. In one embodiment, the ports may be provided generally at or near the top of the liner and/or overpack. In a further embodiment, the storage and dispense assembly may include a septum which may be positioned in or adjacent a connector (such as those described above) and may seal the assembly thereby securely containing any substance therein. In some embodiments any or all of the ports and/or septum may be sterilized or aseptic.

In addition to features and structures already described above, in other embodiments, assemblies of the present disclosure or one or more components thereof may include other shaped structures or features, such as honeycomb structures or features in the walls of the liner and/or overpack that can be used to control the collapsing pattern of the liner and/or overpack or one or more components thereof. In one embodiment, such structures (e.g., folds, honeycombs, etc.) may be used to control collapse of the liner and/or overpack, such that it collapses radially, without substantially collapsing vertically.

In some embodiments, one or more colors and/or absorbant materials may be added to the materials of the liner and/or overpack or one or more components thereof, such as a container, bottle, overpack, or liner, during or after the manufacturing process to help protect the contents of the assembly from the external environment, to decorate the assembly or to use as an indicator or identifier of the contents within the liner and/or overpack or otherwise to differentiate multiple assemblies, etc. Colors may be added using, for example, dyes, pigments, nanoparticles, or any other suitable mechanism. Absorbant materials may include materials that absorb ultraviolet light, infrared light, and/or radio frequency signals, etc. For example, in one embodiment, the liner and/or overpack may be substantially impervious to UV light. For example, in some embodiments, the liner and/or overpack may block up to about 99.9% of UV light for about 190 nm wavelength to about 425 nm wavelength. In other embodiments, the liner and/or overpack may have any other suitable degree of opaqueness, for example, so as to achieve a desired level of UV blockage.

The liners and/or overpacks described herein may be configured as any suitable shape, including but not limited to square, rectangular, triangular or pyramidal, cylindrical, or any other suitable polygon or other shape. Differently shaped liners and/or overpacks can improve packing density during storage and/or transportation, and may reduce overall transportation costs. Additionally, differently shaped liners and/or overpacks can be used to differentiate assemblies from one another, such as to provide an indicator of the contents provided within the liner and/or overpack or to identify for which application or applications the contents are to be used, etc. In still further embodiments, the liners and/or overpacks described herein may be configured as any suitable shape in order to “retrofit” the storage and dispensing systems of the present disclosure with existing dispense systems.

Additionally, some embodiments of liners and/or overpacks may include a base or chime component or portion. The chime portion may be an integrated or separate portion or component of the liner and/or overpack, and may be removable or detachable in some embodiments. In regard to chimes that are separate components, the chime may be attached by any suitable means, including snap-fit, bayonet-fit, friction-fit, adhesive, rivets, screws, etc. Some example chime embodiments are described and/or illustrated in U.S. Prov. Appl. No. 61/448,172, titled “Nested Blow Molded Liner and Overpack,” filed Mar. 1, 2011, which were previously incorporated herein. The chime may be any suitable size and shape, and may be made from any suitable material, such as the materials described herein. In some embodiments, the chime may be configured to enhance or add stability to the system for stacking, shipping, strength (e.g., structurally), weight, safety, etc. For example, a chime may include one or more interlocking or mating features or structures that is configured to interlock or mate with a complementary feature of an adjacent container, either vertically or horizontally, for example. As described for example in U.S. Prov. Appl. No. 61/448,172, titled “Nested Blow Molded Liner and Overpack,” filed Mar. 1, 2011, which were previously incorporated herein, a packaging system or one or more components thereof may include a generally rounded or substantially rounded bottom. A rounded bottom can help increase dispensability of the contents therein, particularly in pump dispense applications. A chime may be used to provide support for such packaging systems. In some embodiments a chime may be used with a liner without an overpack. In such an embodiment, the chime may help provide stability to, for example, a rigid collapsible liner and may, in some cases, be dispensed by pump dispense.

In some embodiments, the liners and/or overpacks described herein may include symbols and/or writing that is molded into the liner and/or overpack or one or more components thereof. Such symbols and/or writing may include, but is not limited to names, logos, instructions, warnings, etc. Such molding may be done during or after the manufacturing process of the liner and/or overpack. In one embodiment, such molding may be readily accomplished during the fabrication process by, for example, embossing the mold for the liner and/or overpack. The molded symbols and/or writing may be used, for example, to differentiate products.

Similarly, in some embodiments, the assembly or one or more components thereof may be provided with different textures or finishes. As with color and molded symbols and/or writing, the different textures or finishes may be used to differentiate products, to provide an indicator of the contents provided within the assembly, or to identify for which application or applications the contents are to be used, etc. In one embodiment, the texture or finish may be designed to be a substantially non-slip texture or finish or the like, and including or adding such a texture or finish to the assembly or one or more components thereof may help improve graspability or handling of the assembly or components thereof, and thereby reduce or minimize the risk of dropping of the assembly. The texture or finish may be readily accomplished during the fabrication process by, for example, providing a mold for the liner and/or overpack, for example with the appropriate surface features. In other embodiments, the molded liner and/or overpack may be coated with the texture or finish. In some embodiments, the texture or finish may be provided on substantially the entire liner and/or overpack or substantially the entirety of one or more components thereof. However, in other embodiments, the texture or finish may be provided on only a portion of the liner and/or overpack or a portion of one or more components thereof.

In some embodiments, the interior walls of the liner and/or overpack may be provided with certain surface features, textures, or finishes. In embodiments wherein the assembly comprises an overpack and liner, or multiple liners, etc., the interior surface features, textures, or finishes of the overpack, or one or more of the liners, may reduce adhesion between the overpack and liner, or between two liners. Such interior surface features, textures, or finishes can also lead to enhanced dispensability, minimized adhesion of certain materials to the surface of the overpack or liner(s), etc. by controlling, for example, the surface hydrophobicity or hydrophilicity.

In some embodiments, the assembly may include one or more handles. The one or more handles can be of any shape or size, and may be located at any suitable position of the assembly. Types of handles can include, but are not limited to, handles that are located at the top and/or sides; are ergonomic; are removable or detachable; are molded into the assembly or are provided after fabrication of the assembly (such as by, for example, snap fit, adhesive, riveting, screwed on, bayonet-fit, etc.); etc. Different handles and/or handling options can be provided and may depend on, for example but not limited to, the anticipated contents of the assembly, the application for the assembly, the size and shape of the assembly, the anticipated dispensing system for the assembly, etc.

In some embodiments, the assembly may include two or more layers, such as an overpack and a liner, multiple overpacks, or multiple liners. In further embodiments, an assembly may include at least three layers, which may help ensure enhanced containment of the contents therein, increase structural strength, and/or decrease permeability, etc. Any of the layers may be made from the same or different materials, such as but not limited to, the materials previously discussed herein.

In some embodiments, the assembly may comprise a single wall overpack or liner. In even further embodiments, the single wall may comprise PEN. In another embodiment, the assembly may comprise a liner that is made of a flexible glass type or a flexible glass/plastic hybrid. Such flexible glass liner may reduce or eliminate the permeation of oxygen and water into the contents stored therein. A flexible glass liner may also add the ability of withstanding chemicals or chemistries not compatible with other materials, such as PEN or other plastics.

In some embodiments, as described in some detail above, a desiccant may be used to adsorb and/or absorb water, oxygen, and/or other impurities. Similarly, in some embodiments, a sorbent material, and in some embodiments, a small cylinder, may be filled with a gas, a mixture of gases, and/or a gas generator and may be placed in, for example, the annular space between a liner and an overpack. The sorbent material may be used as a source of pressure for pressure dispense without the need for an external pressure source. In such embodiments, the gas or gases may be released by the sorbent by heating the system, or by electrical pulse, fracture, or any other suitable method or combination of methods.

In order to assist in making the assemblies described herein more sustainable, the packaging systems or one or more components thereof, including any overpack, liner(s), handles, chimes (support members), connectors, etc., may be manufactured from biodegradable materials or biodegradable polymers, including but not limited to: polyhydroxyalkanoates (PHAs), like poly-3-hydroxybutyrate (PHB), polyhydroxyvalerate (PHV), and polyhydroxyhexanoate (PHH); polylactic acid (PLA); polybutylene succinate (PBS); polycaprolactone (PCL); polyanhydrides; polyvinyl alcohol; starch derivatives; cellulose esters, like cellulose acetate and nitrocellulose and their derivatives (celluloid); etc.

In some embodiments, the assemblies or one or more components thereof may be manufactured from materials that can be recycled or recovered, and in some embodiments, used in another process by the same or a different end user, thereby allowing such end user(s) to lessen their impact on the environment or lower their overall emissions. For example, in one embodiment, the assembly or one or more components thereof may be manufactured from materials that may be incinerated, such that the heat generated therefrom may be captured and incorporated or used in another process by the same or different end user. In general the assemblies or one or more components thereof may be manufactured from materials that can be recycled, or that may be converted into raw materials that may be used again.

In some embodiments, structural features may be designed into the liner and/or overpack that add strength and integrity to the liner and/or overpack. For example, the base (or chime in some embodiments), top, and sides of the liner and/or overpack may all be areas that experience increased shake and external forces during filling, transportation, installation, and use (e.g., dispensing). Accordingly, in one embodiment, added thickness or structural edifices (e.g., bridge tressel design) may be added to support stressed regions of the liner and/or overpack, which can add strength and integrity. Furthermore, any connection region in the liner and/or overpack may also experience increased stress during use. Accordingly, any of these such regions may include structural features that add strength through, for example, increased thickness and/or specifically tailored designs. In further embodiments, the use of triangular shapes could be used to add increased strength to any of the above described structures; however, other designs or mechanical support features may be used.

In some embodiments, the storage and dispense assembly or one or more components thereof, including any overpack or liner(s), may include reinforcement features, such as but not limited to, a mesh, fiber(s), epoxy, or resin, etc. that may be integrated or added to the assembly or one or more components thereof, or portions thereof, in order to add reinforcement or strength. Such reinforcement may assist in high pressure dispense applications, or in applications for dispensing high viscosity contents or corrosive contents.

In further embodiments, flow metering technology may be either separate or integrated into the dispense connector for a direct measurement of material being delivered from the liner and/or overpack to a down stream process. A direct measurement of the material being delivered could provide the end user with data which may help ensure process repeatability or reproducibility. In one embodiment, the integrated flow meter may provide an analog or digital readout of the material flow. The flow meter, or other component of the system, can take the characteristics of the material (including but not limited to viscosity and concentration) and other flow parameters into consideration to provide an accurate flow measurement. Additionally, or alternatively, the integrated flow meter can be configured to work with, and accurately measure, a specific material stored and dispensed from the dispense assembly. In one embodiment, the inlet pressure can be cycled, or adjusted, to maintain a substantially constant outlet pressure or flow rate.

In some embodiments, the assembly may include level sensing features or sensors. Such level sensing features or sensors may use visual, electronic, ultrasonic, or other suitable mechanisms for identifying, indicating, or determining the level of the contents stored in the assembly. For example, in one embodiment, the assembly or a portion thereof may be made from a substantially translucent or transparent material that may be used to view the level of the contents stored therein.

In still further embodiments, the storage and dispense assembly may be provided with other sensors and/or RFID tags, which may be used to track the assembly, as well as to measure usage, pressure, temperature, excessive shaking, disposition, or any other useful data. The RFID tags may be active and/or passive. For example, strain gauges may be used to monitor pressure changes of the assembly. The strain gauges may be applied or bonded to any suitable component of the assembly. In some embodiments, the strain gauges may be applied to an outer overpack or liner. The strain gauges may be used to determine pressure build-up in an aging product, but may also be useful for a generally simple measurement of the contents stored in the liner and/or overpack. For example, the strain gauge may be used to alert an end user when to change out a liner or may be used as a control mechanism, such as in applications where the liner and/or overpack is used as a reactor or disposal system. In embodiments where the sensitivity of the strain gauge is high enough, it may be able to provide a control signal for dispense amount and flow rate.

Although the present invention has been described with reference to preferred embodiments, persons skilled in the art will recognize that changes may be made in form and detail without departing from the spirit and scope of the invention.

1-33. (canceled)

34. A liner-based system comprising:
an overpack; and
a liner provided within the overpack, the liner comprising a mouth and a liner wall forming an interior cavity of the liner and having a thickness such that the liner is substantially self-supporting in an expanded state, but is collapsible at a pressure of less than about 20 psi.

35. The liner-based system of claim 34, wherein the overpack and the liner have substantially the same form.

36. The liner-based system of claim 34, wherein the liner is configured to collapse away from an interior wall of the overpack upon the introduction of a gas or liquid into an annular space between the liner and the overpack, thereby dispensing contents of the liner.

37. The liner-based system of claim 36, wherein at least one of the liner or overpack comprises one or more surface features for controlling the collapse of the liner.

38. The liner-based system of claim 37, wherein the one or more surface features comprise a plurality of rectangular-shaped panels spaced around the circumference of the at least one of the liner or overpack.

39. The liner-based system of claim 38, wherein the liner and overpack are coblowmolded.

40. The liner-based system of claim 39, wherein the one or more surface features for controlling the collapse of the liner are configured to maintain integrity between the liner and overpack when not in active dispense.

41. The liner-based system of claim 36, wherein at least one of the liner or overpack are configured to control the collapse of the liner such that the liner collapses substantially evenly circumferentially away from the interior wall of the overpack.

42. The liner-based system of claim 37, further comprising a chime coupled to the exterior of the overpack, wherein the chime comprises a barrier coating for protecting contents of the liner.

43. The liner-based system of claim 36, wherein at least one of the liner or overpack are comprise of a biodegradable material.

44. The liner-based system of claim 36, further comprising at least one of a sensor for measuring dispense of the contents of the liner and a device for tracking at least one of liner contents or liner usage.

45. The liner-based system of claim 36, further comprising a dessicant between the liner and overpack.

46. The liner-based system of claim 34, further comprising a connector for at least one of filling the liner or dispensing contents from the liner.

47. The liner-based system of claim 46, wherein the connector is configured for substantially aseptic filling or dispense.

48. The liner-based system of claim 46, wherein the connector is configured for at least one of direct pressure dispense, indirect pressure dispense, pump dispense, pressure assisted pump dispense, gravity dispense and pressure assisted gravity dispense.

49. The liner-based system of claim 46, wherein the connector comprises a diptube probe that partially extends into the liner for dispensing the contents of the liner.

50. The liner-based system of claim 49, wherein the connector is further adapted for recirculation of the contents of the liner.

51. The liner-based system of claim 34, wherein the overpack comprises two interconnecting portions.

52. The liner-based system of claim 46, wherein the connector is that of a conventional glass bottle dispensing system.

53. A method of delivering a material to a downstream process, the method comprising:
providing a liner comprising a mouth and a liner wall forming an interior cavity of the liner with the material stored therein, the liner having a thickness such that the liner is substantially self-supporting in an expanded state, but is collapsible at a pressure of less than about 20 psi, and the liner having a diptube in the interior for dispensing the material therefrom;
coupling the diptube to a downstream process; and
dispensing the material from the container via the diptube and delivering the material to the downstream process.
